(19) United States
(12) Patent Application Publication
(10) Pub. No.: US 2007/0299645 A1
(43) Pub. Date: Dec. 27, 2007

(54) Autonomous Molecular Computer Diagnoses Molecular Disease Markers and Administers Requisite Drug in Vitro

(75) Inventors: Ehud Y. Shapiro, Nataf (IL); Yaakov Benenson, Cambridge, MA (US); Binyamin Gil, Rishon-LeZion (IL); Uri Ben-Dor, Givat Shmuel (IL); Rivka Adar, Carmei Yosef (IL)

Correspondence Address: Martin D Moynihan;PRTSI Inc, Post Office Box 16446, Arlington, VA, 22215, US

(73) Assignee: Yeda Research and Development Co., Ltd., Rehovot (IL)

(21) Appl. No.: 11/587,754

(22) PCT Filed: May 1, 2005
(86) PCT No.: PCT/IL05/00458

§ 371 Date: Oct. 26, 2006

Related U.S. Application Data
(60) Provisional application No. 60/565,536, filed on Apr. 27, 2004.

(51) Int. Cl. G06G 7/48

(52) U.S. Cl. 703/11

(57) ABSTRACT

An autonomous molecular computer that, when coupled to a molecular model of a disease, is capable of disease diagnosis. The computer preferably performs such diagnosis by detecting one or more disease markers. For example, optionally and preferably the molecular computer checks for the presence of over-expressed, under-expressed and mutated genes, applies programmed medical knowledge to this information to reach a diagnostic decision.

### FIELD OF THE INVENTION

The present invention relates to biomolecular computers and in particular, to diagnosis of a disease through molecular markers.

### BACKGROUND OF THE INVENTION

Electronic computers can analyze biological information only after its conversion into an electronic representation. Computers made of biological molecules hold the promise of direct computational analysis of biological information in its native molecular form, potentially providing in situ disease diagnosis and therapy.

Electronic computers and living organisms are similar in their ability to carry out complex physical processes under the control of digital information—electronic gate switching controlled by computer programs and organism biochemistry controlled by the genome. Yet they are worlds apart in their basic building blocks—wires and logic gates on the one hand¹, and biological molecules on the other hand². While electronic computers, first realized in the 1940's³ are the only “computer species” we are accustomed to, the abstract notion of a universal programmable computer, conceived by Alan Turing in 1936⁴, has nothing to do with wires and logic gates. In fact, Turing's design of the so-called Turing machine, which set the stage for the theoretical study of computation and has been since at the foundation of theoretical computer science⁵, has striking similarities to information-processing biomolecular machines such as the ribosome and polymerases. This similarity holds the promise that biological molecules can be used to create a new “computer species” that can have direct access to the patient's biochemistry, a major advantage over electronic computers used for medical applications³⁴⁻³⁷

Work on biomolecular computers included theoretical designs⁶⁻¹⁰ as well as experimental constructions¹¹⁻²⁵. Initially, experimental research aimed at competing heads-on with electronic computers by solving compute-intensive problems using human-assisted, laboratory-scale manipulation of DNA^{11-14, 17-21}. Later, molecular implementations of highly-simplified Turing machines, called finite automata⁵, were demonstrated^{15,22,24} (FIG. 1a). In the molecular realizations of finite automata^{22,24} the input is encoded as a double-stranded (ds) DNA molecule, software, called transition rules, is encoded by another set of dsDNA molecules, and the hardware consists of DNA manipulating enzymes. A computation commences when all molecular components are present in solution, and proceeds by stepwise, transition-rule directed, enzymatic cleavage of the input molecule, resulting in a DNA molecule that encodes the output of the computation. An automaton can be stochastic^{26,27}, namely have two or more competing transitions for each state-symbol combination, each with a prescribed probability, the sum of which is 1. A stochastic automaton is useful for processing information that is uncertain or probabilistic in nature, like most biological and biomedical information²⁸⁻³³. While electronic computers use cumbersome and indirect methods to implement stochastic computations, molecular automata can exploit the stochastic nature of competing biochemical reactions and control the probabilities of stochastic choices through the relative molar concentrations of competing transition molecules²⁷.

### SUMMARY OF THE INVENTION

The background art does not teach or suggest an autonomous molecular computer that is capable of disease diagnosis. The background art also does not teach or suggest an autonomous molecular computer that is capable of detecting disease markers. The background art also does not teach or suggest an autonomous molecular computer that is capable of determining when an appropriate treatment should be administered.

The present invention overcomes these deficiencies of the background art by providing an autonomous molecular computer that, when coupled to a molecular model of a disease, is capable of disease diagnosis. The computer preferably performs such diagnosis by detecting one or more disease markers. For example, optionally and preferably the molecular computer checks for the presence of over-expressed, under-expressed and mutated genes, applies programmed medical knowledge to this information to reach a diagnostic decision.

More preferably, the computer administers the requisite treatment, such as a drug molecule, most preferably anti-sense chemotherapy, upon diagnosis.

According to preferred embodiments of the present invention, the autonomous molecular computer is preferably capable of diagnosis of small-cell lung cancer and of prostate cancer, optionally through a detection of one or more disease markers determined according to a simplified molecular model of each disease. More preferably, the computer is able to administer upon diagnosis the requisite anti-sense chemotherapy for treating these diseases.

Although the present invention is described with regard to an in vitro computer, it is understood that the present invention is also operative in vivo.

In order to be able to further describe the present invention, a short discussion is provided regarding Turing machines.

The Turing machine^{4,5} has an information-encoding tape, which is similar to information-encoding biopolymers in that each position in the tape can hold exactly one of a finite number of symbols, and in that the tape can be extended potentially endlessly in both directions. The Turing machine has a “processive” control unit that processes one tape position at a time and cannot randomly access remote positions, like many biomolecular machines. The control unit obeys instructions, called transition rules, of which there are only a finite number. A transition rule is similar to an amino-acyl-tRNA², in that it can be activated only by sensing the symbol in the currently-processed position, analogously to codon-sensing by tRNA, and in that its actions include placing a new symbol in the currently processed position, analogously to the transfer of an amino acid from the tRNA to the nascent polypeptide by the ribosome. The differences between the Turing machine and biomolecular machines such as the ribosome and polymerases² are (i) the Turing machine is not directional: at each step of the computation it can move one position to the left or to the right; (ii) the Turing machine modifies the tape it reads: it may replace the symbol it senses by a new symbol specified by the transition rule; (iii) the Turing machine is always in one of a finite number of internal states. A transition rule checks the machine's internal state together with the current symbol and instructs state modification simultaneously with the replacement of the current symbol by a new symbol, followed by instructing a move of one position to the left or to the right.

A two-state finite automaton is probably the simplest computing machine deserving this name. Yet, surprisingly, its computing power seems initially adequate for this medical task of molecular diagnosis and cure. The gap between this rudimentary computer and actual medical applications lies not so much in computing power but in system integration: how to provide such a computer with safe and effective access to a diseased tissue, organ or organism.

Another approach to sensing biochemical signals, known as “chemical logic gates”^{25,46}, interprets chemical input signals as inputs to a Boolean expression and produces a chemical output which encodes the truth value of this expression.

Although this process may start with a prototype in the simplest setting (in vitro sensu stricto in biology; an automaton in computer science), once it has been demonstrated to be operative, the essential “design principles” may stay the same although further significant changes may also optionally be performed. Thus, although the present invention may require one or more changes in implementation to put the molecular computer into cells, nevertheless the basic building blocks are described herein.

According to one aspect of the present invention there is provided an autonomous molecular computer capable of disease diagnosis.

According to further features in preferred embodiments of the invention described below, the autonomous molecular computer further comprising: a molecular model of a disease for being coupled to the computer.

According to still further features in the described preferred embodiments the computer is for performing the diagnosis by detecting one or more disease markers.

According to still further features in the described preferred embodiments the one or more disease markers includes the absence or presence, or over-expression or under-expression of one or more proteins or metabolites, or mutation of one or more proteins.

According to still further features in the described preferred embodiments performing the diagnosis includes performing one or more of checking for the presence of over-expressed, under-expressed and mutated genes.

According to still further features in the described preferred embodiments the computer further comprising: programmed medical knowledge for being applied to the diagnosis.

According to still further features in the described preferred embodiments the computer further being capable of administering the requisite treatment upon diagnosis.

According to still further features in the described preferred embodiments the treatment comprises a drug molecule, most preferably anti-sense chemotherapy.

According to still further features in the described preferred embodiments the disease comprises at least one of small-cell lung cancer and of prostate cancer.

According to yet another aspect of the present invention there is provided an autonomous molecular computer capable of in vivo treatment.

According to still further features in the described preferred embodiments the treatment occurs within a cell or at a cell surface.

According to still further features in the described preferred embodiments the computer comprising a plurality of polymeric molecules, optionally including one or more heteropolymers or homopolymers.

According to still further features in the described preferred embodiments the polymeric molecules comprise oligomers.

According to still further features in the described preferred embodiments the polymeric molecules comprise a plurality of oligonucleotides.

According to still further features in the described preferred embodiments the polymeric molecules optionally comprise at least one modified oligonucleotide.

According to still further features in the described preferred embodiments the polymeric molecules comprise peptides and/or polypeptides.

The present invention successfully addresses the shortcomings of the presently known configurations by providing an autonomous molecular computer capable of disease diagnosis and treatment.

### BRIEF DESCRIPTION OF THE DRAWINGS

The invention is herein described, by way of example only, with reference to the accompanying drawings, wherein:

FIGS. 1a-e are schematic illustrations depicting the architecture of the molecular finite automaton, featuring its input, software and hardware components. FIG. 1a—molecular component and computational step of a molecular automaton; FIG. 1b—molecular medical computer; FIG. 1c—diagnosis and therapy rules; FIG. 1d—diagnosis and therapy rule processor; FIG. 1e-processing prostate cancer diagnosis and therapy rule. The current state of computation is represented by a partially cleaved symbol-encoding dsDNA segment that exposes a four-nucleotide “sticky end” at a state-specific location. The cleavage is accomplished by the FokI hardware enzyme that recognizes the double-stranded DNA sequence GGATG and cleaves its substrate 9 or 13 nucleotides away from the recognition site in 5′→3′ or 3′→5′ strands, respectively. The transition molecule recognizes a particular state-symbol sticky end and directs the FokI bound to it to cleave within the next symbol at a precise location, to expose the next state-symbol combination and thus to realize the transition between states. The software molecule is recycled and the cleaved symbol is scattered. Note the unusual use of automaton components: its formal input, the diagnostic rule to be processed, functions in the present application like a program, and its formal program, the software molecules, function in the present application as the input mechanism, detecting the presence of molecular indicators.

FIGS. 2a-e are schematic illustrations depicting the exemplary molecular design and operation of the molecular computer according to the present invention. FIG. 2a—diagnostic molecules for prostate cancer. The diagnosis moiety (gray) implements the diagnosis component of a diagnosis and therapy rule and consists of 7-bp sequences encoding the symbols for the molecular indicators. Following the diagnostic moiety are either a drug release moiety (purple) or a drug-suppressor release moiety (brown), consisting of a ssDNA that loops on itself to form a sequence encoding three diagnostic verification symbols (light purple/light brown) followed by a drug loop (purple) or a drug-suppressor loop (brown). For all symbol-representing sequences, the first four nucleotides of the sequence represent the symbol combined with state Yes, while nucleotides three to six represent the symbol combined with the state No. Example symbol encodings and state-symbol sticky ends are enlarged in red frames. FIGS. 2b and c—pair of competing transition molecules regulated by PIM1 mRNA, each containing a regulation (green, red) and a computation (blue, gray) fragment. The computation fragment consists of the double-stranded recognition site of the hardware enzyme FokI (blue), a single-stranded sticky end (gray) that recognizes a particular state-symbol combination of the diagnostic molecule, and possibly a 2-bp spacer (gray) between the two. A spacer of 2 bp effects a Yes→Yes transition while a zero-length spacer effects a Yes→No transition. The regulation fragment of a transition molecule enables its regulation by a nucleic-acid-based molecular indicator, which may activate (green) or deactivate (red) the transition when in high concentration. The transition molecule 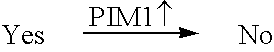
(FIG. 2c) is inactivated by a subsequence of the PIM1 mRNA indicator (“inactivation tag”) via its binding to the single-stranded overhang of the regulation fragment of the transition molecule followed by strand exchange due to higher stability of the mRNA-deactivation-tag/transition-sense-strand hybrid relative to the normal transition molecule hybrid. The transition molecule 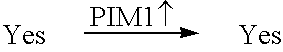
(FIG. 2b) is activated by high concentration of PIM1 mRNA. In its absence, formation of the transition molecule is prevented by a third “protecting” oligonucleotide (green) that partially hybridizes to the antisense strand and forms a complex that is more stable than the active transition molecule. The protecting strand is also complementary to a subsequence of PIM1 mRNA (“activation tag”, light green). Activation tag of PIM1 mRNA triggers a strand exchange process that decouples the protecting strand from the antisense strand of the transition molecule and allows it to hybridize with the sense strand to form an active 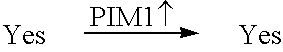
transition. In an idealized regulation process one PIM1 mRNA molecule inactivates one 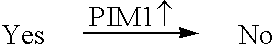
and activates one 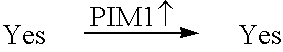
transition molecule. FIG. 2d—pair of transition molecules regulated by mRNA point mutation. The positive transition has a regulation fragment complementary to the wild-type mRNA while the corresponding regulation fragment of the negative transition is complementary to the mutated mRNA. The positive transition is preferentially inactivated by the wild-type mRNA whereas the negative transition is inactivated by the mutated mRNA.

FIG. 3 is a schematic illustration depicting an exemplary stepwise diagnosis followed by drug release performed by the molecular computer of the present invention. Step a—computation module: Logical analysis of disease indicators for PC. The initial diagnostic molecule consists of a diagnosis moiety (gray) that encodes the left-hand side of the diagnostic rule and a drug-administration moiety (light purple) incorporating an inactive drug loop (dark purple); Step b—input module: Software regulation of the two transitions for PIM1↑ by mRNA levels (subsequences, i.e., “tags”). Over-expression of PIM1 mRNA results in relatively high level of the Yes→PIM1^{↑}→Yes transition molecules and a low level of the Yes→PIM1^{↑}→No molecules. Each transition molecule contains regulation (green, red) and computation (blue, gray) fragments. The “inactivation tag” of PIM1 mRNA (light red) displaces the 5′→3′ strand of the transition molecule Yes→PIM1^{↑}→No and destroys its computation fragment. The “activation tag” of PIM1 mRNA (light green) activates the transition molecule Yes→PIM1^{↑}→Yes. Initially, a “protecting” oligonucleotide (green) partially hybridizes to the 3′→5′ strand of the transition molecule and blocks the correct annealing of its 5′→3′ strand. The “activation tag” displaces the protecting strand, allowing such annealing and rendering an active Yes→PIM1^{↑}→Yes transition. Ideally, one PIM1 mRNA molecule inactivates one Yes→PIM1^{↑}→No and activates one Yes→PIM1^{↑}→Yes transition molecule. Step c—probabilistic check for PIM1↑ indicator. Note the stochastic processing of the symbol PIM1↑ by a regulated pair of competing transition molecules. The probability of a Yes→Yes transition is high, resulting in a high level of diagnostic molecules in the state Yes and a low level in state No; Step d—depicts the output module of drug administration. The combined computation of both types of diagnostic molecules, high Yes and low No results in a high release of drug and low release of drug suppressor, and hence in the administration of the drug.

FIGS. 4a-f depict experimental results with illustrative implementations of the molecular computer of the present invention. FIG. 4a—regulation of competing transitions by mRNA representing a generic disease symptom showing transition molecules in their active and inactive state. F stands for FAM, R stands for tetramethyl rhodamine and Y for Cy5 labels. Note the correlation between the increased mRNA level and the increased levels of the active Yes→Yes transition molecule and the inactive Yes→No transition molecule. FIG. 4b—depicts a calibration curve showing the regulation of probability of Yes output state in a single-step computation by a pTRI-Xef generic mRNA indicator. Experimental data used to calculate the probabilities is shown below the graph. FIG. 4c—depicts regulation by point mutation by mixtures of model ssDNA oligonucleotides representing different ratios of mRNA of wild-type and of mutated genes. Experimental data used to calculate the probabilities is shown below the graph. FIGS. 4d-f illustrate the adjustment of confidence in a positive diagnosis for various concentrations of the molecular indicator by adjusting the absolute concentrations of the transition molecules. FIG. 4d is a gel visualizing the increase in probability of Yes diagnostic output with increasing concentrations of INSM1 ssDNA model (over-expressed in the disease) for different concentrations of active and inactive transition molecules. FIG. 4e is a graph depicting the transition probabilities derived from the measured intensities of the Yes and No bands, highlighting the change in the No/Yes crossover point as a function of transition molecule concentration and FIG. 4f plots this function.

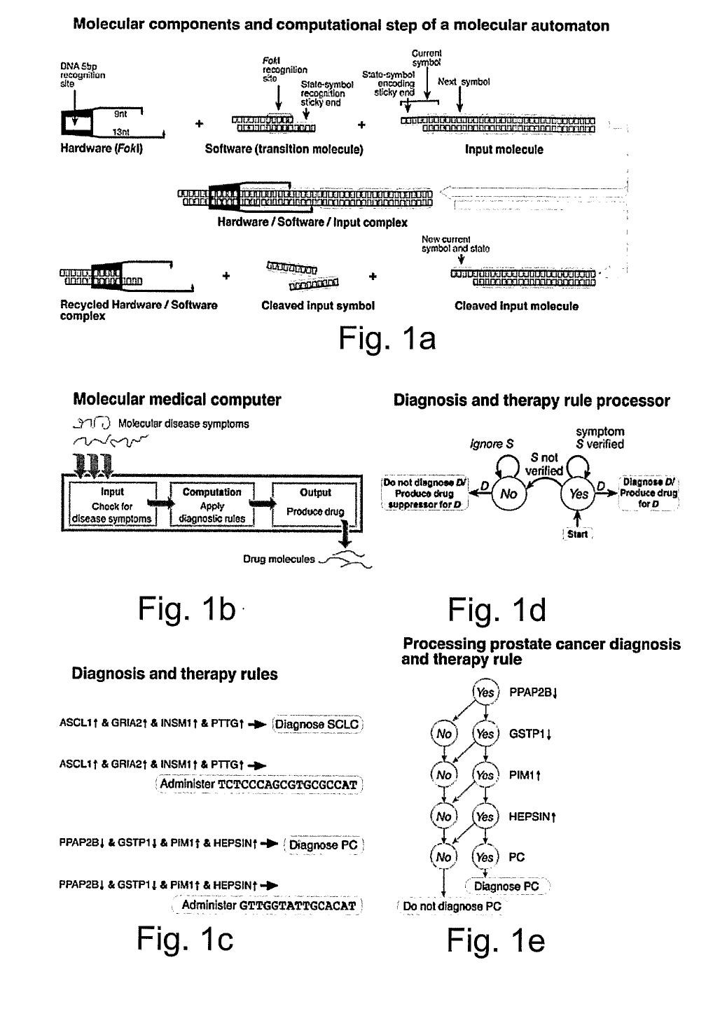

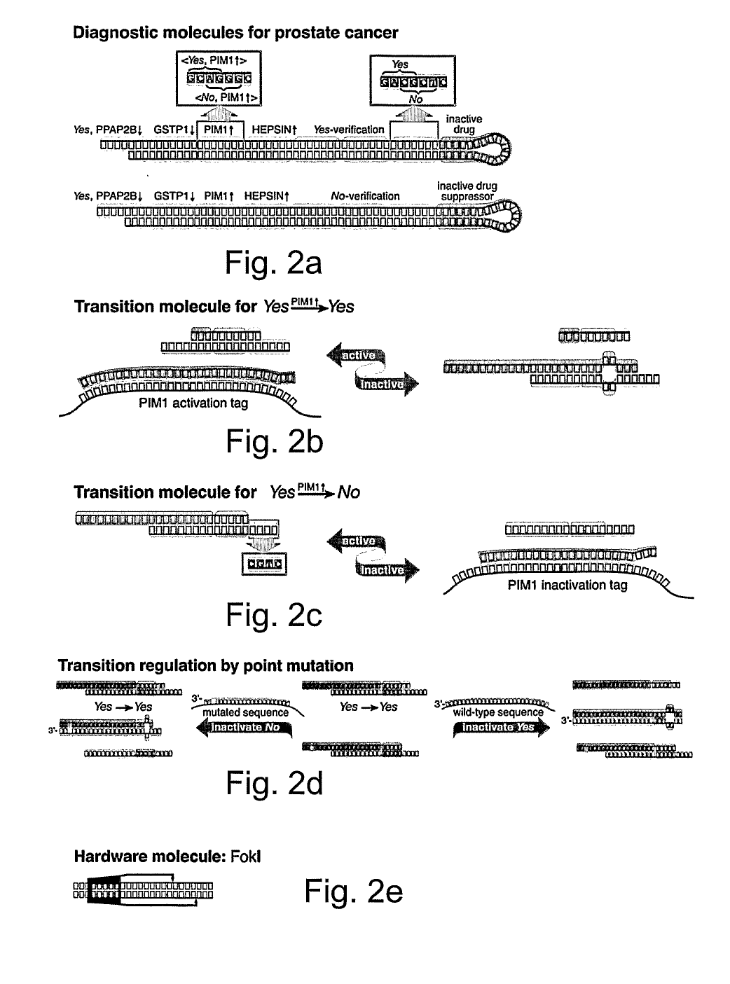

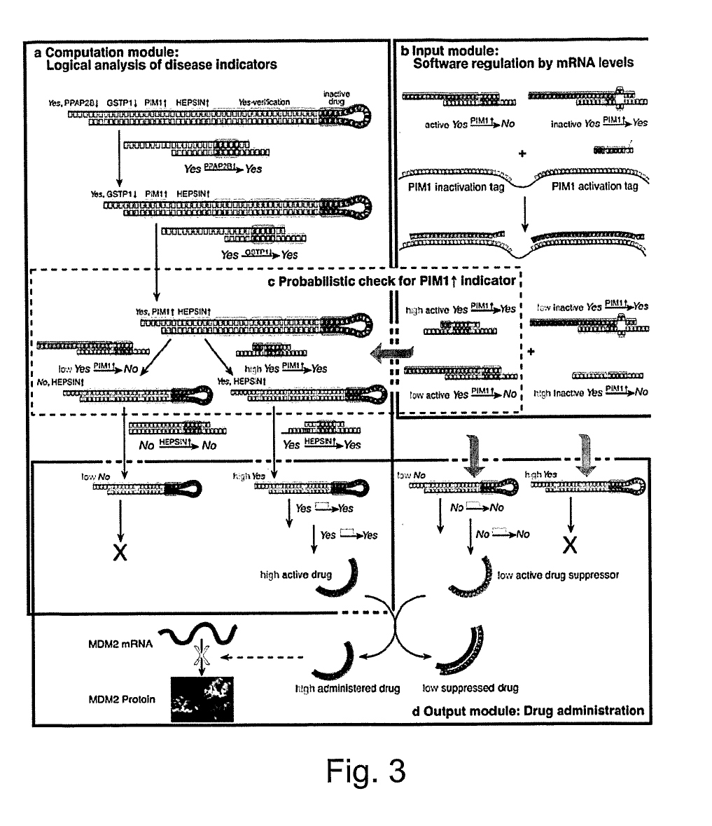

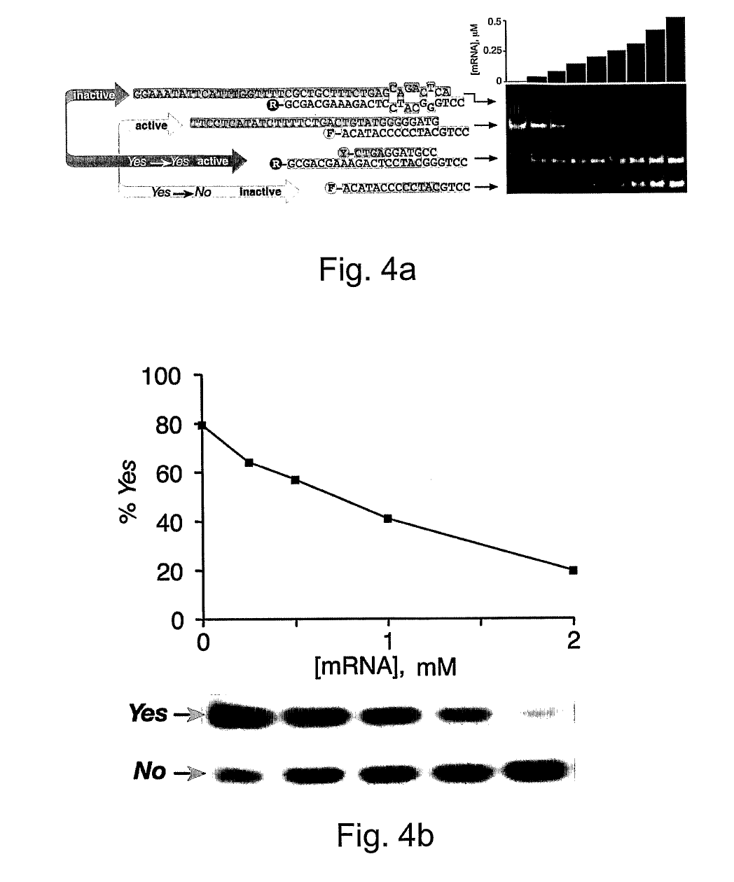

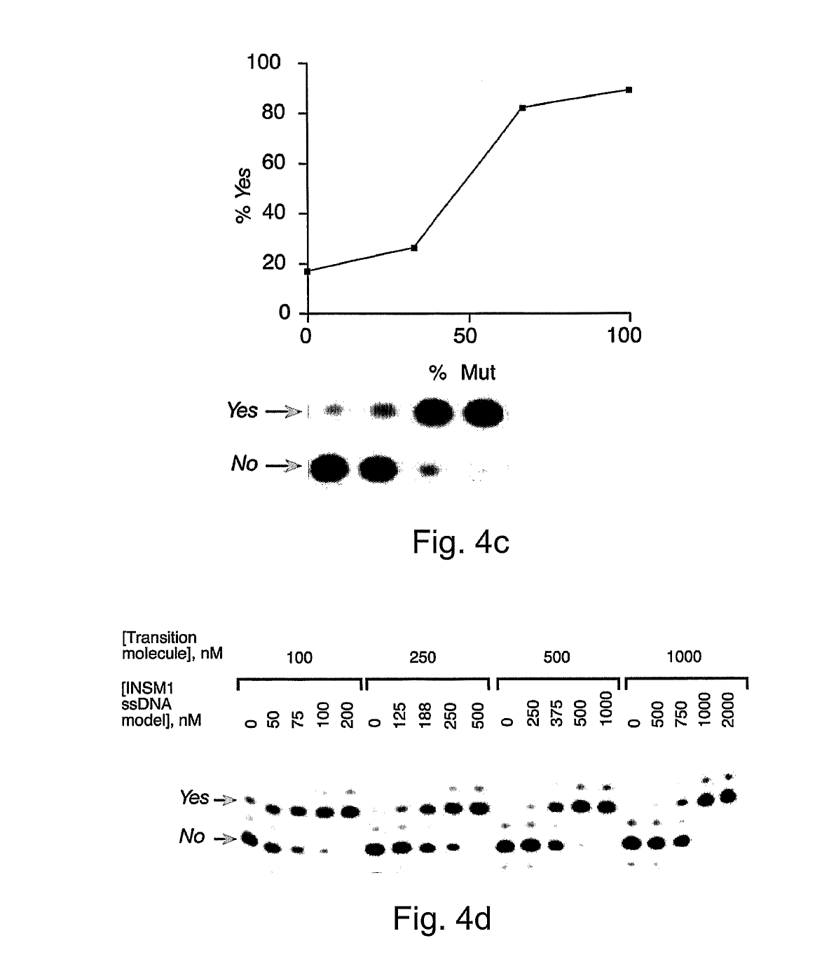

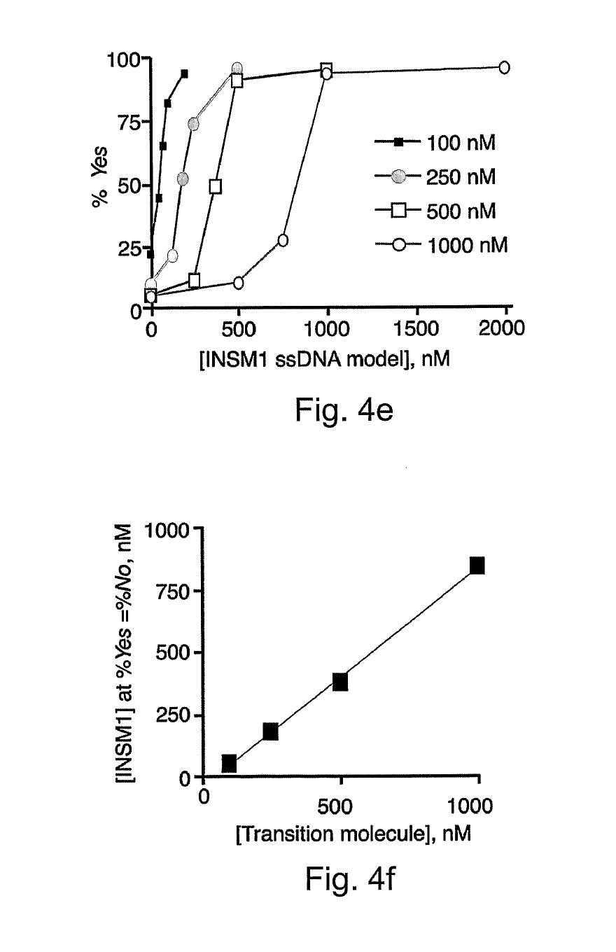

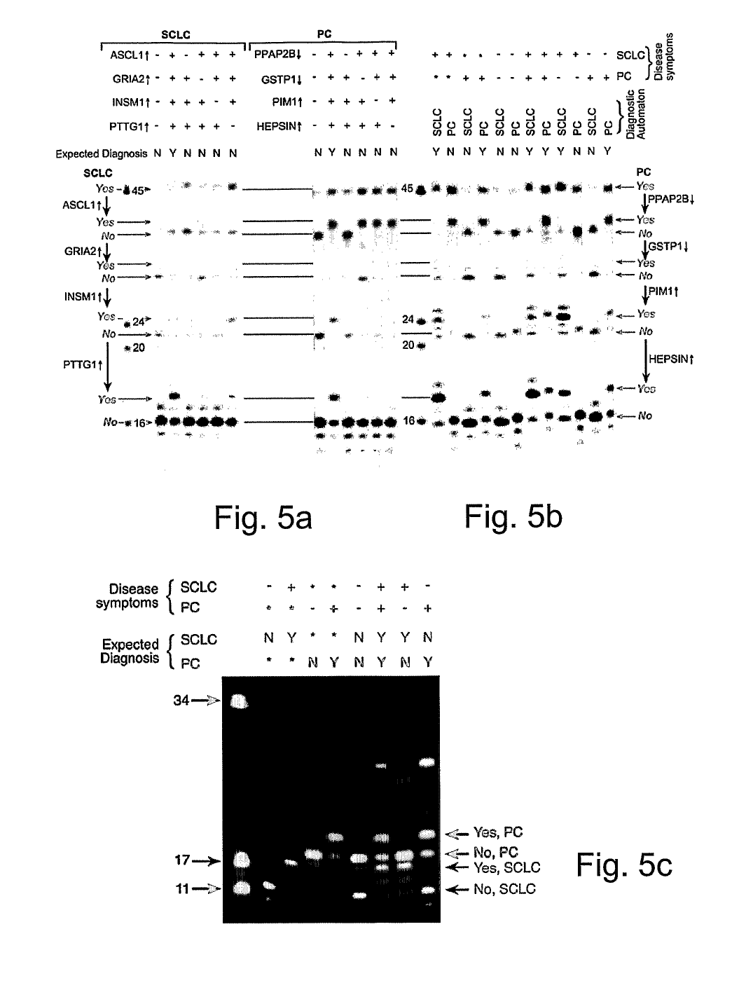

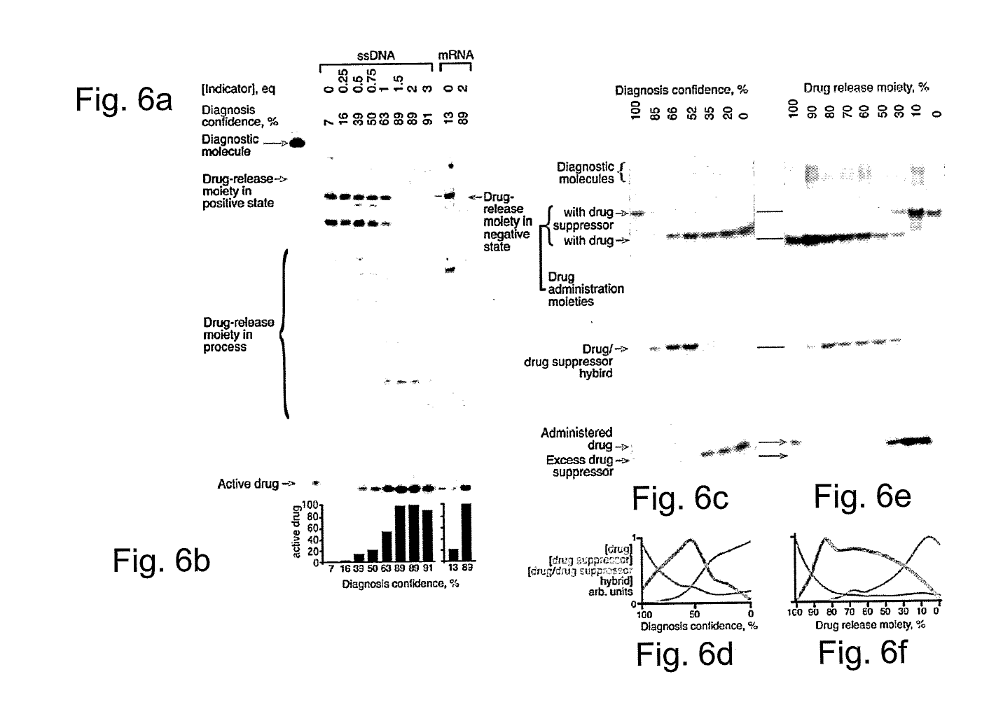

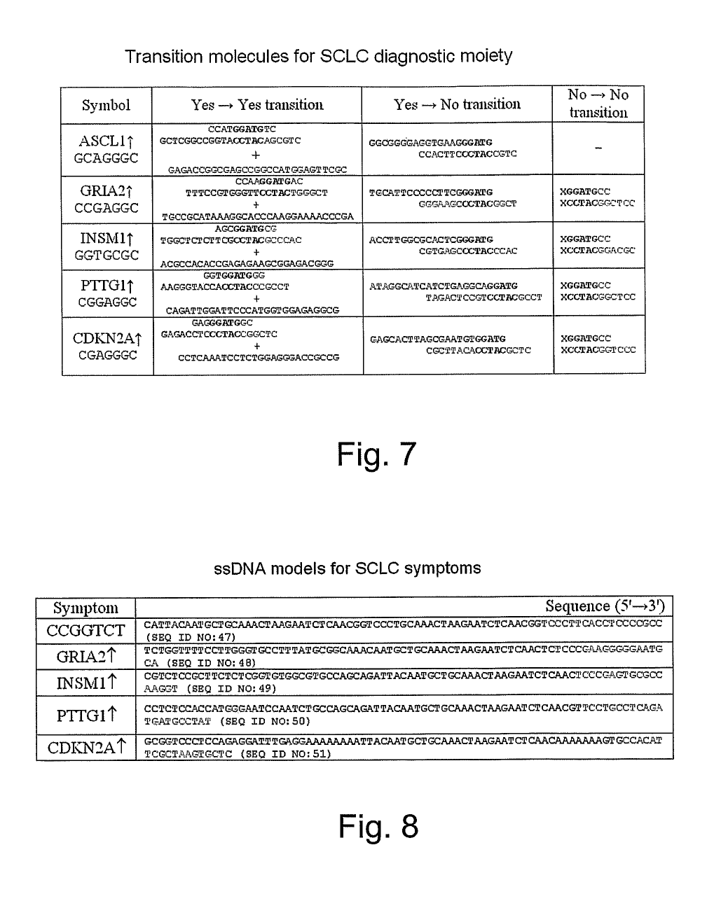

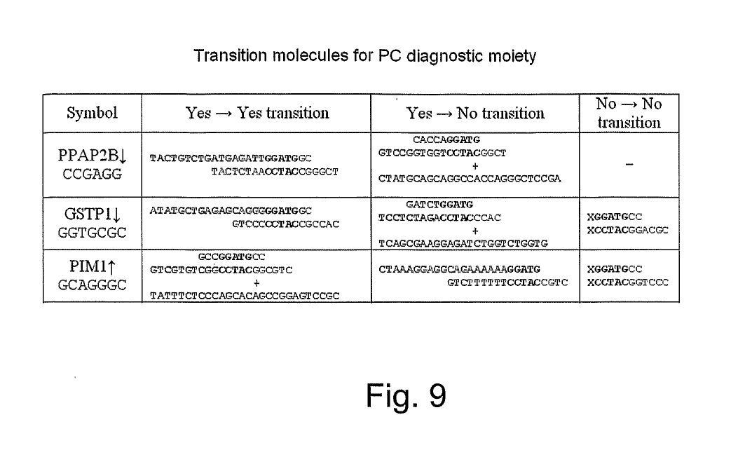

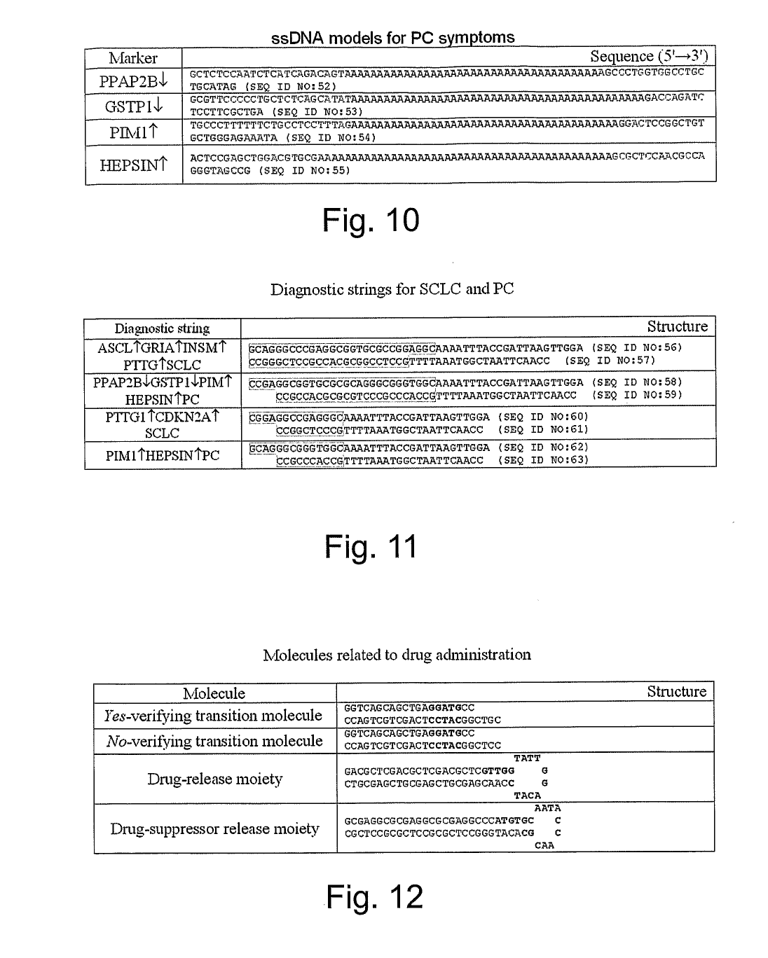

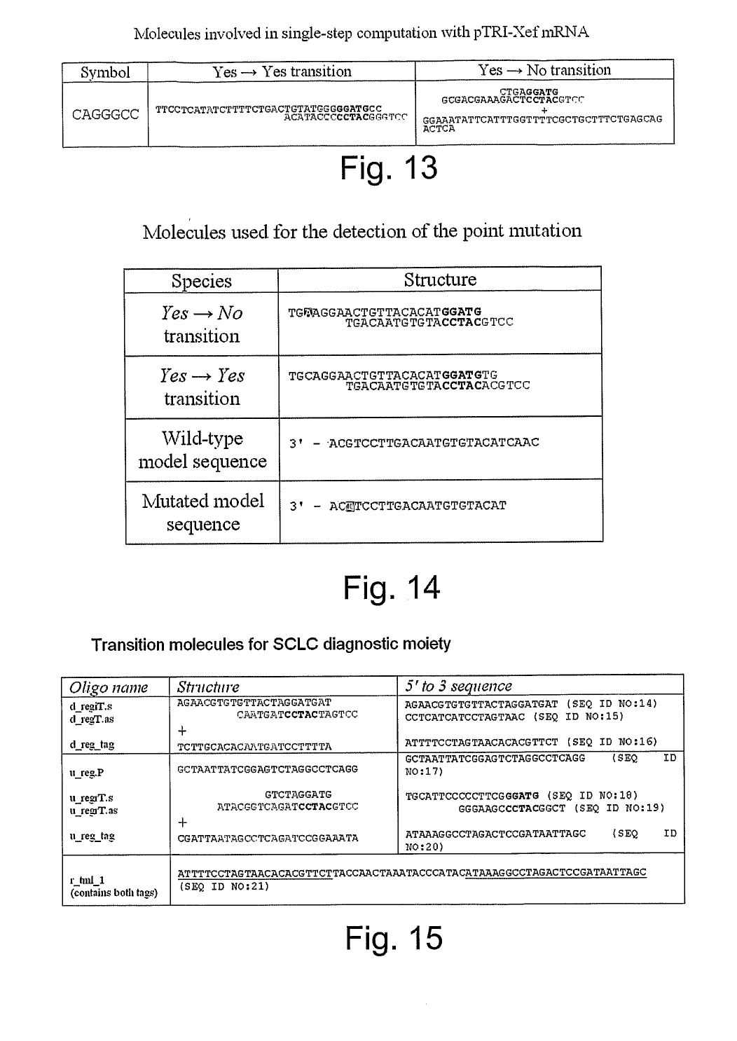

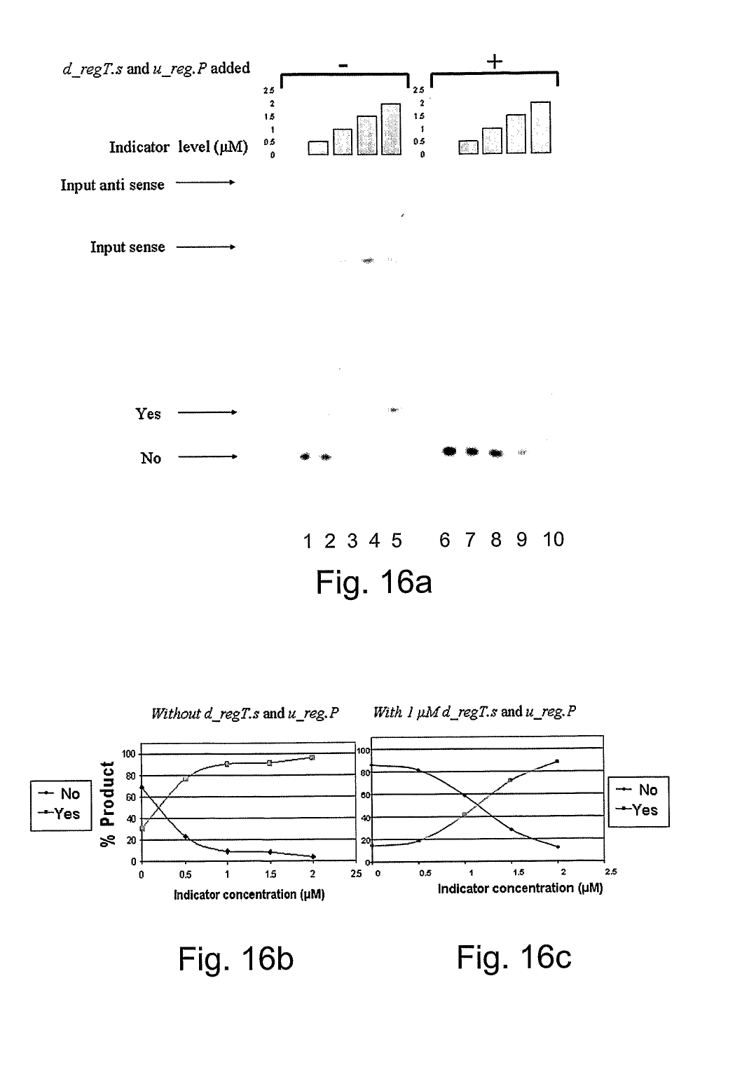

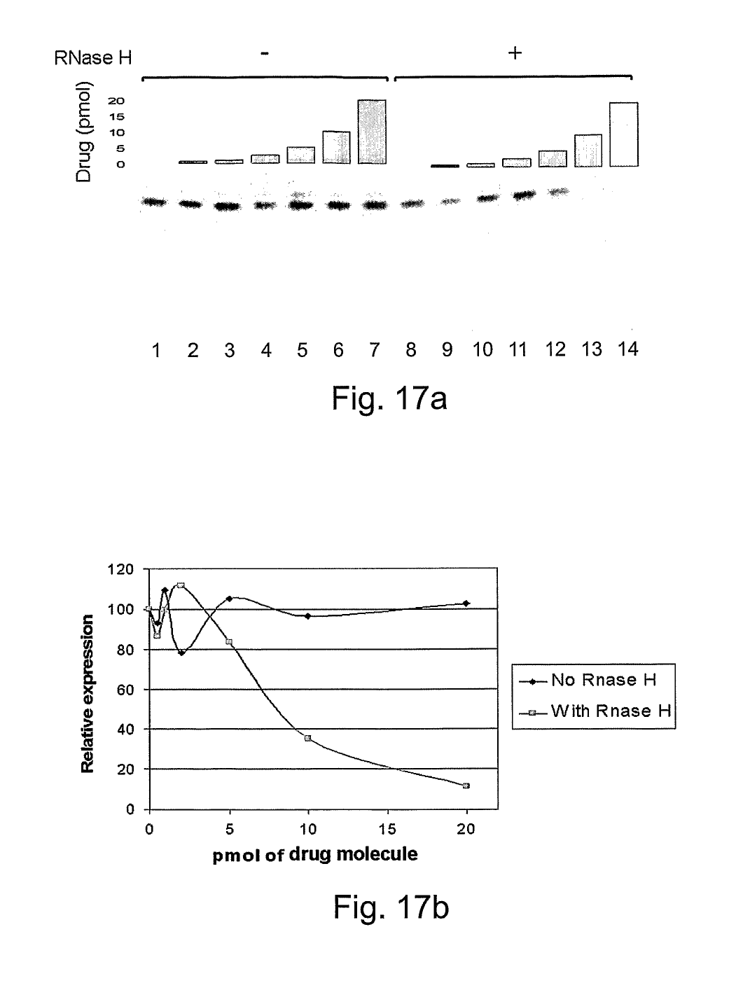

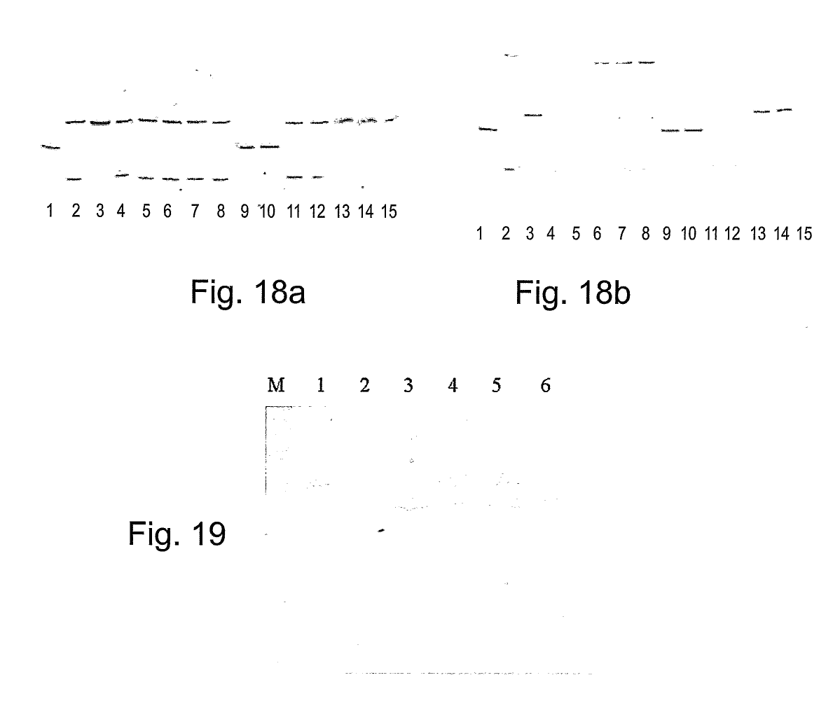

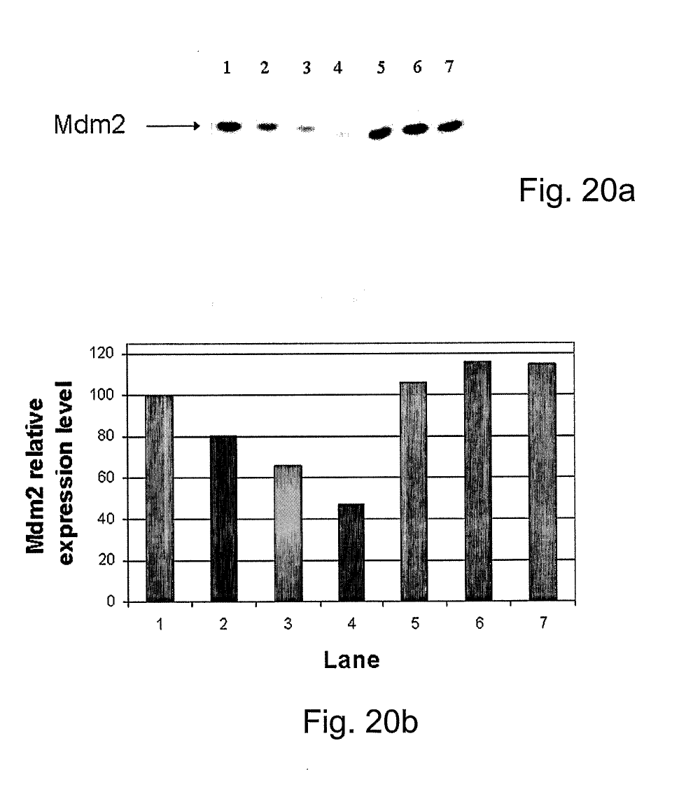

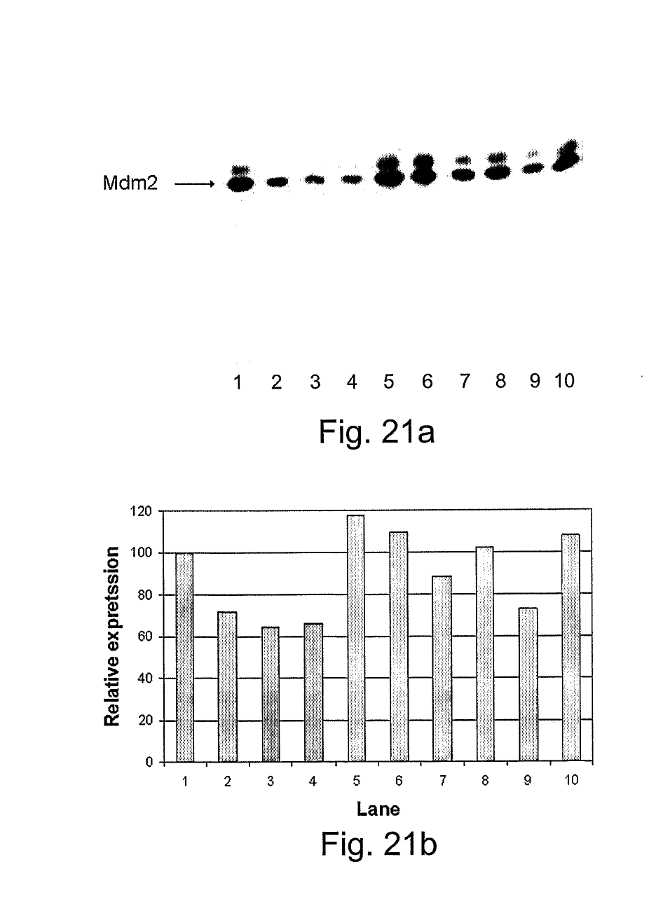

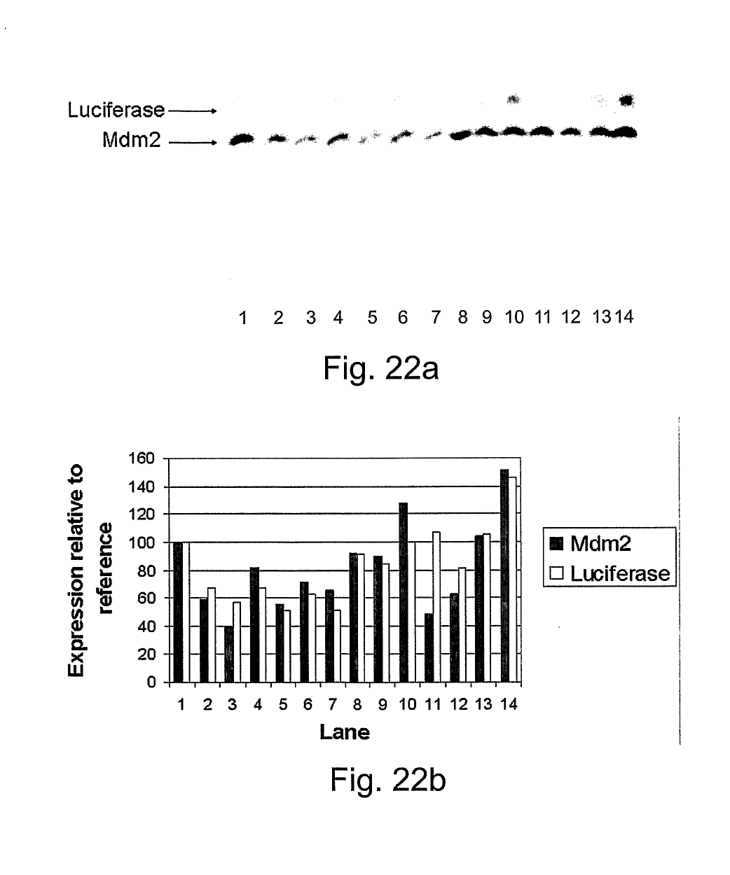

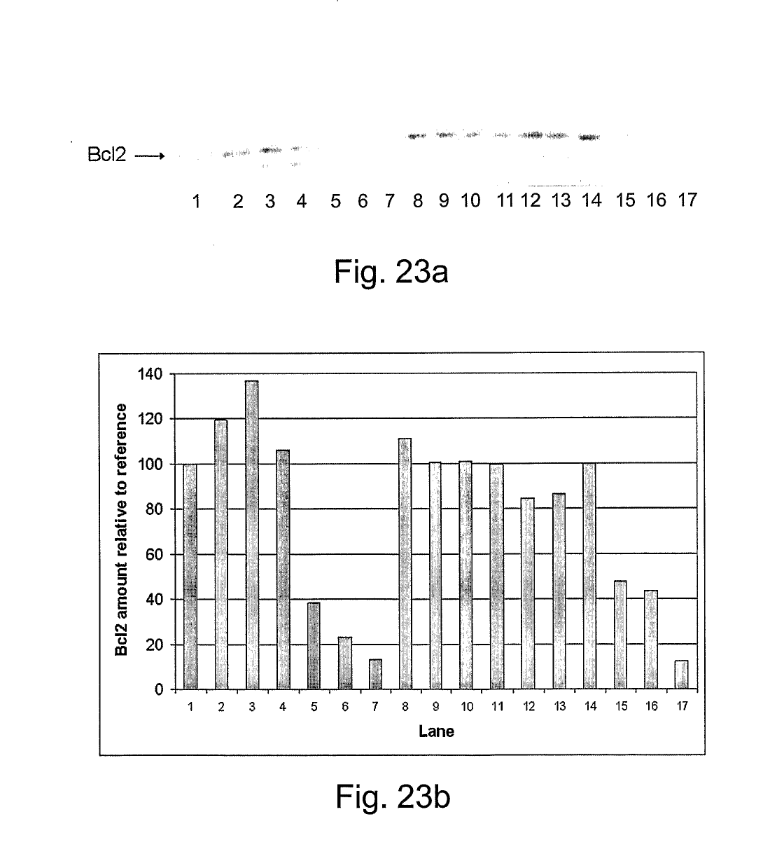

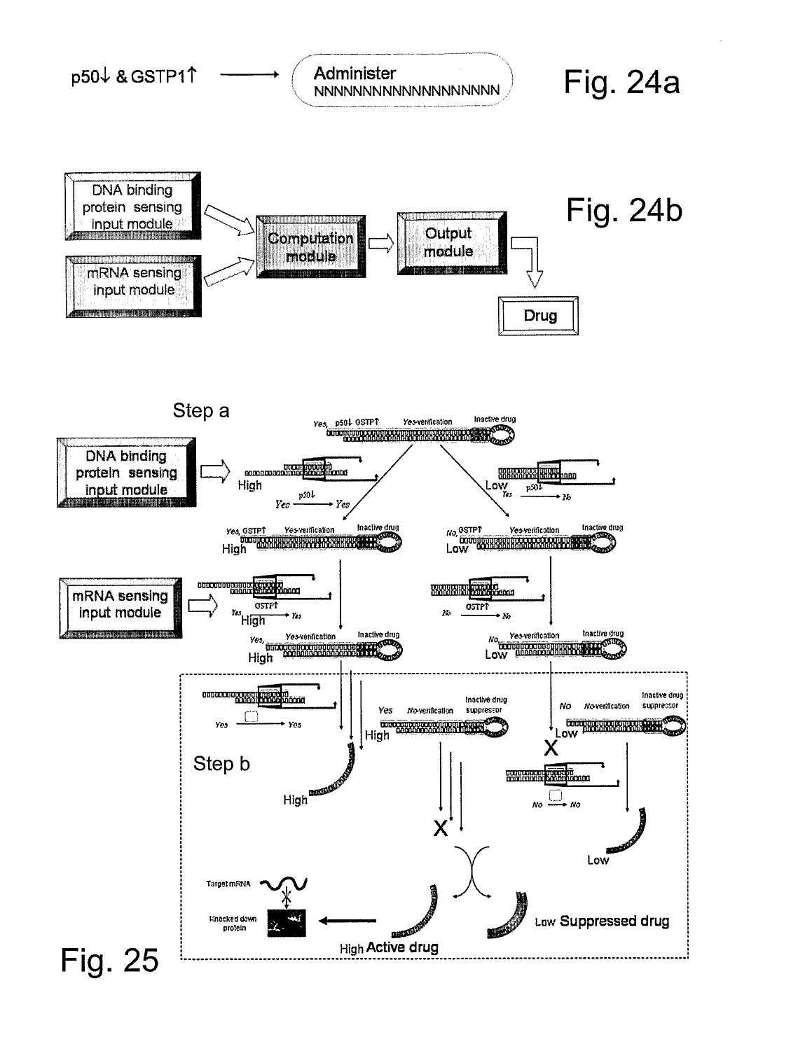

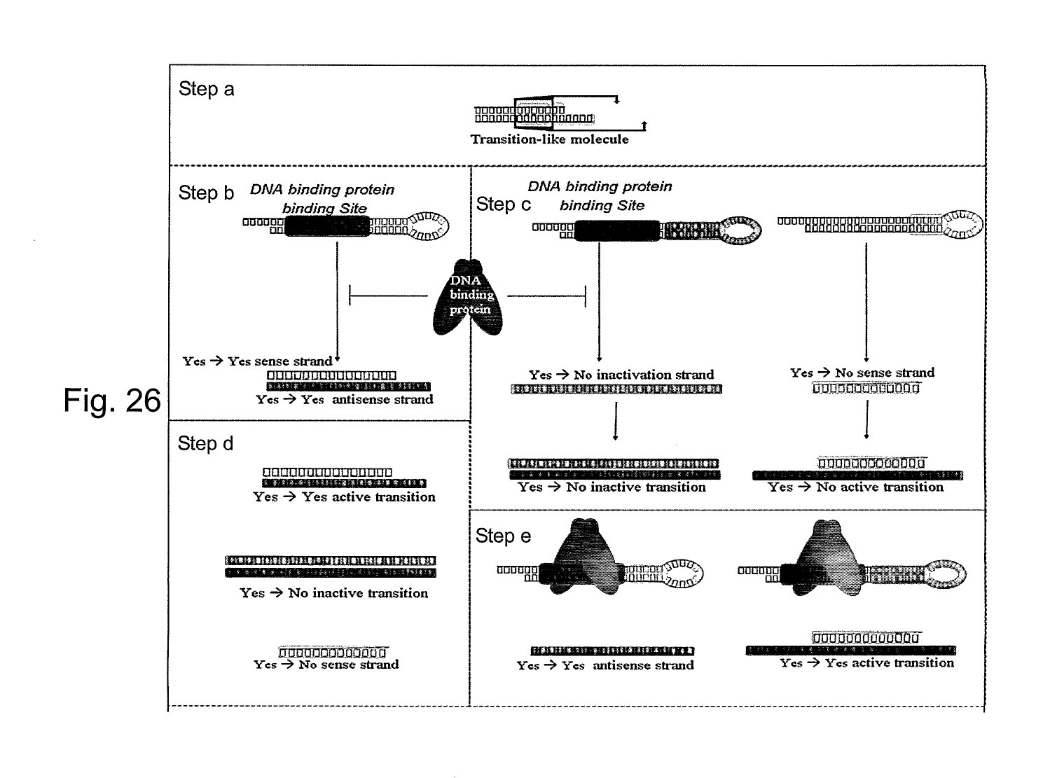

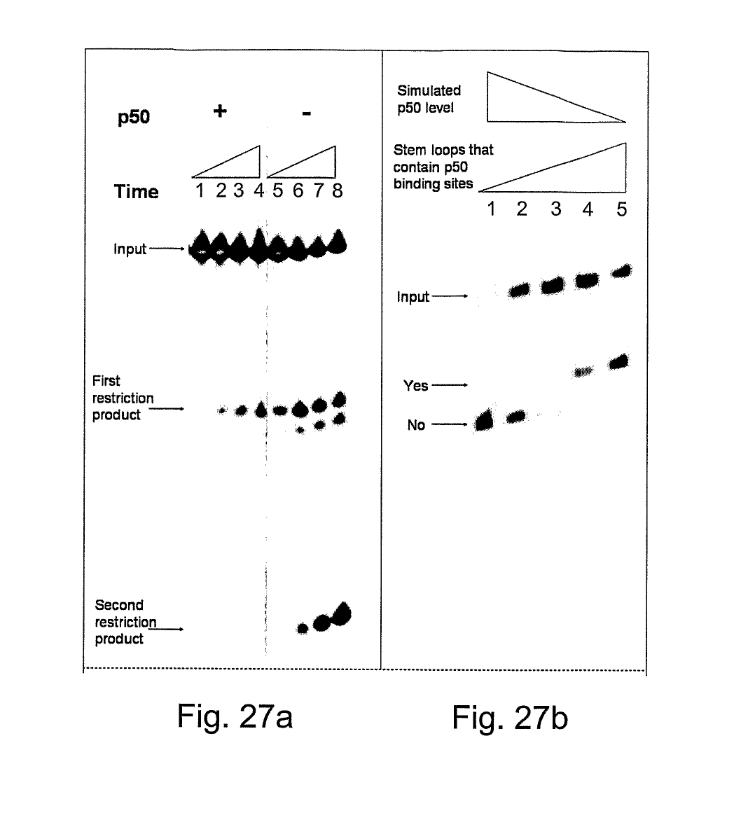

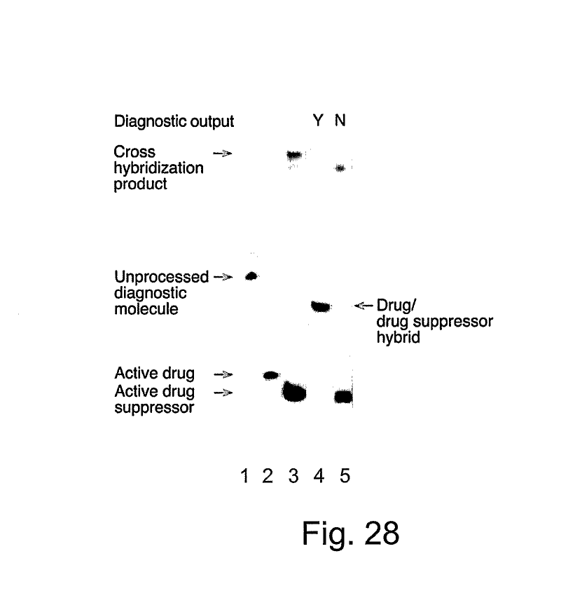

FIGS. 5a-c depict experimental results with illustrative implementations of the molecular computer of the present invention. FIG. 5a—Validation of the diagnostic automata with the diagnosis rules for SCLC and PC described in FIG. 1b. Each lane shows the result of diagnostic computation for the indicated composition of diseases symptoms. Y=Yes, N=No; FIG. 5b—Selectivity of the diagnostic automata for the disease models. Each pair of lanes is a particular combination of the molecular indicators indicated and is diagnosed separately by the automata for SCLC (left lane) and PC (right lane). + indicates presence of disease indicators, − indicates a normal condition, and * indicates absence of disease-related molecules. Expected outcome of the diagnosis is indicated above each lane; FIG. 5c is a gel depicting parallel detection of two diseases by two diagnostic automata. The diagnosed environment contains a two-symptom model of SCLC, represented by the diagnostic string PTTG1↑CDKN2A↑SCLC and a two-symptom model of PC represented by the string PIM1↑HEPSIN↑PC. The presence of symptoms and the expected diagnostic output by each automaton are indicated above the lanes.

FIGS. 6a-f are gels (FIGS. 6a, 6c and 6e) and the respective quantitation graphs (FIGS. 6b, 6d and 6f) depicting experimental results of drug administration by the molecular computer of the present invention. FIGS. 6a and b depict the release of an active drug by a drug-release PPAP2B↓GSTP1↓PIM1↑HEPSIN↑ diagnostic molecule, showing absolute amount of the active drug versus positive diagnosis probability; FIGS. 6c and d depict different diagnostic outcomes modeled using active transition molecules with a mixture of equal amounts of the drug-release and drug-suppressor-release moieties for the diagnostic string PPAP2B↓GSTP5. Each lane shows the distribution of drug-administration moieties, active drug, excess drug suppressor and drug/drug-suppressor hybrid, as indicated. FIGS. 6e and f depict variations in the distribution of active drug, excess drug suppressor and drug/drug-suppressor hybrid for a given diagnostic outcome and for varying relative amount of drug release and drug-suppressor release diagnostic moiety.

FIG. 7 depicts sequences (SEQ ID NOs:64-82) of transition molecules for SCLC diagnostic moiety. Color code corresponds to the color code of the transition molecules schematically depicted in FIGS. 2b and c.

FIG. 8 depicts sequences (SEQ ID NOs:47-51) of ssDNA models for SCLC symptoms. Color code corresponds to the color code of the molecules schematically depicted in FIGS. 2b and 2c.

FIG. 9 depicts sequences (SEQ ID NOs:96-106) of transition molecules for PC diagnostic moiety. Color code corresponds to the color code of the molecules schematically depicted in FIGS. 2b and c.

FIG. 10 depicts sequences (SEQ ID NOs:52-55) of ssDNA models for PC symptoms. Color code corresponds to the color code of the molecules schematically depicted in FIGS. 2b and 2c.

FIG. 11 depicts sequences (SEQ ID NOs:56-63) of diagnostic strings for SCLC and PC. Color code corresponds to the color code of the molecules schematically depicted in FIG. 2a.

FIG. 12 depicts sequences (SEQ ID NOs:83-88) of molecules related to drug administration. Color code corresponds to the color code of the molecules schematically depicted in FIG. 3.

FIG. 13 depicts sequences (SEQ ID NOs:89-91) of molecules involved in single-step computation with pTRI-Xef mRNA. Color code corresponds to the color code of the molecules schematically depicted in FIGS. 2b and 2c.

FIG. 14 depicts sequences (SEQ ID NOs:92-95) of molecules used for the detection of the point mutation. Color code corresponds to the color code of the molecules schematically depicted in FIG. 2d.

FIG. 15 depicts sequences (SEQ ID NOs:14-21) of transition molecules for SCLC diagnostic moiety.

FIGS. 16a-c are a gel (FIG. 16a) and graphs (FIGS. 16b and c) depicting experimental verification of the “sensitivity region” theory. FIG. 16a depicts a calibration experiment in which the marker was added to a final concentration of 0, 0.5, 1, 1.5 or 2 mM in the presence (lanes 6-10) or absence (lanes 1-5) of d_regT.s (SEQ ID NO:14) and u_reg.P (SEQ ID NO:17) which are the ssDNA molecules that interact with the mRNA molecule. Both of input strands were labeled and the computation result was determined from the antisense restriction products. FIGS. 16b-c depict analysis of relative pixel count of the experiment depicted in FIG. 16a, in the presence (FIG. 16c) or absence (FIG. 16b) of 1 μM d_regT.s and u_reg.P. Net (without background) S0 plus S1 pixel count result was considered to be 100%.

FIGS. 17a-b are a gel (FIG. 17a) and a graph (FIG. 17b) depicting the drug activity through the RNase H pathway. FIG. 17a—SDS-PAGE (10%) analysis of Mdm2 in vitro translation with increased drug amount and in the absence (lanes 1-7) or presence (lanes 8-14) of RNase H. FIG. 17b—Quantification of the results by net pixel count. Positive references in lanes 1 and 8, which contained no drug, were set to be 100%.

FIGS. 18a-b are gels depicting the interactions between output-module components in two sets of modules encompassing a loop length of 10 nt (OP1-OP4; FIG. 18a) and 18 nt (OP5-OP8; FIG. 18b). Lanes 1-4 in each gel are references in which hybridization was forced by heating to 99° C. and slowly cooled down. Lanes 5-7 in each gel are set to check kinetics, by calibrating the incubation time. The specific reaction conditions used in each lane are summarized in Table 4 in Example 3 of the Examples section which follows. Non-specific products can be seen only when the second set of module was used (upper bands, FIG. 18b).

FIG. 19 is a gel depicting testing the minimal stem length. A 14 nt long stem was tested with a complementary short oligonucleotide. Lane 1—self-annealed stem pOP5test, lane 2—the short oligonucleotide pOP6test, lane 3—a “forced annealing” product of pOP5test and pOP6test, lanes 4-6 incubation in various temperatures (15° C., 23° C. and 37° C.).

FIGS. 20a-b depict drug and drug suppressor effects on Mdm2 translation in vitro. FIG. 20a is an SDS-PAGE (10%) analysis of in vitro translation of Mdm2. Lane 1—reference reaction, lanes 2-4 include increasing concentrations of the drug: lane 2—7.5 pmol, lane 3—10 pmol and lane 4—15 pmol, lane 5-7 include increasing concentrations of the drug suppressor: lane 5—7.5 pmol, lane 6—10 pmol and lane 7—15 pmol. FIG. 20b is a histogram depicting the quantification of the results observed by the gel of FIG. 20b using net pixel count. Lane 1 (the reference) was set to be 100%.

FIGS. 21a-b depict the effect of computer components on Mdm2 translation. FIG. 21a is a gel depicting in vitro translation of Mdm2 in the presence of different oligonucleotides at the concentrations indicated in Table 5 in Example 3 of the Examples section which follows. FIG. 21b is an histogram depicting the quantification of the results observed by the gel of FIG. 21a using net pixel count. Lane 1 (reference) was set to be 100%.

FIGS. 22a-b depict the effect of computer components on Mdm2 translation using a transcription-translation kit with an internal control. FIG. 22a is a gel depicting Mdm2 and Luciferase expression in the presence of different oligonucleotides (representing automaton components) at the concentrations indicated in Table 6 in Example 3 of the Examples section which follows. To determine the pathway in which the drug effects translation, the reactions were performed in the absence (lanes 1-9) or presence (lanes 10-14) of RNase H. FIG. 22b is an histogram depicting the quantification of the results observed by the gel of FIG. 22a using net pixel count. Lane 1 (reference) was set to be 100%. Lane 10 should be referred to as a reference for the RNase H added reactions (lanes 10-14).

FIGS. 23a-b depict the effect of computer components on Bcl2 expression using an in vitro transcription-translation kit. FIG. 23a is a gel depicting Bcl2 expression in the presence of different oligonucleotides (representing automaton components) at the concentrations indicated in Table 7 in Example 3 of the Examples section which follows. To determine the pathway in which the drug effects translation, reactions were performed in the absence (lanes 1-13) or presence (lanes 14-17) of RNase H. FIG. 23b is an histogram depicting the quantification of the results observed by the gel of FIG. 23a using net pixel count. Lane 1 (reference) was set to be 100% for the reactions presented in lanes 1-13 and lane 10 was set to be the 100% for the reactions presented in lanes 10-14.

FIGS. 24a-b are schematic illustrations depicting a new input module embedded into the automaton design. FIG. 24a—A diagnostic rule that states that if P50 is under-expressed and GSTP is over-expressed then administer an aDNA drug which exhibit, in this case, the sequence NNN . . . NNN. FIG. 24b—Schematic representation of the new input module, when embedded into the old automaton. The two input modules sense different disease indicators in the biologic environment (DNA binding proteins and mRNA) and transform the data into an “automaton language”. The computation module calculates the probability of a disease (i.e., diagnose). Then, if the diagnosis is positive the output module produces a drug, if not—it does nothing.

FIG. 25 is a schematic illustration depicting a stepwise molecular realization of a computation process of the rule depicted in FIGS. 24a-b, in which the input module reaches a high (but not complete) confidence in the presence of the indicator (p50↓). Step a—Stochastic processing of the p50 symbol thus occurs, and the computation result is accordingly; Step b—Upon positive diagnosis (more Yes than No) the output module produces a drug at an amount that reflects the automaton confidence in the existence of the disease.

FIG. 26 is a schematic illustration depicting stepwise mechanisms of input module. The transition-like molecule bound to FokI is presented in A. Together, the presented molecules perform the stem cleavage, in a stem-specific manner. In this case, all three stems can be cleaved by this molecule. B—A stem containing DNA binding protein binding site in its sequence is cleaved only in the absence of protein (e.g., in case of detecting p50↓), to produce the positive transition sense strand. C—The rightmost stem is cleaved, independently of protein indicator to produce the negative transition sense strand. Another stem (the leftmost) contains the DNA binding protein binding site in its sequence. It is therefore cleaved only in the protein absence, to produce a ssDNA capable of annealing to the negative transition antisense strand, without forming an active transition. This annealing is more stable, thus prevents the negative transition formation. D—The overall products of the system when the DNA binding protein is absence. All stems can be cleaved, and the prevailing transition is the positive one (in this case). E—The overall products of the system when the DNA binding protein is presence. Only one stem can be cleaved, and the prevailing transition is the negative one (in this case). The other two stems are “protected” from cleavage by the protein.

FIGS. 27a-b are gels depicting the detection of p50 by the molecular automaton. FIG. 27a depicts time points of restriction reaction of a ³²P labeled stem-like dsDNA. The restriction is done by FokI after binding to a transition-like molecule that hybridizes to the stem-like molecule. The stem-like dsDNA molecule contains two p50 binding sites. Lanes 1, 2, 3, and 4 are 5, 15, 30, and 60 minutes time aliquots, respectively, from a reaction with the presence of p50 (4.4 gel shift units, rhNF-kappaB p50, Promega E3770). Lanes 5-8 are the same time aliquots from a reaction, in the absence of p50. FIG. 27b—Simulation of p50 sensing by the automaton. Lanes 1 contains a reaction with the presence of both of stem loops that p50 can bind (simulates p50 absence), lanes 2-5 contain reactions with a decreased amount of these stem loops (simulates increasing p50 concentration).

FIG. 28 is a gel depicting the release of the approved antisense drug. Lane 1—labeled diagnostic molecule, lane—labeled drug molecule, lane 3—non-labeled diagnostic molecule together with a labeled drug suppressor, incubated in NEB4 buffer, lane 4—depicts the release of an active Vitravene® drug upon positive diagnosis as visualized by the labeled drug suppressor probe, lane 5—depicts that the active drug is not released upon negative diagnosis.

### DETAILED DESCRIPTION OF PREFERRED EMBODIMENTS

The present invention is of an autonomous molecular computer that, when coupled to a molecular model of a disease, is capable of disease diagnosis. The computer preferably performs such diagnosis by detecting one or more disease markers. For example, optionally and preferably the molecular computer checks for the presence of over-expressed, under-expressed and mutated genes, applies programmed medical knowledge to this information to reach a diagnostic decision.

More preferably, the computer administers the requisite treatment, such as a drug molecule, most preferably anti-sense chemotherapy, upon diagnosis.

According to preferred embodiments of the present invention, the autonomous molecular computer is preferably capable of diagnosis of small-cell lung cancer and of prostate cancer, optionally through a detection of one or more disease markers determined according to a simplified molecular model of each disease. More preferably, the computer is able to administer upon diagnosis the requisite anti-sense chemotherapy for treating these diseases.

According to preferred embodiments of the present invention, there is provided an autonomous biomolecular computer that logically analyzes the levels of messenger RNA species, and in response produces a molecule capable of affecting levels of gene expression. The computer preferably operates at a concentration close to a trillion computers per microliter, and optionally and preferably consists of three programmable modules: a computation module, a stochastic molecular automaton; an input module, by which specific mRNA levels or point mutations regulate software molecule concentrations, and hence automaton transition probabilities; and an output module, capable of controlled release of a short single-stranded (ss) DNA molecule.

Examples of in vivo applications of this approach optionally include but are not limited to, bio-sensing, genetic engineering, and medical diagnosis and treatment. As a non-limiting, illustrative example only, the experimental examples below (particularly in Example 2) describe a molecular computer that was designed and programmed to identify and analyze mRNA of disease-related genes associated with models of small-cell lung cancer (SCLC) and prostate cancer (PC), and to produce a ssDNA molecule modeled after an anti-cancer drug.

Optionally, the molecular computer according to the present invention may comprise a plurality of polymeric molecules, including but not limited to, oligonucleotides, and peptides and/or polypeptides. The polymeric molecules may optionally be heteropolymeric (featuring a plurality of different types of subunits) or homopolymeric (featuring a single type of subunit, such as a non-substituted and/or altered, or “natural” DNA molecule for example), but preferably should feature a plurality of monomers that are capable of holding information.

According to preferred embodiments of the present invention, a molecular medical computer (FIG. 1b) is an autonomous molecular computer that can be programmed to check for disease symptoms; to diagnose these symptoms according to medical knowledge; and to administer, upon diagnosis, the requisite drug at the required dosage and timing. The molecular computer was shown to be able to perform these operations in vitro on simplified molecular models of diseases. The disease models consist of a combination of several molecular disease markers, including over expressed, under expressed and mutated genes, that were found to be reliable evidence for cancer³⁸⁻⁴² and hereditary diseases⁴³. Any DNA or RNA molecule of sufficient length may serve as a disease marker for the present invention, making it highly flexible.

The medical knowledge for molecular diagnosis and therapy is encoded in rules (FIG. 1c), which state, for a particular disease and its associated molecular markers, that if these markers are present then diagnose the disease or administer an appropriate drug. For example and without wishing to be limiting in any way, the first rule in FIG. 1c states that if achaete-scute complex-like gene 1 (ASCL1), glutamate receptor, ionotropic, AMPA2 (alpha 2) gene (GRIA2), insulinoma-associated gene 1 (INSM1) and pituitary tumor-transforming gene 1 (PTTG1) are over expressed compared to normal cells then diagnose small-cell lung cancer³⁸ (SCLC). The second rule in FIG. 1c states if these same symptoms are present then administer the ssDNA molecule TCTCCCAGCGTGCGCCAT (SEQ ID NO:1; Oblimersen), purported to be an antisense therapy drug for SCLC⁴⁴. The third diagnosis rule states that if phosphatidic acid phosphatase type 2B (PPAP2B) and glutathione S-transferase pi genes (GSTP1) are under expressed and serine/threonine kinase pim-1 gene (PIM1) and hepsin protease gene (HEPSIN) are over expressed compared to normal cells, then diagnose prostate cancer⁴⁰ (PC). The fourth rule states that under the same conditions administer the ssDNA molecule GTTGGTATTGCACAT (SEQ ID NO:2), purported to be a drug for PC45. While these diagnosis and therapy rules are based on quantitative biomedical data they are presented here qualitatively and utilize only a small number of symptoms compared to the actual medical knowledge on these diseases.

Its core computational component is a molecular two-state finite automaton^{22,24} (FIG. 1a), adapted for stochastic processing^{26,27} of diagnosis and therapy rules (FIGS. 1d and 1e). To facilitate processing of a diagnosis rule, it is encoded as a string consisting of one symbolic name for each disease symptom, followed by a name of the diagnosed disease. For example, the diagnostic string for small-cell lung cancer is “ASCL1↑GRIA2↑INSM1↑PTTG1↑SCLC” and for prostate cancer is “PPAP2B↓GSTP1↓PIM1↑HEPSIN↑PC”. The automaton starts processing a diagnostic string in the state Yes and verifies one marker at a time, using its transition rules^{5,22,24} (FIGS. 1d and 1e). For each marker name, if the marker is present, the automaton continues in state Yes, otherwise it changes to the state No and remains in that state checking subsequent symptoms. If the automaton reaches the disease name being in state Yes it diagnoses the disease, otherwise it does not.

As the result of examining the presence and severity of a molecular disease symptom is uncertain in nature, so is the diagnosis. Hence a probabilistic computing framework is preferably provided for the diagnosis task³⁴⁻³⁷. The exemplary molecular diagnostic automaton is preferably stochastic^{26,27}, with two competing transitions, 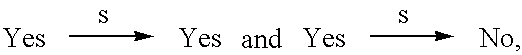
for each symptom S. A symptom S is verified by the automaton transition rule 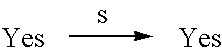
and fails verification by the transition rule 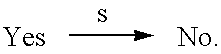
The input component of the molecular automaton regulates these transitions by the molecular disease symptoms: if the symptom S is present with high certainty in the disease model, then the relative concentration and hence the probability of the transition 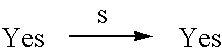
is high, and the relative concentration and the probability of its competitor 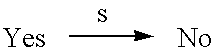
is correspondingly low, as the two probabilities must add to 1; similarly, if the symptom S is present with low certainty then the probability of 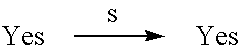
is low and of 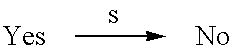
is high.

As the automaton starts the computation in the state Yes, the probability of it ending the sequence of diagnostic checks specified in the diagnostic string in state Yes is the certainty that these symptoms jointly hold. For example, the computation on the second string would diagnose prostate cancer with high certainty only when PPAP2B and GSTP1 are under expressed and PIM1 and HEPSIN are over expressed with high certainty compared to a given base level.

Upon diagnosing a disease, the molecular computer produces a single-stranded DNA (ssDNA) molecule purported to be an anti-sense drug for this disease. The computer can be calibrated to administer the drug only when the certainty of the diagnosis is above a given threshold. Independent diagnosis and therapy rules for multiple diseases can be realized by multiple automata that operate simultaneously and independently within the same biochemical environment. Optionally and preferably, different quantities can be generated based on different diagnostic outcomes.

More specifically FIGS. 1a-e may be described as follows: FIG. 1a illustrates architecture of the molecular finite automaton^{22,24}. The state of the computation is implemented by partial cleavage of the dsDNA segment representing a symbol and exposing a four-nucleotide “sticky end” at a predefined state-specific location. Transition between states is accomplished by a transition molecule bound to the FokI hardware enzyme. The transition molecule recognizes particular state-symbol sticky end and directs the hardware enzyme to cleave within the next symbol at a precise location and to expose the next state-symbol combination. FIG. 1b illustrates major components of the medical molecular computer. FIG. 1c illustrates examples of diagnosis and therapy rules for simplified models of SCLC and PC, indicating the disease symptoms to be verified, namely over expression (↑) or under expression (↓) of a disease-related gene. Example diagnostic rules for simplified models of SCLC19 and PC20, indicating over-expression (↑) or under-expression (↓) of a disease-related gene. The first rule states that if the genes ASCL1, GRIA2, INSM1 and PTTG1 are over-expressed then administer the ssDNA molecule TCTCCCAGCGTGCGCCAT (SEQ ID NO:1; Oblimersen), purported to be an antisense therapy drug for SCLC26. The second rule states that if the genes PPAP2B and GSTP1 are under-expressed and the genes PIM1 and HEPSIN are over-expressed then administer the ssDNA molecule GTTGGTATTGCACAT (SEQ ID NO:2), purported to be a drug for PC. FIG. 1d illustrates a design of the diagnostic automaton. FIG. 1e illustrates a graphical representation of the computation that diagnoses PC.

Taking the cue from the terminology of medical treatment, the molecular computer may optionally be considered to perform a computational version of ‘diagnosis’, the identification of a combination of mRNA molecules at specific levels which in the present example is a highly-simplified model of cancer; and ‘therapy’, production of a bioactive molecule which for the present example is a drug-like ssDNA with known anticancer activity (FIG. 1c). The computer operation is governed by a ‘diagnostic rule’ that encodes medical knowledge in simplified form (FIG. 1c). The left-hand side of the rule consists of a list of molecular indicators for a specific disease, and its right-hand side indicates a molecule to be released, which could be a drug for that disease. For example, the diagnostic rule for PC states that if the genes PPAP2B and GSTP1 are under-expressed and the genes PIM1 and HEPSIN are over-expressed, then administer the ssDNA molecule GTTGGTATTGGACATG (SEQ ID NO:2) that inhibits the synthesis of the protein MDM2 by binding to its mRNA. The computer design is flexible in that any sufficiently long RNA molecule can function as a molecular indicator and any short ssDNA molecule, up to at least 21 nucleotides, can be administered.

The computation module is a molecular automaton (FIG. 1a) that processes such a rule as depicted in FIG. 1e. The automaton has two states, positive (Yes) and negative (No). The computation starts in the positive state and if it ends in that state the result is a ‘positive diagnosis’, otherwise ‘negative diagnosis’. To facilitate rule processing by the automaton, the left-hand side of the diagnostic rule is represented as a string of symbolic indicators, or symbols for short, one for each molecular indicator. For example, the string for the PC rule is PPAP2B↓GSTP1↓PIM1↑HEPSIN↑. For each symbol the automaton has three types of transitions: positive (Yes→Yes); negative (Yes→No); and neutral (No→No). The automaton processes the string from left to right, one symbol at a time. When processing a symbol in the positive state, the computer takes the positive transition if it determines that the molecular indicator is present and the negative transition, changing to a negative state, otherwise. Since the No→Yes transition is not allowed, once the automaton enters the negative state it can use only the neutral transition and thus remains in the negative state for the duration of the computation.

The possible computation paths of the automaton processing the PC diagnostic rule are shown in FIG. 1e. The molecular automaton is stochastic in that it has two competing transitions, positive and negative, for each symbol while in the positive state. A novel molecular mechanism, explained below, regulates the probability of each positive transition by the corresponding molecular indicator, so that the presence of the indicator increases the probability of a positive transition and decreases the probability of its competing negative transition, and vice versa if the indicator is absent. Since the confidence with which the presence or absence of an indicator can be determined is a continuous, rather than a discrete parameter, so is the regulation of transition probabilities, the level of which is correlated with this confidence. The resulting stochastic behavior of the automaton is governed by the confidence in the presence of each indicator, so that the probability of a positive diagnosis is the product of the probabilities of the positive transitions for each of the indicators processed (Appendix A). By changing the ratio between positive and negative transitions for a particular indicator, a fine control over the sensitivity of diagnosis to the presence of that indicator can be achieved. It is worth noting that the unusual use of automaton components, i.e., its formal input and the diagnostic rule to be processed, functions in the present application like a program, and its formal program, the software molecules, function in the present application as part of the input module, detecting the presence of molecular indicators.

Instead of releasing an output molecule on positive diagnosis and doing nothing on negative diagnosis, the present inventors opted to release a biologically-active molecule, for example a drug, on positive diagnosis and its suppressor molecule on negative diagnosis. This allows fine control over the diagnosis confidence threshold beyond which an active drug is administered. Rather than using a single automaton for both tasks, optionally and preferably this may be implemented by using two types of automata, one that releases a drug molecule upon positive diagnosis; and another that releases a drug-suppressor molecule upon negative diagnosis. The ratio between the drug and drug-suppressor molecules released by a population of automata of these two types determines the final active drug concentration.

According to one aspect of the present invention there is provided an autonomous molecular computer capable of disease diagnosis, comprising: a molecular model of a disease being coupled to the computer.

As used herein the phrase “molecular model of a disease” refers to any DNA, RNA, protein or metabolite molecule(s) characterizing the presence of the disease. Such a molecular model can be over-expression, under-expression, presence, absence, and/or mutated form of the DNA, RNA, protein or metabolite molecules as present under normal conditions when the disease is absent. The disease used by the present invention can be any disease, disorder or pathology present in an individual or in a biological sample derived from the individual.

According to one embodiment of the present invention the disease comprises at least one small-cell lung cancer and/or prostate cancer.

According to preferred embodiments of the present invention, the computer is for performing the diagnosis by detecting at least one disease marker.

Preferably, the computer further comprises programmed medical knowledge (e.g., the transition molecules for Yes or No diagnosis as described hereinabove and in the Examples section which follows) for being applied to the diagnosis.

Preferably, the computer of the present invention is being capable of administering the requisite treatment upon diagnosis.

The requisite treatment of the present invention which is capable of being administered by the computer of the present invention is a drug molecule such as an oligonucleotide.

The term “oligonucleotide” refers to a single stranded or double stranded oligomer or polymer of ribonucleic acid (RNA) or deoxyribonucleic acid (DNA) or mimetics thereof. This term includes oligonucleotides composed of naturally-occurring bases, sugars and covalent internucleoside linkages (e.g., backbone) as well as oligonucleotides having non-naturally-occurring portions which function similarly to respective naturally-occurring portions.

Oligonucleotides designed according to the teachings of the present invention can be generated according to any oligonucleotide synthesis method known in the art such as enzymatic synthesis or solid phase synthesis. Equipment and reagents for executing solid-phase synthesis are commercially available from, for example, Applied Biosystems. Any other means for such synthesis may also be employed; the actual synthesis of the oligonucleotides is well within the capabilities of one skilled in the art and can be accomplished via established methodologies as detailed in, for example, “Molecular Cloning: A laboratory Manual” Sambrook et al., (1989); “Current Protocols in Molecular Biology” Volumes I-III Ausubel, R. M., ed. (1994); Ausubel et al., “Current Protocols in Molecular Biology”, John Wiley and Sons, Baltimore, Md. (1989); Perbal, “A Practical Guide to Molecular Cloning”, John Wiley & Sons, New York (1988) and “Oligonucleotide Synthesis” Gait, M. J., ed. (1984) utilizing solid phase chemistry, e.g. cyanoethyl phosphoramidite followed by deprotection, desalting and purification by for example, an automated trityl-on method or HPLC.

The oligonucleotide of the present invention is of at least 17, at least 18, at least 19, at least 20, at least 22, at least 25, at least 30 or at least 40, bases specifically hybridizable with sequence alterations described hereinabove.

The oligonucleotides of the present invention may comprise heterocylic nucleosides consisting of purines and the pyrimidines bases, bonded in a 3′ to 5′ phosphodiester linkage.

Preferably used oligonucleotides are those modified in either backbone, internucleoside linkages or bases, as is broadly described hereinunder.

Specific examples of preferred oligonucleotides useful according to this aspect of the present invention include oligonucleotides containing modified backbones or non-natural internucleoside linkages. Oligonucleotides having modified backbones include those that retain a phosphorus atom in the backbone, as disclosed in U.S. Pat. Nos. 4,469,863; 4,476,301; 5,023,243; 5,177,196; 5,188,897; 5,264,423; 5,276,019; 5,278,302; 5,286,717; 5,321,131; 5,399,676; 5,405,939; 5,453,496; 5,455,233; 5,466,677; 5,476,925; 5,519,126; 5,536,821; 5,541,306; 5,550,111; 5,563,253; 5,571,799; 5,587,361; and 5,625,050.

Preferred modified oligonucleotide backbones include, for example, phosphorothioates, chiral phosphorothioates, phosphorodithioates, phosphotriesters, aminoalkyl phosphotriesters, methyl and other alkyl phosphonates including 3′-alkylene phosphonates and chiral phosphonates, phosphinates, phosphoramidates including 3′-amino phosphoramidate and aminoalkylphosphoramidates, thionophosphoramidates, thionoalkylphosphonates, thionoalkylphosphotriesters, and boranophosphates having normal 3′-5′ linkages, 2′-5′ linked analogs of these, and those having inverted polarity wherein the adjacent pairs of nucleoside units are linked 3′-5′ to 5′-3′ or 2′-5′ to 5′-2′. Various salts, mixed salts and free acid forms can also be used.

Alternatively, modified oligonucleotide backbones that do not include a phosphorus atom therein have backbones that are formed by short chain alkyl or cycloalkyl internucleoside linkages, mixed heteroatom and alkyl or cycloalkyl internucleoside linkages, or one or more short chain heteroatomic or heterocyclic internucleoside linkages. These include those having morpholino linkages (formed in part from the sugar portion of a nucleoside); siloxane backbones; sulfide, sulfoxide and sulfone backbones; formacetyl and thioformacetyl backbones; methylene formacetyl and thioformacetyl backbones; alkene containing backbones; sulfamate backbones; methyleneimino and methylenehydrazino backbones; sulfonate and sulfonamide backbones; amide backbones; and others having mixed N, O, S and CH2 component parts, as disclosed in U.S. Pat. Nos. 5,034,506; 5,166,315; 5,185,444; 5,214,134; 5,216,141; 5,235,033; 5,264,562; 5,264,564; 5,405,938; 5,434,257; 5,466,677; 5,470,967; 5,489,677; 5,541,307; 5,561,225; 5,596,086; 5,602,240; 5,610,289; 5,602,240; 5,608,046; 5,610,289; 5,618,704; 5,623,070; 5,663,312; 5,633,360; 5,677,437; and 5,677,439.

Other oligonucleotides which can be used according to the present invention, are those modified in both sugar and the internucleoside linkage, i.e., the backbone, of the nucleotide units are replaced with novel groups. The base units are maintained for complementation with the appropriate polynucleotide target. An example for such an oligonucleotide mimetic, includes peptide nucleic acid (PNA). A PNA oligonucleotide refers to an oligonucleotide where the sugar-backbone is replaced with an amide containing backbone, in particular an aminoethylglycine backbone. The bases are retained and are bound directly or indirectly to aza nitrogen atoms of the amide portion of the backbone. United States patents that teach the preparation of PNA compounds include, but are not limited to, U.S. Pat. Nos. 5,539,082; 5,714,331; and 5,719,262, each of which is herein incorporated by reference. Other backbone modifications, which can be used in the present invention are disclosed in U.S. Pat. No. 6,303,374.

Oligonucleotides of the present invention may also include base modifications or substitutions. As used herein, “unmodified” or “natural” bases include the purine bases adenine (A) and guanine (G), and the pyrimidine bases thymine (T), cytosine (C) and uracil (U). Modified bases include but are not limited to other synthetic and natural bases such as 5-methylcytosine (5-me-C), 5-hydroxymethyl cytosine, xanthine, hypoxanthine, 2-aminoadenine, 6-methyl and other alkyl derivatives of adenine and guanine, 2-propyl and other alkyl derivatives of adenine and guanine, 2-thiouracil, 2-thiothymine and 2-thiocytosine, 5-halouracil and cytosine, 5-propynyl uracil and cytosine, 6-azo uracil, cytosine and thymine, 5-uracil (pseudouracil), 4-thiouracil, 8-halo, 8-amino, 8-thiol, 8-thioalkyl, 8-hydroxyl and other 8-substituted adenines and guanines, 5-halo particularly 5-bromo, 5-trifluoromethyl and other 5-substituted uracils and cytosines, 7-methylguanine and 7-methyladenine, 8-azaguanine and 8-azaadenine, 7-deazaguanine and 7-deazaadenine and 3-deazaguanine and 3-deazaadenine. Further bases include those disclosed in U.S. Pat. No. 3,687,808, those disclosed in The Concise Encyclopedia Of Polymer Science And Engineering, pages 858-859, Kroschwitz, J. I., ed. John Wiley & Sons, 1990, those disclosed by Englisch et al., Angewandte Chemie, International Edition, 1991, 30, 613, and those disclosed by Sanghvi, Y. S., Chapter 15, Antisense Research and Applications, pages 289-302, Crooke, S. T. and Lebleu, B. ed., CRC Press, 1993. Such bases are particularly useful for increasing the binding affinity of the oligomeric compounds of the invention. These include 5-substituted pyrimidines, 6-azapyrimidines and N-2, N-6 and O-6 substituted purines, including 2-aminopropyladenine, 5-propynyluracil and 5-propynylcytosine. 5-methylcytosine substitutions have been shown to increase nucleic acid duplex stability by 0.6-1.2° C. [Sanghvi Y S et al. (1993) Antisense Research and Applications, CRC Press, Boca Raton 276-278] and are presently preferred base substitutions, even more particularly when combined with 2′-O-methoxyethyl sugar modifications.

Optionally and preferably, the drug molecule used by the computer of the present invention is antisense oligonucleotide, RNAi (siRNA), Ribozyme, DNAzyme and/or triplex forming oligonucleotides (TFO).

Antisense oligonucleotides—Design of antisense molecules which can be used to efficiently downregulate a specific protein or mRNA must be effected while considering two aspects important to the antisense approach. The first aspect is delivery of the oligonucleotide into the cytoplasm of the appropriate cells, while the second aspect is design of an oligonucleotide which specifically binds the designated mRNA within cells in a way which inhibits translation thereof.

The prior art teaches of a number of delivery strategies which can be used to efficiently deliver oligonucleotides into a wide variety of cell types [see, for example, Luft J Mol Med 76: 75-6 (1998); Kronenwett et al. Blood 91: 852-62 (1998); Rajur et al. Bioconjug Chem 8: 935-40 (1997); Lavigne et al. Biochem Biophys Res Commun 237: 566-71 (1997) and Aoki et al. (1997) Biochem Biophys Res Commun 231: 540-5 (1997)].

In addition, algorithms for identifying those sequences with the highest predicted binding affinity for their target mRNA based on a thermodynamic cycle that accounts for the energetics of structural alterations in both the target mRNA and the oligonucleotide are also available [see, for example, Walton et al. Biotechnol Bioeng 65: 1-9 (1999)].

Such algorithms have been successfully used to implement an antisense approach in cells. For example, the algorithm developed by Walton et al. enabled scientists to successfully design antisense oligonucleotides for rabbit beta-globin (RBG) and mouse tumor necrosis factor-alpha (TNF alpha) transcripts. The same research group has more recently reported that the antisense activity of rationally selected oligonucleotides against three model target mRNAs (human lactate dehydrogenase A and B and rat gp130) in cell culture as evaluated by a kinetic PCR technique proved effective in almost all cases, including tests against three different targets in two cell types with phosphodiester and phosphorothioate oligonucleotide chemistries.

In addition, several approaches for designing and predicting efficiency of specific oligonucleotides using an in vitro system were also published (Matveeva et al., Nature Biotechnology 16: 1374-1375 (1998)]. Specific examples of antisense oligonucleotides for prostate cancer or small lung cell cancer are provided in the Examples section which follows.

Several clinical trials have demonstrated safety, feasibility and activity of antisense oligonucleotides. For example, antisense oligonucleotides suitable for the treatment of cancer have been successfully used [Holmund et al., Curr Opin Mol Ther 1:372-85 (1999)], while treatment of hematological malignancies via antisense oligonucleotides targeting c-myb gene, p53 and Bcl-2 had entered clinical trials and had been shown to be tolerated by patients [Gerwitz Curr Opin Mol Ther 1:297-306 (1999)].

More recently, antisense-mediated suppression of human heparanase gene expression has been reported to inhibit pleural dissemination of human cancer cells in a mouse model [Uno et al., Cancer Res 61:7855-60 (2001)].

Thus, the current consensus is that recent developments in the field of antisense technology which, as described above, have led to the generation of highly accurate antisense design algorithms and a wide variety of oligonucleotide delivery systems, enable an ordinarily skilled artisan to design and implement antisense approaches suitable for downregulating expression of known sequences without having to resort to undue trial and error experimentation.

RNAi (siRNA)—RNA interference (RNAi) is a two step process. The first step, which is termed as the initiation step, input dsRNA is digested into 21-23 nucleotide (nt) small interfering RNAs (siRNA), probably by the action of Dicer, a member of the RNase III family of dsRNA-specific ribonucleases, which processes (cleaves) dsRNA (introduced directly or via a transgene or a virus) in an ATP-dependent manner. Successive cleavage events degrade the RNA to 19-21 bp duplexes (siRNA), each with 2-nucleotide 3′ overhangs [Hutvagner and Zamore Curr. Opin. Genetics and Development 12:225-232 (2002); and Bernstein Nature 409:363-366 (2001)].

In the effector step, the siRNA duplexes bind to a nuclease complex to from the RNA-induced silencing complex (RISC). An ATP-dependent unwinding of the siRNA duplex is required for activation of the RISC. The active RISC then targets the homologous transcript by base pairing interactions and cleaves the mRNA into 12 nucleotide fragments from the 3′ terminus of the siRNA [Hutvagner and Zamore Curr. Opin. Genetics and Development 12:225-232 (2002); Hammond et al. (2001) Nat. Rev. Gen. 2:110-119 (2001); and Sharp Genes. Dev. 15:485-90 (2001)]. Although the mechanism of cleavage is still to be elucidated, research indicates that each RISC contains a single siRNA and an RNase [Hutvagner and Zamore Curr. Opin. Genetics and Development 12:225-232 (2002)].

Because of the remarkable potency of RNAi, an amplification step within the RNAi pathway has been suggested. Amplification could occur by copying of the input dsRNAs which would generate more siRNAs, or by replication of the siRNAs formed. Alternatively or additionally, amplification could be effected by multiple turnover events of the RISC [Hammond et al. Nat. Rev. Gen. 2:110-119 (2001), Sharp Genes. Dev. 15:485-90 (2001); Hutvagner and Zamore Curr. Opin. Genetics and Development 12:225-232 (2002)]. For more information on RNAi see the following reviews Tuschl ChemBiochem. 2:239-245 (2001); Cullen Nat. Immunol. 3:597-599 (2002); and Brantl Biochem. Biophys. Act. 1575:15-25 (2002).

Synthesis of RNAi molecules suitable for use with the present invention can be effected as follows. First, the mRNA sequence is scanned downstream of the AUG start codon for AA dinucleotide sequences. Occurrence of each AA and the 3′ adjacent 19 nucleotides is recorded as potential siRNA target sites. Preferably, siRNA target sites are selected from the open reading frame, as untranslated regions (UTRs) are richer in regulatory protein binding sites. UTR-binding proteins and/or translation initiation complexes may interfere with binding of the siRNA endonuclease complex [Tuschl ChemBiochem. 2:239-245]. It will be appreciated though, that siRNAs directed at untranslated regions may also be effective, as demonstrated for GAPDH wherein siRNA directed at the 5′ UTR mediated about 90% decrease in cellular GAPDH mRNA and completely abolished protein level (www.ambion.com/techlib/tn/91/912.html).

Second, potential target sites are compared to an appropriate genomic database (e.g., human, mouse, rat etc.) using any sequence alignment software, such as the BLAST software available from the NCBI server (www.ncbi.nlm.nih.gov/BLAST/). Putative target sites which exhibit significant homology to other coding sequences are filtered out.

Qualifying target sequences are selected as template for siRNA synthesis. Preferred sequences are those including low G/C content as these have proven to be more effective in mediating gene silencing as compared to those with G/C content higher than 55%. Several target sites are preferably selected along the length of the target gene for evaluation. For better evaluation of the selected siRNAs, a negative control is preferably used in conjunction. Negative control siRNA preferably include the same nucleotide composition as the siRNAs but lack significant homology to the genome. Thus, a scrambled nucleotide sequence of the siRNA is preferably used, provided it does not display any significant homology to any other gene.

DNAzymes—DNAzymes are single-stranded polynucleotides which are capable of cleaving both single and double stranded target sequences (Breaker, R. R. and Joyce, G. Chemistry and Biology 1995; 2:655; Santoro, S. W. & Joyce, G. F. Proc. Natl, Acad. Sci. USA 1997; 943:4262) A general model (the “10-23” model) for the DNAzyme has been proposed. “10-23” DNAzymes have a catalytic domain of 15 deoxyribonucleotides, flanked by two substrate-recognition domains of seven to nine deoxyribonucleotides each. This type of DNAzyme can effectively cleave its substrate RNA at purine:pyrimidine junctions (Santoro, S. W. & Joyce, G. F. Proc. Natl, Acad. Sci. USA 199; for rev of DNAzymes see Khachigian, L M [Curr Opin Mol Ther 4:119-21 (2002)].

Examples of construction and amplification of synthetic, engineered DNAzymes recognizing single and double-stranded target cleavage sites have been disclosed in U.S. Pat. No. 6,326,174 to Joyce et al. DNAzymes of similar design directed against the human Urokinase receptor were recently observed to inhibit Urokinase receptor expression, and successfully inhibit colon cancer cell metastasis in vivo (Itoh et al, 20002, Abstract 409, Ann Meeting Am Soc Gen Ther www.asgt.org). In another application, DNAzymes complementary to bcr-ab1 oncogenes were successful in inhibiting the oncogenes expression in leukemia cells, and lessening relapse rates in autologous bone marrow transplant in cases of CML and ALL.

Ribozymes—Ribozymes are being increasingly used for the sequence-specific inhibition of gene expression by the cleavage of mRNAs encoding proteins of interest [Welch et al., Curr Opin Biotechnol. 9:486-96 (1998)]. The possibility of designing ribozymes to cleave any specific target RNA has rendered them valuable tools in both basic research and therapeutic applications. In the therapeutics area, ribozymes have been exploited to target viral RNAs in infectious diseases, dominant oncogenes in cancers and specific somatic mutations in genetic disorders [Welch et al., Clin Diagn Virol. 10:163-71 (1998)]. Most notably, several ribozyme gene therapy protocols for HIV patients are already in Phase 1 trials. More recently, ribozymes have been used for transgenic animal research, gene target validation and pathway elucidation. Several ribozymes are in various stages of clinical trials. ANGIOZYME was the first chemically synthesized ribozyme to be studied in human clinical trials. ANGIOZYME specifically inhibits formation of the VEGF-r (Vascular Endothelial Growth Factor receptor), a key component in the angiogenesis pathway. Ribozyme Pharmaceuticals, Inc., as well as other firms have demonstrated the importance of anti-angiogenesis therapeutics in animal models. HEPTAZYME, a ribozyme designed to selectively destroy Hepatitis C Virus (HCV) RNA, was found effective in decreasing Hepatitis C viral RNA in cell culture assays (Ribozyme Pharmaceuticals, Incorporated—WEB home page).

Triplex forming oligonucleotides (TFOs)—Recent studies have shown that TFOs can be designed which can recognize and bind to polypurine/polypirimidine regions in double-stranded helical DNA in a sequence-specific manner. These recognition rules are outlined by Maher III, L. J., et al., Science, 1989; 245:725-730; Moser, H. E., et al., Science, 1987; 238:645-630; Beal, P. A., et al, Science, 1992; 251:1360-1363; Cooney, M., et al., Science, 1988; 241:456-459; and Hogan, M. E., et al., EP Publication 375408. Modification of the oligonucleotides, such as the introduction of intercalators and backbone substitutions, and optimization of binding conditions (pH and cation concentration) have aided in overcoming inherent obstacles to TFO activity such as charge repulsion and instability, and it was recently shown that synthetic oligonucleotides can be targeted to specific sequences (for a recent review see Seidman and Glazer, J Clin Invest 2003; 112:487-94).

In general, the triplex-forming oligonucleotide has the sequence correspondence:

| | | | | |
|---|---|---|---|---|
| oligo | 3′--A | G | G | T |
| duplex | 5′--A | G | C | T |
| duplex | 3′--T | C | G | A |

However, it has been shown that the A-AT and G-GC triplets have the greatest triple helical stability (Reither and Jeltsch, BMC Biochem, 2002, Sept 12, Epub). The same authors have demonstrated that TFOs designed according to the A-AT and G-GC rule do not form non-specific triplexes, indicating that the triplex formation is indeed sequence specific.

Thus for any given sequence in the gene regulatory region a triplex forming sequence may be devised. Triplex-forming oligonucleotides preferably are at least 15, more preferably 25, still more preferably 30 or more nucleotides in length, up to 50 or 100 bp.

Transfection of cells (for example, via cationic liposomes) with TFOs, and formation of the triple helical structure with the target DNA induces steric and functional changes, blocking transcription initiation and elongation, allowing the introduction of desired sequence changes in the endogenous DNA and resulting in the specific downregulation of gene expression. Examples of such suppression of gene expression in cells treated with TFOs include knockout of episomal supFG1 and endogenous HPRT genes in mammalian cells (Vasquez et al., Nucl Acids Res. 1999; 27:1176-81, and Puri, et al, J Biol Chem, 2001; 276:28991-98), and the sequence- and target specific downregulation of expression of the Ets2 transcription factor, important in prostate cancer etiology (Carbone, et al, Nucl Acid Res. 2003; 31:833-43), and the pro-inflammatory ICAM-1 gene (Besch et al, J Biol Chem, 2002; 277:32473-79). In addition, Vuyisich and Beal have recently shown that sequence specific TFOs can bind to dsRNA, inhibiting activity of dsRNA-dependent enzymes such as RNA-dependent kinases (Vuyisich and Beal, Nuc. Acids Res 2000; 28:2369-74).

Additionally, TFOs designed according to the abovementioned principles can induce directed mutagenesis capable of effecting DNA repair, thus providing both downregulation and upregulation of expression of endogenous genes (Seidman and Glazer, J Clin Invest 2003; 112:487-94). Detailed description of the design, synthesis and administration of effective TFOs can be found in U.S. Patent Application Nos. 2003 017068 and 2003 0096980 to Froehler et al, and 2002 0128218 and 2002 0123476 to Emanuele et al, and U.S. Pat. No. 5,721,138 to Lawn.

According to yet an additional aspect of the present invention there is provided an autonomous molecular computer capable of in vivo treatment.

As used herein the phrase “in vivo treatment” refers to inhibiting or arresting the development of a disease, disorder or condition and/or causing the reduction, remission, or regression of a disease, disorder or condition in an individual. Those of skill in the art will understand that various methodologies and assays can be used to assess the development of a disease, disorder or condition, and similarly, various methodologies and assays may be used to assess the reduction, remission or regression of a disease, disorder or condition.

As used herein, the term “individual” includes mammals, preferably human beings at any age which suffer from the disease, disorder or condition. Preferably, this term encompasses individuals who are at risk to develop the disease, disorder or condition.

According to preferred embodiments of the present invention the treatment occurs within a cell or at a cell surface or the individual or in cells derived from an individual (e.g., stem cells) and are further implanted or transplanted in an individual in need thereof (i.e., in vivo or ex vivo therapy).

According to preferred embodiments of the present invention the computer of the present invention includes a plurality of polymeric molecules, optionally including one or more heteropolymers or homopolymers.

The term “peptide” as used herein encompasses native peptides (either degradation products, synthetically synthesized peptides or recombinant peptides) and peptidomimetics (typically, synthetically synthesized peptides), as well as peptoids and semipeptoids which are peptide analogs, which may have, for example, modifications rendering the peptides more stable while in a body or more capable of penetrating into cells. Such modifications include, but are not limited to N terminus modification, C terminus modification, peptide bond modification, including, but not limited to, CH2-NH, CH2-S, CH2-S═O, O═C—NH, CH2-O, CH2-CH2, S═C—NH, CH═CH or CF═CH, backbone modifications, and residue modification. Methods for preparing peptidomimetic compounds are well known in the art and are specified, for example, in Quantitative Drug Design, C. A. Ramsden Gd., Chapter 17.2, F. Choplin Pergamon Press (1992), which is incorporated by reference as if fully set forth herein. Further details in this respect are provided hereinunder.

Peptide bonds (—CO—NH—) within the peptide may be substituted, for example, by N-methylated bonds (—N(CH3)-CO—), ester bonds (—C(R)H—C—O—O—C(R)—N—), ketomethylen bonds (—CO—CH2-), α-aza bonds (—NH—N(R)—CO—), wherein R is any alkyl, e.g., methyl, carba bonds (—CH2-NH—), hydroxyethylene bonds (—CH(OH)—CH2-), thioamide bonds (—CS—NH—), olefinic double bonds (—CH═CH—), retro amide bonds (—NH—CO—), peptide derivatives (—N(R)—CH2-CO—), wherein R is the “normal” side chain, naturally presented on the carbon atom.

These modifications can occur at any of the bonds along the peptide chain and even at several (2-3) at the same time.

Natural aromatic amino acids, Trp, Tyr and Phe, may be substituted for synthetic non-natural acid such as TIC, naphthylelanine (Nol), ring-methylated derivatives of Phe, halogenated derivatives of Phe or o-methyl-Tyr.

In addition to the above, the peptides of the present invention may also include one or more modified amino acids or one or more non-amino acid monomers (e.g. fatty acids, complex carbohydrates etc).

The term “amino acid” or “amino acids” is understood to include the 20 naturally occurring amino acids; those amino acids often modified post-translationally in vivo, including, for example, hydroxyproline, phosphoserine and phosphothreonine; and other unusual amino acids including, but not limited to, 2-aminoadipic acid, hydroxylysine, isodesmosine, nor-valine, nor-leucine and ornithine. Furthermore, the term “amino acid” includes both D- and L-amino acids.

Tables 1 and 2 below list naturally occurring amino acids (Table 1) and non-conventional or modified amino acids (Table 2) which can be used with the present invention.

TABLE 1

| Amino Acid | Three-Letter Abbreviation | One-letter Symbol |
|---|---|---|
| Alanine | Ala | A |
| Arginine | Arg | R |
| Asparagine | Asn | N |
| Aspartic acid | Asp | D |
| Cysteine | Cys | C |
| Glutamine | Gln | Q |
| Glutamic Acid | Glu | E |
| Glycine | Gly | G |
| Histidine | His | H |
| isoleucine | Ile | I |
| Leucine | Leu | L |
| Lysine | Lys | K |
| Methionine | Met | M |
| phenylalanine | Phe | F |
| Proline | Pro | P |
| Serine | Ser | S |
| Threonine | Thr | T |
| tryptophan | Trp | W |
| tyrosine | Tyr | Y |
| Valine | Val | V |
| Any amino acid as | Xaa | X |
| above | | |

TABLE 2

| Non-conventional amino acid | Code |
|---|---|
| α-aminobutyric acid | Abu |
| α-amino-α-methylbutyrate | Mgabu |
| aminocyclopropane- | Cpro |
| Carboxylate | |
| aminoisobutyric acid | Aib |
| aminonorbornyl- | Norb |
| Carboxylate | |
| Cyclohexylalanine | Chexa |
| Cyclopentylalanine | Cpen |
| D-alanine | Dal |
| D-arginine | Darg |
| D-aspartic acid | Dasp |
| D-cysteine | Dcys |
| D-glutamine | Dgln |
| D-glutamic acid | Dglu |
| D-histidine | Dhis |
| D-isoleucine | Dile |
| D-leucine | Dleu |
| D-lysine | Dlys |
| D-methionine | Dmet |
| D-ornithine | Dorn |
| D-phenylalanine | Dphe |
| D-proline | Dpro |
| D-serine | Dser |
| D-threonine | Dthr |
| D-tryptophan | Dtrp |
| D-tyrosine | Dtyr |
| D-valine | Dval |
| D-α-methylalanine | Dmala |
| D-α-methylarginine | Dmarg |
| D-α-methylasparagine | Dmasn |
| D-α-methylaspartate | Dmasp |
| D-α-methylcysteine | Dmcys |
| D-α-methylglutamine | Dmgln |
| D-α-methylhistidine | Dmhis |
| D-α-methylisoleucine | Dmile |
| D-α-methylleucine | Dmleu |
| D-α-methyllysine | Dmlys |
| D-α-methylmethionine | Dmmet |
| D-α-methylornithine | Dmorn |
| D-α-methylphenylalanine | Dmphe |
| D-α-methylproline | Dmpro |
| D-α-methylserine | Dmser |
| D-α-methylthreonine | Dmthr |
| D-α-methyltryptophan | Dmtrp |
| D-α-methyltyrosine | Dmty |
| D-α-methylvaline | Dmval |
| D-α-methylalnine | Dnmala |
| D-α-methylarginine | Dnmarg |
| D-α-methylasparagine | Dnmasn |
| D-α-methylasparatate | Dnmasp |
| D-α-methylcysteine | Dnmcys |
| D-N-methylleucine | Dnmleu |
| D-N-methyllysine | Dnmlys |
| N-methylcyclohexylalanine | Nmchexa |
| D-N-methylornithine | Dnmorn |
| N-methylglycine | Nala |
| N-methylaminoisobutyrate | Nmaib |
| N-(1-methylpropyl)glycine | Nile |
| N-(2-methylpropyl)glycine | Nile |
| N-(2-methylpropyl)glycine | Nleu |
| D-N-methyltryptophan | Dnmtrp |
| D-N-methyltyrosine | Dnmtyr |
| D-N-methylvaline | Dnmval |
| γ-aminobutyric acid | Gabu |
| L-t-butylglycine | Tbug |
| L-ethylglycine | Etg |
| L-homophenylalanine | Hphe |
| L-α-methylarginine | Marg |
| L-α-methylaspartate | Masp |
| L-α-methylcysteine | Mcys |
| L-α-methylglutamine | Mgln |
| L-α-methylhistidine | Mhis |
| L-α-methylisoleucine | Mile |
| D-N-methylglutamine | Dnmgln |
| D-N-methylglutamate | Dnmglu |
| D-N-methylhistidine | Dnmhis |
| D-N-methylisoleucine | Dnmile |
| D-N-methylleucine | Dnmleu |
| D-N-methyllysine | Dnmlys |
| N-methylcyclohexylalanine | Nmchexa |
| D-N-methylornithine | Dnmorn |
| N-methylglycine | Nala |
| N-methylaminoisobutyrate | Nmaib |
| N-(1-methylpropyl)glycine | Nile |
| N-(2-methylpropyl)glycine | Nleu |
| D-N-methyltryptophan | Dnmtrp |
| D-N-methyltyrosine | Dnmtyr |
| D-N-methylvaline | Dnmval |
| γ-aminobutyric acid | Gabu |
| L-t-butylglycine | Tbug |
| L-ethylglycine | Etg |
| L-homophenylalanine | Hphe |
| L-α-methylarginine | Marg |
| L-α-methylaspartate | Masp |
| L-α-methylcysteine | Mcys |
| L-α-methylglutamine | Mgln |
| L-α-methylhistidine | Mhis |
| L-α-methylisoleucine | Mile |
| L-α-methylleucine | Mleu |
| L-α-methylmethionine | Mmet |
| L-α-methylnorvaline | Mnva |
| L-α-methylphenylalanine | Mphe |
| L-α-methylserine | mser |
| L-α-methylvaline | Mtrp |
| L-α-methylleucine | Mval Nnbhm |
| N-(N-(2,2-diphenylethyl) | Nnbhm |
| carbamylmethyl-glycine | |
| 1-carboxy-1-(2,2-diphenyl | Nmbc |
| ethylamino)cyclopropane | |
| L-N-methylalanine | Nmala |
| L-N-methylarginine | Nmarg |
| L-N-methylasparagine | Nmasn |
| L-N-methylaspartic acid | Nmasp |
| L-N-methylcysteine | Nmcys |
| L-N-methylglutamine | Nmgln |
| L-N-methylglutamic acid | Nmglu |
| L-N-methylhistidine | Nmhis |
| L-N-methylisolleucine | Nmile |
| L-N-methylleucine | Nmleu |
| L-N-methyllysine | Nmlys |
| L-N-methylmethionine | Nmmet |
| L-N-methylnorleucine | Nmnle |
| L-N-methylnorvaline | Nmnva |
| L-N-methylornithine | Nmorn |
| L-N-methylphenylalanine | Nmphe |
| L-N-methylproline | Nmpro |
| L-N-methylserine | Nmser |
| L-N-methylthreonine | Nmthr |
| L-N-methyltryptophan | Nmtrp |
| L-N-methyltyrosine | Nmtyr |
| L-N-methylvaline | Nmval |
| L-N-methylethylglycine | Nmetg |
| L-N-methyl-t-butylglycine | Nmtbug |
| L-norleucine | Nle |
| L-norvaline | Nva |
| α-methyl-aminoisobutyrate | Maib |
| α-methyl-γ-aminobutyrate | Mgabu |
| α-methylcyclohexylalanine | Mchexa |
| α-methylcyclopentylalanine | Mcpen |
| α-methyl-α-napthylalanine | Manap |
| α-methylpenicillamine | Mpen |
| N-(4-aminobutyl)glycine | Nglu |
| N-(2-aminoethyl)glycine | Naeg |
| N-(3-aminopropyl)glycine | Norn |
| N-amino-α-methylbutyrate | Nmaabu |
| α-napthylalanine | Anap |
| N-benzylglycine | Nphe |
| N-(2-carbamylethyl)glycine | Ngln |
| N-(carbamylmethyl)glycine | Nasn |
| N-(2-carboxyethyl)glycine | Nglu |
| N-(carboxymethyl)glycine | Nasp |
| N-cyclobutylglycine | Ncbut |
| N-cycloheptylglycine | Nchep |
| N-cyclohexylglycine | Nchex |
| N-cyclodecylglycine | Ncdec |
| N-cyclododeclglycine | Ncdod |
| N-cyclooctylglycine | Ncoct |
| N-cyclopropylglycine | Ncpro |
| N-cycloundecylglycine | Ncund |
| N-(2,2-diphenylethyl)glycine | Nbhm |
| N-(3,3-diphenylpropyl)glycine | Nbhe |
| N-(3-indolylyethyl) glycine | Nhtrp |
| N-methyl-γ-aminobutyrate | Nmgabu |
| D-N-methylmethionine | Dnmmet |
| N-methylcyclopentylalanine | Nmcpen |
| D-N-methylphenylalanine | Dnmphe |
| D-N-methylproline | Dnmpro |
| D-N-methylserine | Dnmser |
| D-N-methylserine | Dnmser |
| D-N-methylthreonine | Dnmthr |
| N-(1-methylethyl)glycine | Nva |
| N-methyla-napthylalanine | Nmanap |
| N-methylpenicillamine | Nmpen |
| N-(p-hydroxyphenyl)glycine | Nhtyr |
| N-(thiomethyl)glycine | Ncys |
| penicillamine | Pen |
| L-α-methylalanine | Mala |
| L-α-methylasparagine | Masn |
| L-α-methyl-t-butylglycine | Mtbug |
| L-methylethylglycine | Metg |
| L-α-methylglutamate | Mglu |
| L-α-methylhomo phenylalanine | Mhphe |
| N-(2-methylthioethyl)glycine | Nmet |
| N-(3-guanidinopropyl)glycine | Narg |
| N-(1-hydroxyethyl)glycine | Nthr |
| N-(hydroxyethyl)glycine | Nser |
| N-(imidazolylethyl)glycine | Nhis |
| N-(3-indolylyethyl)glycine | Nhtrp |
| N-methyl-γ-aminobutyrate | Nmgabu |
| D-N-methylmethionine | Dnmmet |
| N-methylcyclopentylalanine | Nmcpen |
| D-N-methylphenylalanine | Dnmphe |
| D-N-methylproline | Dnmpro |
| D-N-methylserine | Dnmser |
| D-N-methylthreonine | Dnmthr |
| N-(1-methylethyl)glycine | Nval |
| N-methyla-napthylalanine | Nmanap |
| N-methylpenicillamine | Nmpen |
| N-(p-hydroxyphenyl)glycine | Nhtyr |
| N-(thiomethyl)glycine | Ncys |
| penicillamine | Pen |
| L-α-methylalanine | Mala |
| L-α-methylasparagine | Masn |
| L-α-methyl-t-butylglycine | Mtbug |
| L-methylethylglycine | Metg |
| L-α-methylglutamate | Mglu |
| L-α-methylhomophenylalanine | Mhphe |
| N-(2-methylthioethyl)glycine | Nmet |
| L-α-methyllysine | Mlys |
| L-α-methylnorleucine | Mnle |
| L-α-methylornithine | Morn |
| L-α-methylproline | Mpro |
| L-α-methylthreonine | Mthr |
| L-α-methyltyrosine | Mtyr |
| L-N-methylhomophenylalanine | Nmhphe |
| N-(N-(3,3-diphenylpropyl) | Nnbhe |
| carbamylmethyl(1)glycine | |

The peptides of the present invention are preferably utilized in a linear form, although it will be appreciated that in cases where cyclicization does not severely interfere with peptide characteristics, cyclic forms of the peptide can also be utilized.

The peptides of the present invention may be synthesized by any techniques that are known to those skilled in the art of peptide synthesis. For solid phase peptide synthesis, a summary of the many techniques may be found in J. M. Stewart and J. D. Young, Solid Phase Peptide Synthesis, W. H. Freeman Co. (San Francisco), 1963 and J. Meienhofer, Hormonal Proteins and Peptides, vol. 2, p. 46, Academic Press (New York), 1973. For classical solution synthesis see G. Schroder and K. Lupke, The Peptides, vol. 1, Academic Press (New York), 1965.

In general, these methods comprise the sequential addition of one or more amino acids or suitably protected amino acids to a growing peptide chain. Normally, either the amino or carboxyl group of the first amino acid is protected by a suitable protecting group. The protected or derivatized amino acid can then either be attached to an inert solid support or utilized in solution by adding the next amino acid in the sequence having the complimentary (amino or carboxyl) group suitably protected, under conditions suitable for forming the amide linkage. The protecting group is then removed from this newly added amino acid residue and the next amino acid (suitably protected) is then added, and so forth. After all the desired amino acids have been linked in the proper sequence, any remaining protecting groups (and any solid support) are removed sequentially or concurrently, to afford the final peptide compound. By simple modification of this general procedure, it is possible to add more than one amino acid at a time to a growing chain, for example, by coupling (under conditions which do not racemize chiral centers) a protected tripeptide with a properly protected dipeptide to form, after deprotection, a pentapeptide and so forth. Further description of peptide synthesis is disclosed in U.S. Pat. No. 6,472,505.

A preferred method of preparing the peptide compounds of the present invention involves solid phase peptide synthesis.

Large scale peptide synthesis is described by Andersson Biopolymers 2000; 55(3):227-50.

As used herein the term “about” refers to ±10%.

Additional objects, advantages, and novel features of the present invention will become apparent to one ordinarily skilled in the art upon examination of the following examples, which are not intended to be limiting. Additionally, each of the various embodiments and aspects of the present invention as delineated hereinabove and as claimed in the claims section below finds experimental support in the following examples.

### EXAMPLES

Reference is now made to the following examples, which together with the above descriptions, illustrate the invention in a non limiting fashion.

Generally, the nomenclature used herein and the laboratory procedures utilized in the present invention include molecular, biochemical, microbiological and recombinant DNA techniques. Such techniques are thoroughly explained in the literature. See, for example, “Molecular Cloning: A laboratory Manual” Sambrook et al., (1989); “Current Protocols in Molecular Biology” Volumes I-III Ausubel, R. M., Ed. (1994); Ausubel et al., “Current Protocols in Molecular Biology”, John Wiley and Sons, Baltimore, Md. (1989); Perbal, “A Practical Guide to Molecular Cloning”, John Wiley & Sons, New York (1988); Watson et al., “Recombinant DNA”, Scientific American Books, New York; Birren et al. (Eds.) “Genome Analysis: A Laboratory Manual Series”, Vols. 1-4, Cold Spring Harbor Laboratory Press, New York (1998); methodologies as set forth in U.S. Pat. Nos. 4,666,828; 4,683,202; 4,801,531; 5,192,659 and 5,272,057; “Cell Biology: A Laboratory Handbook”, Volumes I-III Cellis, J. E., Ed. (1994); “Culture of Animal Cells—A Manual of Basic Technique” by Freshney, Wiley-Liss, N.Y. (1994), Third Edition; “Current Protocols in Immunology” Volumes I-III Coligan J. E., Ed. (1994); Stites et al. (Eds.), “Basic and Clinical Immunology” (8th Edition), Appleton & Lange, Norwalk, Conn. (1994); Mishell and Shiigi (Eds.), “Selected Methods in Cellular Immunology”, W. H. Freeman and Co., New York (1980); available immunoassays are extensively described in the patent and scientific literature, see, for example, U.S. Pat. Nos. 3,791,932; 3,839,153; 3,850,752; 3,850,578; 3,853,987; 3,867,517; 3,879,262; 3,901,654; 3,935,074; 3,984,533; 3,996,345; 4,034,074; 4,098,876; 4,879,219; 5,011,771 and 5,281,521; “Oligonucleotide Synthesis” Gait, M. J., Ed. (1984); “Nucleic Acid Hybridization” Hames, B. D., and Higgins S. J., Eds. (1985); “Transcription and Translation” Hames, B. D., and Higgins S. J., Eds. (1984); “Animal Cell Culture” Freshney, R. I., Ed. (1986); “Immobilized Cells and Enzymes” IRL Press, (1986); “A Practical Guide to Molecular Cloning” Perbal, B., (1984) and “Methods in Enzymology” Vol. 1-317, Academic Press; “PCR Protocols: A Guide To Methods And Applications”, Academic Press, San Diego, Calif. (1990); Marshak et al., “Strategies for Protein Purification and Characterization—A Laboratory Course Manual” CSHL Press (1996); all of which are incorporated by reference as if fully set forth herein. Other general references are provided throughout this document. The procedures therein are believed to be well known in the art and are provided for the convenience of the reader. All the information contained therein is incorporated herein by reference.

### Example 1

### Design of Molecular and Automata Components of the Molecular Computer

Molecular Design and Operation

The molecular computer of the present invention optionally and preferably features three types of molecules: (i) diagnostic molecules (FIG. 2a) that encode diagnosis and therapy rules, (ii) transition molecules that realize transition rules and are regulated by molecular disease markers (FIGS. 2b, 2c and 2d) and (iii) hardware molecules, the restriction enzyme FokI that drives the computation forward (FIG. 2e).

A diagnostic molecule (FIG. 2a) has a diagnosis moiety and a drug-administration moiety. The drug-release moiety releases a drug molecule upon positive diagnosis and the drug-suppressor-release moiety releases a drug suppressor molecule upon negative diagnosis. This design allows fine control over the amount of drug administered as a function of the confidence in the diagnosis, simply by varying the initial relative concentrations of the drug and drug-suppressor moieties in the diagnostic molecules, as explained below.

The diagnostic moiety realizes each symbol in the diagnostic string by a unique dsDNA fragment 7-bp long. Following a previously described standard design^{22,24} (FIG. 1a) a sticky end composed of the first four nucleotides of a symbol represents the state Yes combined with that symbol, while a sticky end spanning nucleotides three to six represents the symbol combined with state No.

Design of the Automata Components

A computer program was developed to design the symbols of the diagnostic string molecules that generates a random sequence of 6 nucleotides for each disease symptom name and improves this random set using an evolutionary algorithm. The sequences were constrained to contain 75% CG content in each four nucleotides sticky end. All sticky ends derived from the symbols were checked for complete or partial complementarity. The algorithm renders sequences with minimal partial complementarity between non-related sticky ends. Several runs were performed and a set of symbols with best non-overlapping properties was chosen for diagnostic molecules construction. In the actual diagnostic molecules the 6-bp symbols were separated by 1-bp spacers to obtain symbols of 7-bp total length.

A computer program was developed to select mRNA activating and deactivating tags, which were then realized using ssDNA molecules in the experiments. It accepts a set of mRNA sequences of the disease markers for a particular disease and provides the two most unique short subsequences for each of these markers which also contained a partial FokI recognition site (preferentially, first three nucleotides: 3′-CCT) to facilitate the strand exchange.

The Hamming distance⁴⁸, which is a number of nucleotides that need to be changed to obtain one sequence from another, was used as the uniqueness criterion and assume that specific interaction of each transition molecule with its regulatory tag depends only on the uniqueness of its regulatory sticky end. The lengths of the tags were adjusted to have a melting temperature of ˜25° C., using a simplified assumption to determine Tm of a sequence. In a disease model, ssDNA regulatory tags are separated by a linker ˜40 nt long, designed to have minimum interaction with other ssDNA sequences in the system. Each tag sequence was used as a template for the design of the transition molecules. The complete set of oligonucleotides comprising the automaton and the model disease markers was tested for cross-interactions using the OMP (Oligonucleotide Modeling Platform, DNA Software™) software tool possible flaws in the design.

The experiments that verify the diagnostic component of the computer, as described with regard to Example 2 which follows and FIGS. 4-6, use molecules consisting of a diagnostic moiety followed by an inactive double-stranded DNA segment, the size of which at the end of the computation serving as the diagnostic output.

The drug-administration moieties consist of a ssDNA that loops on itself to form a sequence of three diagnostic verification symbols followed by a drug loop or a drug-suppressor loop. If the diagnostic computation ends in state Yes, Yes-verification transitions cleave the Yes-verification symbols of the drug-release moiety and the remaining loop unfolds to become an active drug molecule. If the computation ends in state No, No-verification transitions cleave the No-verification symbols of the drug-suppressor moiety, and the remaining loop unfolds to become an active drug-suppressor that deactivates the drug by hybridizing to it. Conversely, if the diagnostic computation ends in state No it stops without cleaving the Yes-verification symbols so that the drug-release moiety loop is left intact and the drug inactive. Similarly, if the diagnostic computation ends in state Yes, the drug-suppressor moiety is left intact and the drug suppressor inactive.

When diagnostic molecules with equal amounts of the two kinds of drug-administration moieties are used, the ratio of the released drug and drug suppressor corresponds to the ratio between the probabilities of the computation ending in positive or negative diagnosis. Active drug suppressor hybridizes to the drug and inactivates it; excess drug remains active and performs the therapeutic function. The higher the certainty of positive diagnosis, the higher is the amount of available active drug at the end of the computation. Since the actual ratio of drug and drug-suppressor diagnostic molecules is an available degree of freedom of the medical computer, it can be biased towards drug release or drug suppression, as needed by medical or other considerations. For example, assume that, due to errors or other limitations of the biochemistry of the automaton, the probability of a Yes diagnosis for a particular disease, when all disease symptoms are present, is only 50%. If the drug and drug-suppressor diagnostic molecules are combined at a ration of 2 to 1, 25% of the computations with drug-release diagnostic molecules will produce an active drug. An opposite bias can be introduced to suppress false-positive diagnosis below a certain threshold (FIG. 3, step d).

Although the ssDNA drug molecule was shown to provide effective antisense therapy for prostate cancer⁴⁴, it does not necessarily need to viable, as it was intended to show the operation of the present invention. With the design of the present study any ssDNA with a known therapeutic effect can be released, including a ssDNA molecule that would cause the synthesis of a particular RNA or a particular protein molecule. The present invention also optionally includes the release of any small molecule.

FIGS. 2a-e are described in more detail with regard to molecular components of the computer as follows: FIG. 2a, Diagnostic molecules for prostate cancer. The diagnosis moiety (gray) implements the diagnosis component of a diagnosis and therapy rule. Attached to the diagnosis moiety there are two kinds of drug-administration moieties: a drug-release moiety (purple) and a drug-suppressor-release moiety (brown). The drug-administration moieties consist of a ssDNA that loops on itself to form two components, a sequence of three diagnostic verification symbols (light purple/light brown) followed by a drug loop (purple) or a drug-suppressor loop (brown). Example encodings for selected symbols along with state-symbol sticky ends are shown in zoom-in frames, for example shown with regard to FIG. 2a.

FIGS. 2b and c show a pair of competing transition molecules regulated by PIM1 mRNA. Each molecule contains a regulation (red, green) and a computation (blue, gray) fragments. The computation fragment consists of the double-stranded recognition site of the hardware enzyme FokI (blue), a single-stranded sticky end (gray) that recognizes a particular state-symbol combination of the diagnostic molecule, and possibly a 2-bp spacer (gray) between the two. A spacer of 2 bp effects a Yes→Yes transition while a zero-length spacer effects a Yes→No transition. Activation or inactivation of the transition molecules by the tags of the PIM1 mRNA marker (light green, light red) is accomplished via their binding to the single-stranded overhang of the regulation fragment of the transition molecule followed by strand exchange.

FIG. 2d shows a pair of transition molecules regulated by mRNA point mutation. The Yes→Yes transition has a fragment complementary to the wild-type mRNA while the corresponding fragment of the Yes→No transition is complementary to the mutated mRNA. Yes→Yes is preferentially inactivated by the wild-type mRNA whereas Yes→No is inactivated by the mutated mRNA.

A Transition molecule (FIGS. 2b-d, FIG. 3, step b) is composed of a regulation fragment and a computation fragment. The regulation fragment of a transition molecule enables its regulation by nucleic-acid-based disease marker, which may activate (green) or deactivate (red) the transition when in high concentration. For example, the transition molecule 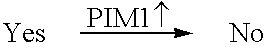
(FIG. 2c) is deactivated by the mRNA of PIM1, a gene over expressed in prostate cancer. Part of the sense DNA strand (red) is complementary to a subsequence of PIM1 mRNA (“deactivation tag” in light red). The mRNA-deactivation-tag/transition-sense-strand hybrid is more stable than the normal transition molecule hybrid, driving forward a strand exchange between the transition molecule and the PIM1 mRNA and thus deactivating the transition molecule. The logical switch between active and inactive states is similar to state-switching of a DNA nanoactuator affected by DNA fuel molecule⁴⁷.

The transition molecule 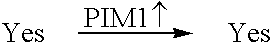
(FIG. 2b) is activated by high concentration of PIM1 mRNA. In its absence, hybridization between the sense and antisense strands of the transition molecule is prevented by a third “protecting” oligonucleotide (green) that partially hybridizes to the antisense strand and forms a complex that is considerably more stable than the active transition molecule. The protecting strand is also complementary to another subsequence of PIM1 mRNA (“activation tag”, light green). The green region of the antisense strand of the transition molecule is complementary to the protecting strand, while its blue region is designed to be only partially complementary to avoid formation of a functional FokI site in this complex. A sticky end at the 5′-terminus of the protecting strand hybridizes to the activation tag of PIM1 mRNA, followed by strand exchange that decouples the protecting strand from the antisense strand of the transition molecule, which then hybridizes with the sense strand to form an active 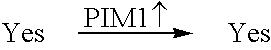
transition. In the overall, in an idealized regulation process one PIM1 mRNA molecule inactivates one 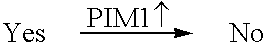
and activates one 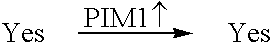
transition molecule.

A similar mechanism allows for transition regulation by a point mutation symptom (where the wild type sequence serves as an inactivation tag for a Yes transition and the mutated sequence serves as an inactivation tag for a No transition). This mechanism is shown in FIG. 2d and analyzed in FIG. 4c.

Turning now to FIG. 3 for a further detailed description of another preferred embodiment of the present invention, there is shown an exemplary molecular computer realizing this logical design which features diagnostic molecules that encode diagnostic rules (FIG. 2a); transition molecules that realize automaton transitions and are regulated by molecular indicators (FIG. 2b, c); and hardware molecules, the restriction enzyme FokI (FIG. 2e).

This exemplary embodiment of the computer preferably features three molecular modules, input (FIG. 3, step b), computation (FIG. 3, step a) and output (FIG. 3, step d), that interact with the disease-related molecules and with each other via a complex network (FIG. 3). Each molecular computer autonomously performs one diagnosis and drug administration task; multiple tasks can be performed by multiple computers that operate in parallel within the same environment without mutual interference, while sharing the hardware molecules and potentially sharing some or all of the software molecules. All pairs of transition molecules are regulated simultaneously by their respective indicators (FIG. 3, step b) and perform a stochastic computation over diagnostic molecules to administer drug upon diagnosis (FIG. 3, step b).

FIG. 3 step a shows part of the computation path for the diagnostic molecule for PC with all molecular indicators present, ending in drug release. The initial diagnostic molecule consists of a diagnosis moiety (gray) that encodes the left-hand side of the diagnostic rule and a drug-administration moiety (light purple) incorporating an inactive drug loop (dark purple). At each computation step, the prevailing transition is shown, except for the processing of the symbol PIM1↑, for which details of the stochastic choice, accomplished by a regulated pair of competing transition molecules, are shown (dashed box, see FIG. 3 step c).

FIG. 3, step b shows regulation of the two transitions for PIM1↑ by subsequences (“tags”) of over-expressed PIM1 mRNA, resulting in relatively high level of the 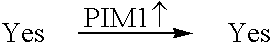
transition molecules and a low level of the 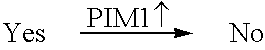
molecules. Each transition molecule contains regulation (green, red) and computation (blue, gray) fragments. The “inactivation tag” of PIM1 mRNA (light red) displaces the 5′→3′ strand of the transition molecule 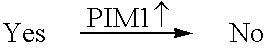
and destroys its computation fragment. The “activation tag” of PIM1 mRNA (light green) activates the transition molecule 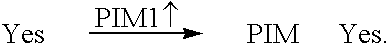
Initially, a “protecting” oligonucleotide (green) partially hybridizes to the 3′→5′ strand of the transition molecule and blocks the correct annealing of its 5′→3′ strand. The “activation tag” displaces the protecting strand, allowing such annealing and rendering an active 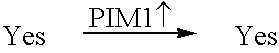
transition. Ideally, one PIM1 mRNA molecule inactivates one 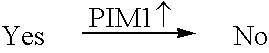
and activates one 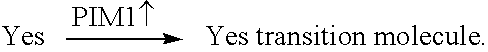
Yes transition molecule.

FIG. 3, step c shows stochastic processing of the symbol PIM1↑ by a regulated pair of competing transition molecules. The probability of a Yes→Yes transition is high, resulting in a high level of diagnostic molecules in the state Yes and a low level in state No.

FIG. 3, step d shows that combining computation results for both types of diagnostic molecules, both with high Yes and low No final states results in high release of drug and low release of drug suppressor, and hence in the administration of the drug.

For each symbolic indicator, a pair of competing transition molecules (FIG. 3, step b) performs the corresponding molecular indicator verification. Presence of a molecular indicator entails high concentration of the positive transition molecule and low concentration of its competing negative transition molecule and vice versa. This regulation is accomplished via sequence-specific interaction between the indicator and a partially single-stranded fragment of a transition molecule, as follows. A positive transition checking for over-expression is activated by a high concentration of its corresponding mRNA. A positive transition checking for under-expression is inactivated by a high concentration of its corresponding mRNA. The corresponding negative transitions are oppositely regulated by a similar mechanism (FIG. 2c). A similar mechanism allows for transition regulation by point mutation (FIG. 2d). The logical switch between configurations of the transition molecules is similar to the state that switching a DNA fuel molecule causes in a DNA nanoactuator. An alternative approach to sensing biochemical signals is known as “chemical logic gates”.

For any embodiment of the present invention, to provide a successful implementation, the computer must be robust both to imprecision of molecular components and to variations in external parameters. This is optionally and preferably achieved by three mechanisms. First, imprecision in transition regulation may be compensated by variation in the relative amounts of the active and inactive transition molecules and by addition of excess ssDNA oligonucleotides that form these transitions. Second, changes in the absolute level at which a molecular indicator should be positively detected are compensated for by a similar change in absolute concentration of the transition molecules. Third, false-positive or false-negative diagnoses may be compensated for as explained above.

### Example 2

### Disease Marker Detection and Diagnosis

The molecular computer of the present invention, as shown in FIGS. 2a-e, can check for the disease symptoms specified in these rules (FIGS. 3 and 4); apply these rules to reach a diagnostic and/or a therapeutic decision (FIGS. 3 and 5); and administer the drug molecules as specified by a therapy rule (FIG. 3). This Example describes disease marker detection and diagnosis, with exemplary treatment, by using a non-limiting, illustrative experimental design and analysis.

Construction of the Automata Components

All deoxyribonucleotides employed for automata construction were ordered from Sigma-Genosys or from the Weizmann Institute DNA synthesis unit, PAGE-purified to homogeneity and quantified by GeneQUANT instrument (Pharmacia). Non-labeled double-stranded components were prepared by annealing 1000 μmol of each single strand in 10 micro-liters of 50 mM NaCl, by heating to 94° C. and slow cooling down in a PCR machine block. Diagnostic strings employed for the experiments in FIGS. 5a and 5b were prepared by annealing of 1000 pmol of their single-stranded components, with 3 pmol of an antisense oligonucleotide phosphorylated by Redivue [γ-³²P] ATP (˜3000 mCi/mmol, 3.33 pmol/microliter, Amersham-Pharmacia). Diagnostic strings with drug-releasing and drug-suppressor-release moieties were prepared by block ligation, employing ³²P-labeled 5′ of one of the oligonucleotides to introduce internal label in the single-stranded loop. Fluorescently labeled diagnostic inputs employed for parallel diagnosis experiment (FIG. 5c) were prepared by annealing non-labelled sense strand of the input and either FAM- or Cy5 5′-labeled antisense strands.

Regulation by mRNA

For generic mRNA disease marker, the mRNA transcribed from a pTRI-Xef 1 ˜1900 bp DNA template provided with the MEGAScript T7 kit (Ambion) was used. mRNA sequence was folded using mFold server v 3.0 (URL: http://www.bioinfo.rpi.edu/applications/mfold/old/ma/) and visually examined to find sequences of low secondary structure. mRNA was synthesized using MEGAScript T7 kit and quantified by GeneQuant (Pharmacia). mRNA solution was refolded by heating to 70° C. and slow cooling down prior to regulation experiments. Transition molecules were designed to match these sequences and were screened to determine the most effective activating and inactivation tags of the mRNA sequence. These were identified at the locations around 600 nt and 1500 nt. Transition molecules were built from fluorescently labeled oligonucleotides to facilitate their identification. A mixture of 0.25 microM active Yes→No and 0.25 microM inactive Yes→Yes transition molecules and 0.25 microM of the sense oligonucleotide for Yes→Yes transition were incubated in 10 microliters of NEB4 (New England Biolabs) buffer at 37° C. for 20 minutes with varying amounts of mRNA and analyzed by native acrylamide gel (15%). For technical reasons, the fluorescently labeled transitions used in FIG. 4a were similar, but not identical, to the unlabeled transitions used in FIG. 5c.

Diagnostic Computations

Diagnostic computations optionally and preferably featured the following stages: 1) mixing of active and inactive transition molecules representing a normal state in each diagnosed symptom, and diagnostic string molecule(s); 2) equilibrating the software component with the mixture of ssDNA oligonucleotides representing the molecular disease markers; 3) processing of the diagnostic string by the hardware enzyme. For each symbol of diagnostic string, the transitions were combined in the following manner: if its marker is under-expressed in a disease, 1 microM of active Yes→Yes molecule was mixed with 1 microM of inactive Yes→No molecule. For a marker over-expressed in a disease, 1 microM of active Yes→No molecule was mixed with 1 microM of inactive Yes→Yes molecule. For some transition molecules, inactivated only by high marker concentrations, 1 microM of the protecting oligonucleotide was added to improve regulation (namely, for each pair of transitions in the SCLC diagnosis and for PPAP2B and GST5-related transitions in the PC diagnosis). All other components except FokI, including the diagnostic string molecules (1 microM), No→No transition molecules (1 microM each), Yes- and No-verification transition molecules (0.5 microM each) and NEB4×10 buffer were admixed at this stage.

A mixture of model ssDNA or mRNA molecular markers was prepared in parallel, with each marker at either zero (normal state for over expressed gene and disease state for under expressed gene) or 3 microM concentration (normal state for under expressed gene and disease state for over expressed gene). Both mixtures were thoroughly mixed to a total volume of 9 microliters and incubated at 15° C. for ssDNA markers or at 37° C. for mRNA markers for 20 minutes. Following equilibration, the computation was initiated by adding 1 microliter of FokI enzyme (New England BioLabs, R0109) solution, either at concentration equal to the total concentration of active transition molecules or at 5.4 microM concentration which is the highest possible with the enzyme stock used by the present invention. Typical reaction proceeded for 30 minutes at 15° C., but for shorter diagnostic strings (2 symbols) incubation times were shortened to 15 minutes. The reaction was quenched by addition of 1 volume of formamide loading buffer. Samples were analyzed by denaturing PAGE (15%) following denaturation at 94° C. for 5 minutes. In this assay, Yes and No outputs are represented by 17-nt and 15-nt long bands, respectively. In the parallel computation experiment (FIG. 5c), the diagnostic molecules were labeled with FAM and Cy5 at the 5′ of their antisense strands. The gels were scanned by Typhoon 9400 instrument (Amersham Pharmacia).

Probabilistic Framework for Diagnostic Process

The assumption was that all the evidences which belong to a diagnostic rule are independent.

Definition 1: A symptom S is a Boolean random variable that takes its values in the set {True, False}.

Definition 2: A symptom indicator Iₛ is a continuous random variable that represents a result of a measurement of a medical indicator that is relevant for determination of the symptom presence. Generally it takes its values in a range [0 . . . ∞).

Definition 3: A certainty value of a symptom S for an indicator Iₛ given its measured value c is a mapping F: [0, ∞)→[0, 1] such that F(S, c)=P(S|Iₛ=c).

Definition 4: A disease D is a Boolean random variable that takes its values in the set {True, False}.

Definition 5: A Diagnostic rule R_{D} is a conjunction of one or more symptoms related to a disease D. R_{D}=S₁ˆS₂ˆ. . . Sₖ.

Definition 6: The diagnostic rule, R, holds with probability p with respect to a set of indicators {Iₛᵢ} with values {cᵢ} if the probability of all conjuncts to jointly hold equals p:

$$p = P ( R = True ) = {\prod }_{1 \leq i \leq k} F ( {S}_{i} , {c}_{i} ) = {\prod }_{1 \leq i \leq k} P ( {S}_{i} = True \vert {I}_{{S}_{i}} = {c}_{i} )$$

Controlled Drug Production

Internally labeled drug- and drug-suppressor-releasing diagnostic strings were prepared as follows: Preparation of PPAP2B↓GSTP5↓PC: The oligonucleotides for the construction of the drug-release diagnostic molecule were RL.21 (SEQ ID NO:3; CCGAGGCGGTGCGCGACGCTCGAGCCTCGACGCTCGTTGGTATTG) and RL.22 (SEQ ID NO:4; ³²P-CACATCCAACGAGCGTCGAGCGTCGAGCGTCGCGCACCGCC). The ligation was afforded by the bridging oligonucleotides RL.25 (SEQ ID NO:5; CTCGACGCTCGTTGGATGTGCAATACCAACGAGCGTCGAGCGTCGAGCGTC GCGCACCGCCTCGG). Twenty pmol of RL.22 oligonucleotide (out of 1000 pmol) were ³²P-labelled with 5 μl of [γ-32P] ATP (˜3000 mCi/mmol, 3.33 μmol/μl, Amersham) in 50 μl reaction containing T4 Polynucleotide Kinase Buffer and 20 u of T4 Polynucleotide Kinase (New England Biolabs). After 1 hour at 37° C., 20 u of T4 Polynucleotide Kinase in T4 Ligase Buffer were added, the volume was increased to 165 μl and the reaction continued for additional hour at 37° C. Double stranded block was prepared by annealing of 1000 pmol of RL.21 and 1200 pmol of RL.25. For ligation, 1000 pmol of the labeled RL.22 oligonucleotide was mixed with the annealed block and ligated using 1,600 u of Taq Ligase (New England Biolabs) in 1 ml of Taq Ligase buffer at 55° C. for 18 hours.

The ligation products were ethanol-precipitated, resuspended in TE buffer, pH 8.0 and separated using 12% denaturing PAGE (40 cm×1.5 mm). The correct-length ligation product was excised from the gel and extracted using standard methods. The product was refolded prior to use. Drug suppressor-release molecule was constructed by the identical protocol using the oligonucleotides RL.23 (SEQ ID NO:6; CCGAGGCGGTGCGCGCGAGGCGCGAGGCGCGAGGCCCATGTGCAATAC), RL.24 (SEQ ID NO:7; ³²P-CAACGCACATGGGCCTCGCGCCTCGCGCCTCGCGCGCACCGCC) and the auxiliary oligonucleotide RL.27 (SEQ ID NO:8; CGCGAGGCCCATGTGCGTTGGTATTGCACATGGGCCTCGCGCCTCGCGCCTC GCGCGCACCGCCTCGG).

Preparation of PPAP2B↓GSTP1↓PIM1↑HEPSIN↑PC: The oligonucleotides for the construction of the inputs were: RL.5-50 (SEQ ID NO:9; CCGAGGCGGTGCGCGCAGGGCGGGTGGCGACGCTCGACGCTCGACGCTCG) and RL.3-51 (SEQ ID NO:10; ³²P-TTGGTATTGCACATCCAACGAGCGTCGAGCGTCGAGCGTCGCCACCCGCCCT GCGCGCACCGCC). They were ligated with the help of a bridging oligonucleotide RL.25n (SEQ ID NO:11; GGATGTGCAATACCAACGAGCGTCGAGCGTCGAGCGTCGCCACCCGCCCTG CGCGC). Twenty pmol of the RL.3-51 oligonucleotide were ³²P-labeled; 1000 pmol of the same substrate were phosphorylated with PNK in T4 DNA Ligase buffer with 1 mM ATP. For ligation, 1000 pmol of the RL.3-51 (mixture of ³²P-labeled and phosphorylated substrates), RL.5-50 and RL.25n (bridge) oligonucleotides were mixed and ligated by 2,000 u of Taq Ligase (New England Biolabs) in 1 ml of Taq Ligase buffer at 60° C. for 2 hours. The ligation products were ethanol-precipitated, resuspended in TE buffer, pH 8.0 and separated using 8% denaturing PAGE (40 cm×1.5 mm). The correct-length ligation product was excised from the gel and extracted using standard methods. It is worth mentioning that the ligation product migrates much faster than is expected from its length, probably due to its stem-loop structure. The product was refolded prior to use.

Equal amounts of diagnostic string molecules (0.5 microM each) were mixed with 1 microM of 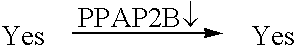
transition molecule and varying ratios of 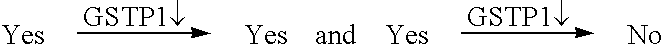
at 1 microM total concentration to model different diagnostic outcomes. Yes- and No-verifying transition molecules were added at 2 microM each and FokI enzyme at 4.3 microM in 10 ml final volume. The mixture was incubated at 15° C. for 30 minutes, quenched with EDTA, mixed with loading buffer and analyzed by native PAGE (20%).

Molecular Composition of Computer and Disease Symptoms

DNA sequences of the oligonucleotides used for construction of computer are shown in FIGS. 8-12. The coloring of the nucleotides reflects their function, as described hereinabove. X stands for AAGAGCTAGAGTC (SEQ ID NO:12) in the sense strand and for its complementary sequence GACTCTAGCTCTT (SEQ ID NO:13) in the antisense strand.

Diagnosis and drug release by the exemplary molecular computer of the present invention—FIG. 3 demonstrates the path ending in the release of a drug and the operation of the molecular components when all disease markers of a prostate cancer model are present, i.e., both drug-release and drug suppressor release diagnostic molecules, the transition molecules participating in this computation which are regulated using a disease-related marker and which affect the relative probability of corresponding Yes→Yes and Yes→No transitions, and the drug release which is regulated by the release of the drug suppressor. Verification of the diagnosis and the drug administration reaction pathways was independently performed and is shown in FIGS. 4-6, except for protein suppression by the ssDNA drug molecule, which was shown elsewhere⁴⁴.

Reference is now made to FIG. 3. Step a—Part of the computation path for prostate cancer in the presence of its disease markers. Computation starts with a diagnostic molecule containing an inactive drug and ends in drug release. At each computation step, the prevailing transition molecule and the product of its application is shown, except the processing of the PIM1↑ symbol. For PIM1↑ symbol, a stochastic choice accomplished by the regulated pair of competing transition molecules is demonstrated. Step b—Regulation of the two transitions for the symbol PIM1↑ by subsequences of over expressed PIM1 mRNA, resulting in relatively high levels of the 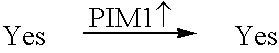
transition molecule and low levels of the 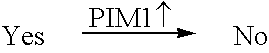
molecule. It should be noted that the same Pim1 RNA was used to lower the Yes→No (through the inactivation tag) and to increase the Yes→Yes (through the activation tag). Step c shows details of the stochastic processing of the PIM1↑ symbol by the pair of competing transition molecules regulated by over expressed PIM1 mRNA. Since PIM1 mRNA is over-expressed, indicating a disease state, the level of Yes→Yes is high and of Yes→No is low. Accordingly, the transition probability associated with Yes→Yes transition is high. The computational step results in a correspondingly high level of diagnostic molecules in the state Yes and a low level in state No. Step d shows that combining computation results for both types of diagnostic molecules, in which the final state in both has high Yes and low No, result in high release of drug and low release of drug suppressor, and hence in the administration of the drug.

Operation Analysis

The regulation of transition molecules by mRNA [FIGS. 2b-c, FIG. 3 (step b)] was confirmed experimentally (FIG. 4a) with a Xenopus elongation factor 1α pTRI-Xef) mRNA of about 1900 nt as a generic marker. Regions of mRNA that could serve as regulation tags were identified by screening candidate sites with low secondary structure. An example of the correlation between the level of mRNA and the probability of a pair of transitions, regulated to check for under expression, to result in the state Yes is shown in FIG. 4b. Regulation by point mutation (FIG. 2d) was experimentally confirmed with a ssDNA model simulating a point substitution mutation, which represents a SCLC-related mutation in the gene p5342 (FIG. 4c). It will be appreciated that such an approach can be extended to detect insertion and deletion mutations. In addition, the probabilistic checking of a disease marker to respond differently to various levels of the marker was calibrated by altering the absolute concentration of the competing transition molecules (FIG. 4d).

Reference is now made to FIGS. 4a-f which depict the regulation of a single diagnostic step by mRNA and ssDNA. FIG. 4a—Regulation of competing transitions by mRNA representing a generic disease symptom showing transition molecules in their active and inactive state. F stands for FAM, R stands for tetramethyl rhodamine and Y for Cy5 labels. FIG. 4b-Calibration curve showing regulation of probability of Yes output state in a single-step computation by a generic mRNA marker. FIG. 4c—Regulation by point mutation by mixtures of model ssDNA oligonucleotides representing different ratios of mRNA of wild-type and of mutated genes. FIGS. 4d-f—Controlling the certainty threshold of a molecular disease symptom by adjusting the absolute concentrations of the transition molecules. The gel (FIG. 4d) visualizes the increase in probability of Yes diagnostic output with increasing concentrations of INSM1 ssDNA model (over-expressed in the disease) for different concentrations of active and inactive transition molecules. The graph (FIG. 4e) displays the transition probabilities derived from the measured intensities of the Yes and No bands, highlighting the change in the No/Yes crossover point as a function of transition molecule concentration and the graph shown in FIG. 4f plots this function.

Regulation of the Competing Transition Molecules by mRNA

Transition molecules involved in the experiment described in FIG. 4b were similar to the fluorescently labeled molecules used in direct visualization of the regulation process presented in FIG. 4a. The only difference was converting the Yes→No transition to Yes→Yes transition and vice versa, by introduction and removal of spacers between the FokI sites and the state-symbol recognition sticky ends, respectively, (for sequences see FIG. 13). To improve the regulation pattern, Yes→No transition molecule was used at 0.5 microM while Yes→Yes transition molecule was used at 1 microM concentration.

Detection of a Point Mutation

The structures of the transition molecules and the model molecular symptoms used for detection of point mutation (FIG. 4c) are given in FIG. 14. In the experiment, each transition molecule was at 1 microM and total concentration of the model symptoms was set to 2 microM. The ratio between the sequences was gradually varied as shown in FIG. 4c. The mixture of the transition molecules and the model symptoms was equilibrated for 10 minutes at 15° C.; one-step computation was initiated by addition of 1 microM of FokI enzyme and proceeded at 15° C. for 30 minutes prior to quenching and analysis by denaturing PAGE.

Controlling the Certainty Threshold of a Molecular Disease Symptom

The experiment described in FIG. 4d was performed using the SCLC diagnostic molecule. The computation advanced by 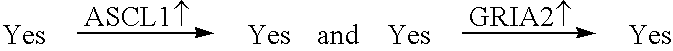
transitions, then branched on INSM1↑ symbol due to regulation by the INSM ssDNA model symptom and proceeded to completion via 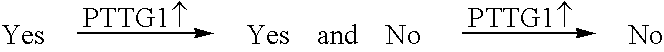
transitions, to reflect the Yes/No ratio obtained at the branching point. All transition molecules except the regulated pair and the diagnostic string were at 1 microM concentration, and FokI enzyme was at 5.4 microM concentration.

In multi-symptom diagnostic computations ssDNA oligonucleotides were employed to represent disease-related mRNA and used two constant concentration values to represent mRNA levels: zero for low level and 3 microM for high level. The results in FIG. 4d suggest that it can be easily adjusted to realistic disease marker levels by varying the absolute concentrations of transition molecules.

Reference is now made to FIGS. 5a-c. FIG. 5a—Validation of the diagnostic automata with the diagnosis rules for SCLC and PC described in FIG. 1b. Each lane shows the result of diagnostic computation for the indicated composition of diseases symptoms. FIG. 5b, Selectivity of the diagnostic automata for their disease models. Each pair of lanes is a particular combination of disease symptoms indicated in the figure and is diagnosed separately by the automata for SCLC (left lane) and PC (right lane). + indicates presence of disease symptoms, − indicates a normal condition, and * indicates absence of disease-related molecules. Expected outcome of the diagnosis is indicated above each lane. FIG. 5c, Parallel detection of two diseases by two diagnostic automata. The diagnosed environment contains a two-symptom model of SCLC, represented by the diagnostic string PTTG1↑CDKN2A↑SCLC and a two-symptom model of PC represented by the string PIM1↑HEPSIN↑PC. The presence of symptoms for each disease as well as the expected diagnostic output by each automaton are indicated above the lanes.

The diagnostic component of the computer was tested on molecular models of SCLC and PC with diagnostic automata (sets of diagnostic molecules with corresponding transition molecules) for the diagnosis rules shown in FIG. 1b. Each automaton diagnoses its respective disease with significant probability only when all four molecular disease symptoms are present (FIG. 5a). The false-negative diagnosis obtained when all symptoms are present is due to imperfections in the design of the transition molecules, but can be compensated for during drug administration as discussed above. The two diagnostic automata were tested in mixed conditions, in which none, one, or both sets of molecular disease symptoms are present (FIG. 5b), to confirm the selectivity of the diagnostic process. In all cases a positive diagnosis was made with significant probability by a diagnostic automaton only when all the symptoms for the disease it was programmed to diagnose were actually present.

To confirm the possibility of simultaneous, independent diagnosis of multiple diseases, the two diagnostic automata were tested running in parallel (FIG. 5c). Indeed, each automaton performed its diagnosis correctly, irrespective of the computation performed by the other automaton. In this experiment each automaton was provided with diagnostic molecules containing only two diagnostic symbols, and the two disease models were simplified accordingly to have only two molecular symptoms each.

Reference is now made to FIGS. 6a-f. FIG. 6a-b depict the release of an active drug by a drug-release PPAP2B↓GSTP1↓PIM1↑HEPSIN↑ diagnostic molecule, showing absolute amount of the active drug versus positive diagnosis probability. FIGS. 6c-d depict the different diagnostic outcomes are modeled using active transition molecules with a mixture of equal amounts of the drug-release and drug-suppressor-release moieties for the diagnostic string PPAP2B GSTP51. Each lane shows the distribution of drug-administration moieties, active drug, excess drug suppressor and drug/drug-suppressor hybrid, as indicated. FIGS. 6e-f depict variation in the distribution of active drug, excess drug suppressor and drug/drug-suppressor hybrid for a given diagnostic outcome and for varying relative amount of drug release and drug-suppressor release diagnostic moiety.

Drug administration is demonstrated in FIGS. 6a-f for the prostate cancer model. The dependence of the concentrations of an active drug, drug suppressor and their hybrid are shown on the diagnostic output using the diagnostic string PPAP2B↓GSTP5↓PC (FIG. 6b). The results show drug release upon positive diagnosis and formation of drug/drug suppressor hybrid as the probability of negative diagnosis increases. Studies of drug release protocols, coupling of the diagnosis to the drug release and assessing drug activity in the in vitro assays are in progress.

Drug administration is demonstrated for the prostate cancer disease model (FIG. 6a). The drug-release diagnostic molecule for PPAP2B↓GSTP1↓PIM1↑HEPSIN↑ (FIG. 2a) was constructed and the extent of active drug release was tested for different diagnostic outcomes, effected by varying amounts of ssDNA representing HEPSIN mRNA and, in a separate experiment, an example mRNA that substitutes for GSTP1 mRNA. Presence of other indicators was modeled by appropriately formed positive transitions. As is shown in FIGS. 6a and b, the amount of active drug increases with the confidence in a positive diagnosis. The concept of drug regulation was demonstrated by a drug suppressor using diagnostic molecules for PPAP2B↓GSTP1↓ with drug release and drug-suppressor release moieties. Thus, the prevailing species is the active drug for high, a drug/drug suppressor hybrid for intermediate and an active drug suppressor for low probability values (FIGS. 6c-d). In addition, these results demonstrate the ability to control the relative amounts of drug and drug suppressor for the 1:1 ratio of positive and negative diagnosis (FIGS. 6e-f). The results demonstrates the robustness of the proposed compensation mechanism and illustrate how multiple degrees of freedom of the system allow it to overcome imperfections in its components.

For this particular set of experiments (FIGS. 5 and 6), ssDNA oligonucleotides were employed to represent disease-related mRNA and used two concentrations to represent mRNA levels: 0 microM for low level and 3 microM for high level. Transition regulation can be adjusted by changing the absolute concentration of competing transitions to identify over-expression of mRNA at concentrations as low as 100 nM, which represent ˜50 mRNA copies per mammalian cell. These experiments involved the use of up to four molecular indicators, although the specific symbol encoding used can provide up to eight indicators.

The input and computation modules of the computer were tested on molecular models of SCLC and PC with diagnostic automata for the diagnostic rules shown in FIG. 1b.

This study demonstrated a robust and flexible molecular computer capable of logical analysis of mRNA disease indicators in vitro and the controlled administration of biologically active ssDNA molecules, including drugs. The modularity of the design facilitates improving each computer component independently. For example, computer regulation by other biological molecules such as proteins, the output of other biologically active molecules such as RNAi and in vivo operation can all be explored simultaneously and independently.

### Example 3

### Detection of a Molecular Marker at Different Concentrations

The input module described hereinabove was designed to detect over- and under-expressed mRNA species as indicators of a specific disease. Usually, 3 μM was set to be the normal state for under-expressed gene and the disease state for over-expressed gene; whereas, 0 μM was set to be the disease state for under-expressed gene and the normal state for over-expressed gene. Other indicator concentration ranges were demonstrated, but the range's low value was set up to be 0 μM at all times. The motivation for setting the lower sensitivity value to zero is the fact that the transitions displacement regulation process begins as soon as the first indicator molecule becomes available. Theoretically, one indicator molecule causes one active negative transition to become inactive, and one inactive positive transition to become active by the strands displacement process (in the case of over expressed gene, and vice versa in the case of under expressed gene).

The actual displacement reaction occurs between two accessible regions (tags) within the same indicator molecule and two transition strands: 1) the negative transition sense strand and 2) the positive transition protecting strand (FIG. 2b). Thus, the addition of free ssDNA molecules with the same sequences might inhibit, by competition, the transition displacement process. Since free ssDNA hybridization to mRNA is favorable kinetically, the excess ssDNA will react first, and only after its depletion the displacement process will commence. In the general case, in order to set up concentration ‘a’ as the lower value of the sensitivity range and concentration ‘b’ as the upper value of the sensitivity range, each transition should be applied at a concentration of ‘b-a’. For the displacement process to initiate at an mRNA concentration of ‘a’, inhibitor ssDNA molecules should be added at this concentration (‘a’).

To demonstrate the shifting of the sensitivity range, calibration experiments were performed by mixing 1 μM of active negative transition molecule and 1 μM of inactive positive transition molecule with 0-2 μM of a ssDNA molecule (r_tml_{—}1; SEQ ID NO:21; FIG. 15) representing the mRNA indicator, in NEB4 buffer, with or without 1 μM of negative-sense-strand (d_regT.s; SEQ ID NO:14; FIG. 15) and positive-protecting-strand (u_reg.P; SEQ ID NO:17; FIG. 15), respectively. Following 7 minutes at 15° C. the computation reaction was initiated by the adding FokI to a final concentration of 5.4 μM. The reaction was quenched after 15 minutes at 15° C. by the addition of 1 volume of a formamide loading buffer. Samples were denatured for 5 minutes at 94° C. and analyzed by denaturing PAGE (15%). In this assay, both input strands were labeled, Yes and No outputs are represented by 22-nt and 20-nt long bands, respectively (products of the antisense strand restrictions). Radioactive gels were exposed to Imaging Plates (Fuji) and scanned on PhosphorImager (Fuji). The experiment results and quantification are given in FIGS. 16a-c. Experimental results show that the sensitivity range was shifted almost exactly by the amount of the inhibitor molecules added (1 μM). This shift can be observed by comparing the two graphs (FIGS. 16b and c). In the absence of d_regT.s and u_reg.P, a 50:50 ratio between computation results (Yes:No) is achieved at the ‘mRNA’ concentration of about 0.25 μM (FIG. 16b), whereas in the presence of 1 μM of d_regT.s and u_reg.P right this ratio have been reached only at about 1.2 μM ‘mRNA’. This shift was also been found to improve sensitivity in the lower concentrations range. The ratio between Yes to No in the absence of d_regT.s and u_reg.P (FIG. 16b), at zero mRNA concentration, is 30:70. In theory it should have been 0:100, but incomplete ‘protection’ by the protecting strand may cause false positive transition activation, which results in the false positive result. Here it is evident that the addition of the negative sense strand and positive protecting strand improved the basal ratio to about 20:80. It has been observed that the addition of only the positive protecting strand (at higher concentrations) improved the basal ratio even more (data not shown).

Drug Concept Verification

Although the output mechanism described hereinabove is designed only to demonstrate the potential power of a biomolecular computer, it can be applicable in vitro, optionally, under a few assumptions: 1) antisense DNA (aDNA) technology is a valid therapeutic tool which operates via a ssDNA molecule (drug) that can hybridize to a specific mRNA molecule and inhibit its translation; 2) aDNA can be hindered by another ssDNA molecule that has the reverse-complementary sequence (drug suppressor), by hybridization; 3) while in a loop structure, both of the above molecules cannot interact with each other, with other computer components or with mRNA; and 4) of all computer components only the drug molecule is active biologically, i.e., drug suppressor and looped molecules are inert, biologically

aDNA Technology Viability

This technology, discovered two decades ago, is now under controversy. aDNA is believed to act, mainly, via two mechanisms: by a physical interference to ribosomal activity; and/or via the RNase H pathway, in which RNase H specifically restricts mRNA molecules that are, in part, hybridized to DNA (Crooke S. T., 1999, Biochim. Biophys. Acta. 1: 31-44). To test drug activity in both pathways, the translation of the Mdm2 protein was tested using an in vitro translation kit (Rabbit reticulocyte lysate, Promega L4960) in the presence or absence of RNase H (cloned Ribonuclease H, USB corporation) and in the presence of increased amount of aDNA that could be released by the computation process as a drug (FIGS. 6a-b). Mdm2 plasmid was kindly provided by M. Oren (pcDNA3 containing W.T. Mdm2 under T7 promoter). In vitro transcription kit (Megascript™ T7, Ambion) was used to transcribe Mdm2 RNA, via a T7 promoter. Minimal mRNA amount required for maximal protein translation was found to be 100 ng (data not shown). Standard in vitro translation kit manufacturer procedure was applied with the following changes: 1) reaction volume was reduced to 15 μl; 2) ³⁵S-Methionine (³⁵S-Promix 2.5MCi, Amersham) was used to label the proteins; 3) prior to the translation reaction, Mdm2 RNA (100 ng) was incubated for 10 minutes at 37° C. with the tested oligonucleotide, in this case 0-20 pmol of OP37 (SEQ ID NO:31; Table 3, hereinbelow); 4) RNase H was added (only to samples 8-14, in this case); 5) 6 units of RNase inhibitor (SUPERase-In™, Ambion), which does not affect RNase H activity, were added. 6) After 30 minutes at 30° C., each translation reaction was stopped by adding 6 μl of 4× standard SDS loading buffer. Then, samples were vortexed and denatured for 10 minutes at 80° C. The denatured proteins were separated on 10% SDS-PAGE, which was then dried and analyzed by autoradiography. As is shown in FIGS. 17a-b, only in the presence of RNase H, Mdm2 synthesis is inversely correlated with the amount of drug added. This may indicate that in this specific drug/system the Mdm2 RNA was degraded by RNase H subsequent to drug annealing to the RNA. This demonstration, supports the theory of aDNA activity, through RNase H pathway. Specificity inspection should also be done to deprive the possibility of a general, non specific effect on protein synthesis.

TABLE 3
Molecules representing output module sets

| | |
|---|---|
| Name | Sequence (SEQ ID NO:) |

| | |
|---|---|
| OP01 | GACGCTCGACGCTCGACGCTCTCTCCCAGCGTGCGCCATCTG |
| | GGAGCGCGCGTCGAGCGTCGAG |
| | (SEQ ID NO:22) |
| OP02 | TCTCCCAGCGTGCGCCATCTGG |
| | (SEQ ID NO:23) |
| OP03 | GAGGCGCGAGGCGCGAGGCCCATGGCGCACGCTGGGAGATGC |
| | GCCATGGGCCTCGCGCCTCGCG |
| | (SEQ ID NO:24) |
| OP04 | ATGGCGCACGCTGGGAGATGCG |
| | (SEQ ID NO:25) |
| OP05 | GACGCTCGACGCTCGACGCTCGGCCGTCTCCCAGCGTGCGTG |
| | CGCCATCGGCCGAGCGTCGAGCGTCGAG |
| | (SEQ ID NO:26) |
| OP06 | GGCCGTCTCCCAGCGTGCGCCATC |
| | (SEQ ID NO:27) |
| OP07 | GAGGCGCGAGGCGCGAGGCGGCCGCGATGGCGCACGCTGGGA |
| | GACGCGGCCGCCTCGCGCCTCGCG |
| | (SEQ ID NO:28) |
| OP08 | CCGCGATGGCGCACGCTGGGAGAC |
| | (SEQ ID NO:29) |
| OP36 | GACGCTCGACGCTCGTTGGTATTGCACATCCAACGAGCGTCG |
| | AG |
| | (SEQ ID NO:30) |
| OP37 | GTTGGTATTGCACATC |
| | (SEQ ID NO:31) |
| OP38 | GAGGCGCGAGGCCCATGTGCAATACCAACGCACATGGGCCT |
| | CG |
| | (SEQ ID NO:32) |
| OP39 | ATGTGCAATACCAACGC |
| | (SEQ ID NO:33) |
| pOP5test | ACGCTCGACGCTCTCTCCCAGCGTGCGCCATCTGGGAGAGAG |
| | CGTCG |
| | (SEQ ID NO:34) |
| pOP6test | ATGGCGCACGCTGGGAGATGCG |
| | (SEQ ID NO:35) |

Drug Suppressor Activity

Hybridization of ssDNA to RNA is, thermodynamically and kinetically, favorable over ssDNA to ssDNA hybridization (Baronea F., et al., 2000, Biophysical Chemistry 86: 37-47). Nevertheless, mRNA is mostly found in secondary structure form, thus, drug to drug suppressor hybridization might be favorable over drug to mRNA hybridization. To overcome such limitations the drugs are optionally designed using the following guidelines: a) Designing the drug with an overhang (when bound to the mRNA) which can specifically interact with the drug suppressor to generate a longer, thus more stable, duplex; b) Backbone modifications, which are also advantageous for in vivo applications can affect the stability ratio in favor of the drug-drug suppressor duplex; c) Sequence adjustments, like point mutations in the drug and drug suppressor sequences, relative to the mRNA, might also improve to drug-drug suppressor duplex stability. The last solution must take into consideration the sustaining of the drug activity.

Nonspecific Interactions

Potentially, undesired interactions may occur between computer components to other, or between computer components other than the drug to mRNA. For example, the active drug could hybridize to the single stranded part of the looped drug suppressor (due to sequence complementary). Other interactions, which are not characterized by sequence complementary, are probably less likely to occur. Non-specific interactions with the target mRNA and other mRNA molecules should also be tested. Fortunately, a lot of research is being done in the antisense DNA field and a lot of data is being collected regarding drug specificity, backbone toxicity etc. Additionally, all possible interactions have been tested by the present inventors using a computer program (Visual OMP4.1, DNA software) that is based on state of the art nearest-neighbor thermodynamic parameters to produce an accurate determination of the structure and behavior of oligonucleotides in a multi-state equilibrium. To verify OMP results further examinations were performed experimentally, as described below. Two parameters can affect the probability of an interaction between a free ssDNA oligonucleotide and its complementary molecule, which is the loop part of a stem loop structure: 1) stem length, which stabilizes the loop structure, and 2) loop length which determines the single-stranded part accessibility to other molecules.

The first parameter to be checked was the loop length. For this purpose, two sets of four molecules were synthesized (free drug and drug suppressor and looped drug and drug suppressor) one set [OP1 (SEQ ID NO:22), OP2 (SEQ ID NO:23), OP3 (SEQ ID NO:24) and OP4 (SEQ ID NO:25)] was designed to have a loop length of 10 nucleotides (nt) and the other set [OP5 (SEQ ID NO:26), OP6 (SEQ ID NO:27), OP7 (SEQ ID NO:28) and OP8 (SEQ ID NO:29)] was designed to have a 18 nt long loop (Table 3, hereinabove). All the loops were designed to have a 21 bp stem, which was found to be sufficient for stabilizing the loop structure, by OMP. Each oligonucleotide was radiolabeled as described previously. Reference duplexes of potentially complementary pairs of oligonucleotides were forced to anneal by mixing 100 pmol of each of the oligonucleotides in 10 μl of 50 mM NaCl TE buffer, and then heating to 94° C. and slow cooling down in a PCR machine block.

To examine whether the potential interactions occur in the reaction conditions, an hybridization system was designed in which every combination of two molecules that have the potential of hybridization were allowed to hybridize in the computation reaction conditions, i.e. 60 minutes in NEB4 buffer, at 15° C. To test reaction kinetics, shorter-incubations were performed (10 and 30 minutes). In each reaction one of the oligonucleotides was radiolabeled (as indicated in Table 4, hereinbelow) to allow the identification of the content of each band. The products of each hybridization reaction were identified by ethidium bromide (Et-Br) staining of a native 20% PAGE followed by the drying of the gel and autoradiography analysis, as described before. FIGS. 18a-b show the Et-Br staining of the tested interactions. FIG. 18a shows that all of the interaction reactions which included the 10 nt long loop (lanes 5-15) resulted in products which are identical (in molecular weight) to the starting materials (by references). Meaning that, probably, no interaction took place. Moreover, even in the reference reactions, which were enforced to anneal, the products indicate that no interaction seemed to occur. Dissimilarly, in the 18 nt long loop set (FIG. 18b) many non-specific interaction may be observed (upper bands). Autoradiography supports these findings and shows that labeled strands appear in the upper bands, indicating the formation of complex structures (data not shown). These results demonstrate that the 10 nt loop is sufficiently inaccessible for complementary strands, and that interactions are completed in less then 10 minutes, as no change was observed when incubations were longer (lanes 5-7), in both gels (FIGS. 18a-b).

TABLE 4
Reaction condition used in the experiments depicted in FIGS. 18a-b

| | Lane No. | | | | | | | | | | | | | | |
|---|---|---|---|---|---|---|---|---|---|---|---|---|---|---|---|
| | 1* | 2* | 3* | 4* | 5 | 6 | 7 | 8 | 9 | 10 | 11 | 12 | 13 | 14 | 15 |
| | Lanes of gel depicted in FIG. 18b | | | | | | | | | | | | | | |
| Incub. time | — | — | — | — | 10 | 30 | 60 | 60 | 60 | 60 | 60 | 60 | 60 | 60 | 60 |
| (minutes) | | | | | | | | | | | | | | | |
| Oligo 1 | OP2 | OP2 | OP1 | OP1 | OP2 | OP2 | OP2 | OP2 | OP2 | OP2 | OP1 | OP1 | OP1 | OP1 | OP1 |
| Oligo 2 | OP4 | OP3 | OP3 | OP4 | OP3 | OP3 | OP3 | OP3 | OP4 | OP4 | OP4 | OP4 | OP3 | OP3 | OP2 |
| Incub. time | — | — | — | — | 10 | 30 | 60 | 60 | 60 | 60 | 60 | 60 | 60 | 60 | 60 |
| (minutes) | | | | | | | | | | | | | | | |
| Oligo 1 | OP6 | OP6 | OP5 | OP5 | OP6 | OP6 | OP6 | OP6 | OP6 | OP6 | OP5 | OP5 | OP5 | OP5 | OP6 |
| Oligo 2 | OP8 | OP7 | OP7 | OP8 | OP7 | OP7 | OP7 | OP7 | OP8 | OP8 | OP8 | OP8 | OP7 | OP7 | OP5 |

Table 4: The reaction conditions for the experiments depicted in the FIGS. 18a and b are shown.
Incub. Time = incubation time;
Oligo = oligonucleotide;
*= reference;
underlined oligonucleotides reflect radiolabeled oligonucleotides.

To address the minimal stem length needed for stabilizing the loop structure, an output-like molecules with a 14 bp stem and a 14 nt loop was synthesized [pOP5test (SEQ ID NO:34), Table 3, hereinabove]. This 14 nt loop length was found to be stabilized by a 21 bp stem (data not shown). The interactions between oligonucleotide pOP5test and an oligonucleotide with a complementary sequence to the loop [pOP6test (SEQ ID NO:35), Table 3, hereinabove] were tested in the reaction conditions as described above, but in three different temperatures (15, 23, and 37° C.) and with 20 minutes incubation. In this case a non-labeled native PAGE (20%) was sufficient to show that the loop structure was unstable in all temperatures tested (FIG. 19). The upper band observed in the first lane (lane 1, FIG. 19) might be a homodimer of pOP5test, as forecasted by a computer simulation, OMP.

Specific Biological Activity of Computer Components

To further examine the biological activity of each of the computer elements, in vitro translation reactions were employed. First, drug (OP37) and drug suppressor (OP39) effect on Mdm2 expression was tested in vitro using the rabbit reticulocyte lysate kit as described above (with RNase H). Two other changes were the reaction temperature that was set to be 37° C., and the incubation time that was 42 minutes. As is shown in FIGS. 20a-b, increasing concentration of the drug, i.e., 7.5, 10 and 15 pmol (lanes 2, 3 and 4 respectively) resulted in a dose-dependent negative effect on Mdm2 expression relative to the reference (lane 1). On the other hand, increasing concentrations of the drug suppressor, i.e., 7.5, 10 and 15 pmol (lanes 5, 6 and 7 respectively) exhibited no significant effect.

Next, looped drug (OP36) and looped drug suppressor (OP38) were also tested for their effect as described hereinabove except that incubation was for 30 minutes at 30° C. The reaction conditions are summarized in Table 5, hereinbelow. It is evident from the data presented in FIGS. 21a-b that drug effect is less significant under such conditions, and that other computer components may also have an effect, especially at high concentrations.

TABLE 5
Reaction condition used in the experiment depicted in FIG. 21a

| | Lane | | | | | | | | | |
|---|---|---|---|---|---|---|---|---|---|---|
| | 1 | 2 | 3 | 4 | 5 | 6 | 7 | 8 | 9 | 10 |
| OP37 | | 7.5 | 10 | 15 | | | | | | |
| (pmol) | | | | | | | | | | |
| OP38 | | | | | 7.5 | 10 | 15 | | | |
| (pmol) | | | | | | | | | | |
| OP36 | | | | | | | | 7.5 | 15 | |
| (pmol) | | | | | | | | | | |
| OP39 | | | | | | | | | | 15 |
| (pmol) | | | | | | | | | | |

To further inspect the specificity of the computer components, a coupled in vitro transcription-translation kit (TNT® T7 Coupled Wheat Germ Extract System, L4140, Promega) was employed. In this kit, the internal expression control (Luciferase expression plasmid, supplied with the kit) is also expressed. The reaction conditions are summarized in Table 6, hereinbelow. Here, 100 ng of Mdm2 plasmid were found to be the minimal plasmid required for maximal protein expression along with 75 ng of Luciferase plasmid that were found to be adequate for identification of the Luciferase protein. Standard in vitro transcription-translation (TNT®) kit manufacturer procedure was applied with the following changes: 1) reaction volume was reduced to 15 μl; 2) ³⁵S-Methionine (³⁵S-Promix 2.5MCi, Amersham) was used to radiolabel the proteins; 3) both Mdm2 plasmid (100 ng) and Luciferase plasmid (75 ng) were added to all samples; 4) 6 units of RNase inhibitor (SUPERase○In™) were added to all samples; 6) After 30 minutes at 30° C. each reaction was stopped by the addition 6 μl of 4× standard SDS loading buffer was, followed by a vortex and denaturation for 10 minutes at 80° C. Samples were then separated on a 10% SDS-PAGE, which was subsequently dried and analyzed by autoradiography. FIGS. 22a-b demonstrate the effect of each of the computer components, and the drug effect with RNase H. The protein synthesis, in this case, is probably limited by on more of the kit components; thus, any change in one mRNA concentration will immediately influence the other mRNA expression in an inversely correlated. Evidence shows that all computer components exhibit a negative effect on both of the proteins expression. This effect is not specific and it might be attributed to the oligonucleotides dissolving buffer which contains EDTA (50 nM). Nevertheless, the drug had a slightly larger and more specific effect when RNase H was not used. In the presence of RNase H the negative effect is even more specific and significant.

TABLE 6
Reaction condition used in the experiment depicted in FIG. 22a

| | Lane | | | | | | | | | | | | | |
|---|---|---|---|---|---|---|---|---|---|---|---|---|---|---|
| | 1 | 2 | 3 | 4 | 5 | 6 | 7 | 8 | 9 | 10 | 11 | 12 | 13 | 14 |
| RNaseH | − | − | − | − | − | − | − | − | − | + | + | + | + | + |
| OP37 | − | 5 | 10 | − | − | − | − | − | − | − | 5 | − | − | − |
| (pmol) | | | | | | | | | | | | | | |
| OP39 | − | − | − | 5 | 10 | − | − | − | − | − | − | 5 | − | − |
| (pmol) | | | | | | | | | | | | | | |
| OP36 | − | − | − | − | − | 5 | 10 | − | − | − | − | − | 5 | − |
| (pmol) | | | | | | | | | | | | | | |
| OP38 | − | − | − | − | − | − | − | 5 | 10 | − | − | − | − | 5 |
| (pmol) | | | | | | | | | | | | | | |

FIGS. 23a-b demonstrate the computer components on Bcl2 expression. The oligonucleotides (OP1, OP2, OP3 and OP4, Table 3, hereinabove) representing the output module components of an automaton designed treat the diagnosed cancer by antisense therapy against Bcl2, which is an anti-apoptotic protein (Korsmeyer S. et al., 1999, Genes and Development 13: 1899-1911). Bcl2 plasmid (pcDNA3 plasmid containing W.T. Bcl2 under CMV promoter) was kindly provided by A. Gross (Weizmann Institute Of Science, Rehovot). A PCR amplification procedure was used to insert a T7 promoter upstream to the Bcl2 open reading frame (ORF). The PCR product was then served as a template for the in vitro kit (TNT®), as described above, to test this computer's components, and to reexamine RNase H activity. The reaction conditions used in this experiment (FIGS. 23a-b) as summarized in Table 7, hereinbelow. Here an internal control was not used. FIGS. 23a-b show that without RNase H all computer components, but the drug suppressor, had no significant effect on Bcl2 translation. Surprisingly, the drug suppressor did have a dose-dependent negative effect on Bcl2 translation. In the presence of RNase H only the drug was tested, and it exhibited a (similar) dose-dependent negative outcome on Bcl2 translation.

TABLE 7
Reaction condition used in the experiment depicted in FIG. 23a

| | Lane | | | | | | | | | | | | | | | | |
|---|---|---|---|---|---|---|---|---|---|---|---|---|---|---|---|---|---|
| | 1 | 2 | 3 | 4 | 5 | 6 | 7 | 8 | 9 | 10 | 11 | 12 | 13 | 14 | 15 | 16 | 17 |
| RNaseH | − | − | − | − | − | − | − | − | − | − | − | − | − | + | + | + | + |
| OP2 | − | 5 | 10 | 20 | − | − | − | − | − | − | − | − | − | − | 5 | 10 | 20 |
| (pmol) | | | | | | | | | | | | | | | | | |
| OP4 | − | − | − | − | 5 | 10 | 20 | − | − | − | − | − | − | − | − | − | − |
| (pmol) | | | | | | | | | | | | | | | | | |
| OP1 | − | − | − | − | − | − | − | 5 | 10 | 20 | − | − | − | − | − | − | − |
| (pmol) | | | | | | | | | | | | | | | | | |
| OP3 | − | − | − | − | − | − | − | − | − | − | 5 | 10 | 20 | − | − | − | − |
| (pmol) | | | | | | | | | | | | | | | | | |

### Example 4

### Molecular Automata as Logical Components in Transcription Networks

Intervention in transcription networks has medical and biotechnology applications. Unconditional intervention may be achieved by a drug that blocks the activity of one Transcription Factor (TF) or more [Higgins, K. A. Proc. Natl. Acad. Sci. USA. 90: 9901-9905 (1993)]. Conditional intervention was usually accomplished by re-engineering the cell genome to produce a molecular signal (GFP) when a certain condition held [Weiss R., et al., 1999). Toward in vivo Digital Circuits. DIMACS Workshop on Evolution as Computation, Landweber, Laura F.; Winfree, Erik (Eds.) 2003, XV, p. 273, Springer(http://www.springeronline.com /sgw/cda/frontpage/0,11855,5-147-22-2042090-detailsPage%253 Dppmmedia%257Ctoc %257Ctoc,00.html)]; Hasty J, et al., 2001, Chaos. 11: 207-220; McMillen D., et al., 2002, Proc. Natl. Acad. Sci. USA. 99: 679-684; Elowitz M. B. and Leibler S. 2000, Nature 403: 335-338). The molecular automaton of the present invention consists of three modules, an input module that can sense, at least in vitro, levels of mRNA expression, and computation component that can diagnose a disease based on encoded medical knowledge and the input, and an output component that can release a drug if a disease is diagnosed [Benenson, Y., et al., 2004, Nature 429: 423-429].

The molecular computer of the present invention is capable of sensing disease-linked abnormal levels of several mRNA species, perform a diagnostic decision-making computation and administer an antisense DNA drug for this disease. Although vast information had been obtained about transcription patterns in various cell conditions, experimental evidence showed a disparity between the relative expression levels of mRNAs and their corresponding proteins [Gurrieri C., et al., 2004, J. Natl. Cancer Inst. 96: 269-279; Gygi S. P., et al., 1999, Mol. Cell. Biol. 19: 1720-1730; Cahill D. J., 2001, J. Immunol. Methods 250: 81-91; Lee P. S, and Lee K. H. 2000, Curr. Opin. Biotechnol, 11: 171-175; Zhu H. and Snyder M., 2003, Curr. Opin. Chem. Biol. 7: 55-6). This difference is due to more than a hundred types of posttranscriptional mechanisms that control protein translation rate like proteins (or mRNAs) half life and intracellular localization and association [Gygi S. P., et al., 1999, Mol. Cell. Biol. 19: 1720-1730; Cahill D. J., 2001, J. Immunol. Methods 250: 81-91). Therefore, the bona fide phenotype of a cell is reflected both in its proteome and in its transcriptome.

It will be appreciated that novel mechanism for identifying disease-linked abnormal levels of DNA binding proteins can be integrated into the design of the molecular computer of the present invention as an additional input module. Using the terminology defined in [Benenson, 2004, (Supra)], the molecular automaton can perform an in vitro computational version of ‘diagnosis’—the identification of several molecular disease indicators, namely mRNAs and DNA binding proteins at specific levels, and ‘therapy’—production of a biologically active molecule.

Following is a diagnosis of an hypothetical model of a disease, characterized by an under-expressed NF-kB subunit p50 [Baldwin A S Jr. Annu Rev Immunol. 14: 649-83 (1996)] and an over-expressed mRNA of GSTP gene [Dhanasekaran et al., 2001, Nature 412: 822-826]. ‘Drug’ (ssDNA molecule with a therapeutic activity) could have been employed by coupling the output module to this system, as done before [Benenson, 2004, (Supra)]. The term ‘drug suppressor’ will indicate the drug antagonist molecule, which is a ssDNA molecule whose sequence is a reverse complement of the drug sequence.

The automaton operation is governed by a ‘diagnostic rule’ that states the condition in which a specific drug should be administered (see example in FIG. 24a). The left-hand side of the rule describes molecular disease indicators (DNA binding proteins and mRNA levels) that characterizes a disease and the right-hand side consists of the drug for this disease. The diagnostic rule implemented in this work states that if NF-kB p50 protein (p50) is under-expressed and the gene GSTP is over-expressed (at the mRNA level) then administer a hypothetical drug, in the form of ssDNA molecule (FIG. 24a). The automaton comprises three modules: input module, which can sense bio-molecules that indicate a disease; computation module that implements the decision making algorithm which decides whether the set of condition holds; and an output module, which enables a controlled release of a drug molecule according to the diagnosing decision.

The abstract notion of the combined automaton, for the detection of both mRNA and protein indicators is illustrated in FIG. 24b. The molecular realization design is given in FIG. 25 (Step a).

The former input module was designed to sense specific mRNA species via regulation of the software molecules concentrations. There, transitions could be activated or deactivated by a strand displacement process with specific, accessible, region in an mRNA molecule. The computation module is based on a simple two-state stochastic molecular automaton [Benenson, 2001 (Supra); Benenson, 2003 (Supra); Benenson, 2004 (Supra)]. The two automaton states, positive (Yes) and negative (No), are realized in a dsDNA molecule (diagnostic molecule) sticky end. This molecule also encompasses the symbols read by the automaton. The computation process starts in a Yes state and the transition molecules, using the hardware molecule FokI (class IIs restriction enzyme), can transform the automaton between states, by cleaving the diagnostic molecule to revile the next symbol and state combination. Positive transition transforms the automaton from a Yes state to a Yes state. Negative transition transforms the automaton from a Yes state to a No state. The automaton stochastic feature is achieved by using different concentrations for competing transitions for the same state-symbol configuration (FIG. 25, step a). This results in different probabilities for the computation module to change states, in a transition-concentration dependent manner. The final automaton state reflects the confidence in the existence of the disease, as displayed by its molecular indicators. The output module is realized by a stem-loop DNA structure at the end of the diagnostic molecule that contains a drug or a drug suppressor sequence in the loop part. While in the loop, the drug cannot be active because it is inaccessible for interactions with long mRNA molecules or other ssDNA molecules. Upon positive diagnosis, a diagnostic molecule containing drug in the looped part will be restricted and the drug will be activated; upon negative diagnosis a diagnostic molecule containing drug suppressor in the looped part will be restricted and the drug suppressor will be activated. Hence, in the overall stochastic process only a positive diagnosis, which is indicated by a higher concentration of diagnostic molecules in a final Yes state, more drug then drug suppressor will be released, and the excess of drug will be free to function [Benenson, 2004, (Supra)].

The novel input module demonstrated here emphasizes the system modularity that enables the addition of a module or the substitution of one module with another. In this case a new input module was designed and embedded into an existing design without changing the other two modules (computation and output).

The new input mechanism utilizes: 1) the observation that nucleases, including restriction enzymes, cleave DNA bound to the DNA binding proteins much slower than the free DNA. Much information can be achieved from the literature as the well known footprint technique (Tullius T. D., 1989, Annu. Rev. Biophys. Biophys. Chem., 18: 213-237) is also base on this observation; 2) The ability to produce a short ssDNA molecule by the cleavage of the stem of a stem-looped DNA molecule. This technique is used also by the automaton output module.

Here, stem cleavage used to produces a ssDNA is done by the automaton hardware molecule FokI and a transition-like molecule. This cleavage can be hindered by a DNA binding protein if the stem sequence contains the protein binding site.

The module is a transition molecule generator that is controlled by the indicator proteins. For each protein indicator one transition is generated only in the absence of the DNA binding protein, the opposed transition is generated always but it is inactivated in the protein absence. Transition species (positive or negative) is determined by the sequence design, thus the final outcome of the generator is a positive transition if the protein indicator is present and a negative transition otherwise.

Transition are comprised of two complementary ssDNA oligonucleotides that hybridize to form a duplex which contains the FokI binding site and a sticky end, complementary to a potential sticky end in the diagnostic molecule (FIG. 26a). Transitions can be constructed out of their two ssDNA molecules in situ in certain conditions, which include the automaton reaction conditions.

Generation of the first transition is accomplished by cleaving a stem, which contains the protein indicator binding site, to produce one transition strand to an environment containing the other transition strand. This results in an active transition only in the absence of the DNA binding protein (FIG. 26b). The opposed transition must be activated when the protein is present to prevent the possibility of computation hampering. The stem loop used to produce this transition strand contains no binding site, thus the transition activation is done in a protein-indicator-independent manner. However, this transition contains a ssDNA overhang that enables the inactivation of the transition by a displacement process. This inactivation can be done by a ssDNA molecule that forms a more stable duplex with one of the transition strands that contains no FokI site nor a putative sticky end. The inactivating ssDNA molecule is formed only if the DNA binding protein is absent, as it is produced from a stem cleavage mechanism that can be hindered by a DNA binding protein, as described above. This will result in an active transition only if the DNA binding protein is present, because only then the inactivating molecule production is impeded (FIG. 26c). Each of the above transition can be designed, by sequence, to be positive or negative, thus over and under expressed DNA binding proteins can be detected. Moreover, the automaton stochastic feature enables the production of only one transition, if the indicator is highly significant (FIG. 26d), the opposed indicator if the indicator is absent (FIG. 26e), and all the continuous possibilities between these two extremes, according to the indicator level.

Materials and Experimental Methods

The design and oligonucleotides used to build the mRNA detecting module (GSTP) are given elsewhere [Benenson, Y., et al., 2004, Nature 429: 423-429]. The oligonucleotides used to build the p50 detecting module were ordered from the Weizmami Institute synthesis unit or from Sigma-Genosys. Sequences are given in Table 8, hereinbelow. All duplexes and self annealing were prepared by heating the oligonucleotide/s to 99° C. in TE containing 50 mM NaCl, followed by a slow cool down in a PCR block.

TABLE 8

Input module oligonucleotides for the detection
of p50 (5′→3′)

| | |
|---|---|
| Name | Sequence (SEQ ID NO:) |

| | |
|---|---|
| PP48 | GGACGATATGGACTGTCGGAGACAGGGATGTCTCCGACAGTCCAT |
| | ATC |
| | (SEQ ID NO:36) |
| PP50 | GGACTTTCCGGACGGGACTTTCCACCGAGACAGGGACGCCGATGG |
| | AAAGTCCCGTCCGGAAA |
| | (SEQ ID NO:37) |
| PP52 | GGACTTTCCGGACGGGACTTTCCGTCGCGGGATGCGGAAAGTCCC |
| | GTCCGGAAA |
| | (SEQ ID NO:38) |
| PP54 | TCGGCATCCCTCTCTCGGTGGAAA |
| | (SEQ ID NO:39) |
| PP55 | TCGGCGCATCCCGCGACGGAAA |
| | (SEQ ID NO:40) |
| PP20 | CGTAGCTAGCTGCAGATCGGATG |
| | (SEQ ID NO:41) |
| PP21 | GTCCCATCCGATCTGCAGCTAGCTACG |
| | (SEQ ID NO:42) |
| PP24 | GGACTTTCCGGACGGGACTTTCCATCGC |
| | (SEQ ID NO:43) |
| PP25 | CGCGATCCAAAGTCCCGTCCGGAAA |
| | (SEQ ID NO:44) |
| RD87 | CCGAGGCGGTGCGCAAAATTTACCGATTAACTTCCA |
| | (SEQ ID NO:45) |
| RD89 | Cy5-CCAACTTAATCGGTAAATTTTGCGCACCGCC |
| | (SEQ ID NO:46) |

PP48 was self annealed to form B2.45.1, PP50 was self annealed to form B2.45.2 and PP52 was self annealed to form B2.45.3. PP24 and PP25 were annealed and radiolabeled to construct a dsDNA molecule mimicking the DNA binding site containing stem. The transition-like molecule used for stem cleavage was constructed by the annealing of PP20 and PP21.

All computation reactions were done in NEB4 buffer (New England Biolabs), at 15° C. for 30 minutes in a total volume of 10 μl. Reactions were quenched by adding 1 volume of formamide loading buffer and incubating at 95° C. for 5 minutes. Samples were then analyzed on a 15% denaturizing PAGE. Radioactive gels were exposed to Imaging Plates (Fuji) and scanned on PhosphorImager (Fuji). Fluorescence was read by the Typhoon 9400 machine (Amersham Pharmacia Biosciences). Excitation was done with the red laser (633 nm, PMT 650 V) and emission was measured through the 670 BP30 filter). Experiments done to test stem restriction hindrance by p50 were done by mixing of the stem-mimicking radiolabeled duplex (200 nM) with transition-like molecules (200 nM) in the NEB4 buffer, with 4.4 gsu (gel shift units) of recombinant human p50 (rhNF-kappaB p50, Promega E3770) or with the same volume (1 μl) of rh-p50 dilution buffer. The mixture was incubated at 15° C. for 10 minutes, followed by FokI addition (to a final of 200 nM) and thorough mixing that was considered to start the reaction.

Experiments done to demonstrate the detection of p50 were done by mixing: fluorescence labeled (Cy5) input molecule (50 nM) which contains the symbol identified by the in situ constructed transitions, B2.45.1 (25 nM), PP54 (25 nM), PP55 (100 nM) and transition-like molecule (500nM) with or without a mixture simulating p50 absence that contained B2.45.2 (to a final 250 nM) and B2.45.3 (to a final 100 nM). After 10 minutes incubation reaction were initiated by the addition of FokI (to a 500 nM) and thorough mixing.

Experiments done to demonstrate the diagnosis of p50↓GSTP↑ were done by combining the simulated p50 detection described above and the ssDNA representing GSTP mRNA detection, which was described elsewhere [Benenson, Y., 2004, Nature 429: 423-429].

Experimental Results

Surprisingly, p50 displayed the same binding activity (and specificity) in NEB4 buffer (and even in double distilled water) compared to the binding activity in several proposed p50 binding buffers, as revealed in gel shift experiments (data not shown).

The p50 hindrance experiments showed a much slower cleavage rate in the presence of p50 than in its absence (FIG. 27a). This finding demonstrates that a dsDNA cleavage, can be hindered by a DNA binding protein, in the proposed mechanism. This may indicate that a stem cleavage could also be thwarted and ssDNA production could be controlled by DNA binding proteins.

For p50 detection by the designed input module, the ratio between stem loop molecules was calibrated to compensate different restriction and inactivation rates and yields. These preliminary calibrations showed that 1:10:4 ratio is needed between the stem loop molecule that produces the negative transition strand (B2.45.1 which does not contain p50 binding site), to the stem loop molecule that produces the negative transition inactivation strand (B2.45.2, which contains p50 binding site) to the stem loop molecule that produces the positive transition strand (B2.45.3, which contains p50 binding site), respectively (data not shown). Due to technical difficulties, protein hindrance was simulated by a manually decreasing the concentrations of the stems that p50 was supposed to bind (B2.45.2 and B2.45.3). FIG. 27b demonstrates the detection of under expressed p50, by such a simulation. These findings suggest that the DNA binding protein detection is possible by this model. Because the computation mechanism was identical this system could be embedded as an additional input module into the former, mRNA based, diagnostic and therapeutic molecular automaton.

Analysis and Discussion

The modular design of the computer enables replacing and/or combining the mRNA-sensing input module with a module that senses levels of transcription factors. Thus, this automaton may realize a logical component in a transcription network which could also sense several mRNAs' level. Future work may allow the operation of this device inside a living cell. Potential applications may include sophisticated research tools and even conditional drug admission by coupling gene regulation to an arbitrary combination of multiple transcription factors in vivo.

The designed module senses the active portion of each protein indicator rather then its actual concentration. This might be an advantage over current protein detection tools, in future applications. One of the main drawbacks of this system is the fact that it relies on DNA binding proteins ability to hinder dsDNA restriction. The hindrance is mostly not complete; hence a “transition generation leakage” is possible. This drawback can be compensated by other means, like changing the ratio between initial system components or by adding other restrains over transition production.

The proposed design, of the transition generator, resembles the output architecture in many ways. However, the use of FokI and the transition is not inevitable. In fact, almost any restriction enzyme could have been used to cleave the stems. In the case of class II restriction enzymes the recognition site may be within the stem, if the DNA binding protein binding will not be interfered.

This work demonstrates the automaton modularity and that future development may increase its abilities. The ability to sense protein indicator is a step forward towards logical analysis of the proteome. Indeed, not all proteins can be detected by the current design, but the activity level of important proteins, like transcription factors, can be detected and cell condition can be derived from this data. Moreover, the current design might enable a conditional intervention in TF networks, by administering a drug only when a set of condition over TFs is held.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

### REFERENCES

### Additional References are Cited in Text

1. Mead, C. & Conway, L. (1980) Introduction to VLSI systems. (Addison-Wesley, Boston).
2. Alberts, B., Johnson, A., Lewis, J., Raff, M., Roberts, K., Walter, P. (2002) Molecular biology of the cell (Garland, N.Y.). [fourth edition].
3. von Neumann, J. Report prepared for U.S. Army Ord. Dept. under contract W-670-ORD-4926 (1945). Reprinted in Papers of John von Neumann on Computing and Computer Theory, (eds. Aspray, W. & Burks, A.), 17-82, (MIT Press, Cambridge, Mass., 1986).
4. Turing, A. M. On computable numbers, with an application to the Entcheidungproblem. Proc. of the London Mathematical Society 42, 230-265 (1936-7).
5. Hopcroft, J. E., Motwani, R., Ullman, J. D. Introduction To Automata Theory, Languages And Computation (2nd ed., Addison-Wesley Publishing Co., Boston, Mass., 2000).
6. Bennet C. H. The thermodynamics of computation—a review. Int. J. Theor. Phys. 21, 905-940 (1982).
7. Rothemund, P. W. K. in DNA Based Computers:Proceedings of the DIMACS Workshop, Apr. 4, 1995, Princeton University (eds Lipton, R. J. & Baum, E. B.) 75-119 (American Mathematical Society, Providence, R.I., 1996).
8. Smith, W. D. in DNA Based Computers: Proceedings of the DIMACS Workshop, Apr. 4, 1995, Princeton University (eds Lipton, R. J. & Baum, E. B.) 121-185 (American Mathematical Society, Providence, R.I., 1996).
9. Garzon, M. et al. In vitro implementation of finite-state machines, in Proc. 2nd Int. Workshop on Implementing Automata WIA'97, 56-71 (Springer-Verlag, LNCS 1436, 1998).
10. Shapiro, E. & Karunaratne, K. S. G. Method and system of computing similar to a Turing machine. U.S. Pat. No. 6,266,569 (Jul. 24, 2001).
11. Adelman, L. M. Molecular computation of solutions to combinatorial problems. Science 266, 1021-1024 (1994).
12. Lipton, R. J. DNA solution of hard computational problem. Science 268, 542-545 (1995).
13. Ouyang, Q., Kaplan, P. D., Liu, S., Libchaber, A. DNA solution of the maximal clique problem. Science 278, 446-449 (1997).
14. Winfree, E., Liu, F. R., Wenzler, L. A., Seeman, N. C. Design and self-assembly of two-dimensional DNA crystals. Nature 394, 539-544 (1998).
15. Sakamoto, K. et al. State transitions by molecules. BioSystems 52, 81-91 (1999).
16. Khodor, J., Gifford, D. K. Design and implementation of computational systems based on programmed mutagenesis. Biosystems 52(1-3), 93-97 (1999).
17. Liu, Q. et al. DNA computing on surfaces. Nature 403, 175-179 (2000).
18. Ruben, A. J., Landweber, L. F. The past, present and future of molecular computing. Nature Rev. Mol. Cell. Biol. 1, 69-72 (2000).
19. Faulhammer, D., Cukras, A. R., Lipton, R. J., Landweber, L. F. Molecular computation: RNA solutions to chess problems. Proc. Natl. Acad. Sci. USA 97, 1385-1389 (2000).
20. Mao, C., LaBean, T. H., Reif, J. H., Seeman, N. C. Logical computation using algorithmic self-assembly of DNA triple-crossover molecules. Nature 407, 493-496 (2000).
21. Sakamoto, K et al. Molecular computation by DNA hairpin formation Science 288, 1223-1226 (2000).
22. Benenson, Y. et al. Programmable and autonomous computing machine made of biomolecules. Nature 414, 430-434 (2001).
23. Bar-Ziv, R., Tlusty, T., Libchaber, A. Protein-DNA computation by stochastic assembly cascade. Proc. Natl. Acad. Sci. USA 99, 11589-11592 (2002).
24. Benenson, Y.; Adar, R.; Paz-Elizur, T.; Livneh, Z.; Shapiro, E. DNA molecule provides a computing machine with both data and fuel. Proc Natl. Acad. Sci. USA 100, 2191-2196 (2003).
25. Stojanovic, M. N., Stefanovic, D. A deoxyribozyme-based molecular automaton Nat. Biotech. 21, 1069-1074 (2003).
26. Rabin, M. O. Probabilistic Automata. Inform. Control 6, 230-245 (1963).
27. Adar, R. et al. Controlling stochastic choices in molecular automata via software molar concentrations. Submitted.
28. Murphy, K. P. Passively learning finite automata. (Tech. Rep. 96-04-017, Santa Fe Institute, Santa Fe, 1996).
29. Maass, W., Orponen, P. On the effect of analog noise in discrete-time analog computations, Neural Comp. 10, 1071-1095 (1998).
30. Durbin, R, Eddy, S. R., Krogh, A., Mitchison, G. (1998) Biological Sequence Analysis: Probabilistic Models of Proteins and Nucleic Acids (Cambridge University Press, Cambridge).
31. Bejerano, G., Yona, G. Variations on probabilistic suffix trees: statistical modeling and prediction of protein families. Bioinformatics 17, 23-43 (2001).
32. Priami, C., Regev, A., Shapiro, E., Silverman, W. Application of a stochastic name-passing calculus to representation and simulation of molecular processes. Inf. Proc. Lett. 80, 25-31 (2001).
33. Regev, A., Shapiro, E. Cellular abstractions: Cells as computation. Nature 419, 343-343 (2002).
34. Ledley, R. S. & Lusted, L. B. Reasoning foundation of medical diagnosis. Science 130, 9-21 (1959).
35. Albert D. A. Decision theory in medicine: A review and critique. Health and Society 56, 362-400 (1978).
36. Schaffner K. F. Modeling medical diagnosis: Logical and computer approaches. Synthese 47, 163-1999 (1981).
37. Holzer, S., Fremgen, A. M., Hundahl, S. A., Dudeck, J. Analysis of medical-decision making and the use of standards of care in oncology. Proc. AMIA Symp. 364-368 (2000).
38. Sidransky, D. Emerging molecular markers of cancer. Nat. Rev. Cancer 2, 210-219 (2002).
39. Pedersen, N. et al. Transcriptional gene expression profiling of small cell lung cancer cells. Cancer Res. 63, 1943-1953 (2003).
40. Dhanasekaran S. M. et al. Delineation of prognostic biomarkers in prostate cancer. Nature 412, 822-826 (2001).
41. Alizadeh, A. A. et al. Distinct type of diffuse large B-cell lymphoma identified by gene expression profiling. Nature 403, 503-511 (2000).
42. Takahashi, T. et al. The p53 gene is very frequently mutated insmall-cell lung cancer with a distinct nucleotide substitution patter. Oncogene 6, 1775-1778 (1991).
43. Thorns, C., Gaiser, T., Lange, K., Metz, H., Feller, A. C. cDNA arrays: Gene expression profiles of Hodgkin's disease and anaplastic large cell lymphoma cell lines. Pathology Int. 52, 578-585 (2002).
44. Klasa, R. J., Gillum, A. M., Klem, R. E., Frankel, S. R. Oblimersen Bcl-2 antisense: Facilitating apoptosis in anticancer treatment. Antisense Nucleic Acid Drug Dev. 12, 193-213 (2002)
45. Capoulade, C. et al. Apoptosis of tumoral and nontumoral lymphoid cells is indiced by both mdm2 and p53 antisense oligodeoxynucleotides. Blood 97, 1043-1049 (2001).
46. Balzani, V., Credi, A., Venturi, M. Molecular logic circuits. Chem Phys Chem 4, 49-59 (2003).
47. Yurke, B., Turberfield, A. J., Mills, A. P., Simmel, F. C., Neumann, J. L. A DNA-fuelled molecular machine made of DNA. Nature 406, 605-608 (2000).
48. Hamming, R. W. Error Detecting and Error Correcting Codes. Bell Syst. Tech. J. 29, 147-160 (1950).

1. An autonomous molecular computer capable of disease diagnosis.

2. The computer of claim 1, further comprising: a molecular model of a disease for being coupled to the computer.

3. The computer of claim 1, for performing said diagnosis by detecting one or more disease markers.

4. The computer of claim 3, wherein said one or more disease markers includes the absence or presence, or over-expression or under-expression of one or more proteins or metabolites, or mutation of one or more proteins.

5. The computer of claim 3, wherein said performing said diagnosis includes performing one or more of checking for the presence of over-expressed, under-expressed and mutated genes.

6. The computer of claim 1, further comprising: programmed medical knowledge for being applied to said diagnosis.

7. The computer of claim 1, further being capable of administering the requisite treatment upon diagnosis.

8. The computer of claim 7, wherein said treatment comprises a drug molecule, most preferably anti-sense chemotherapy.

9. The computer of claim 1, wherein said disease comprises at least one of small-cell lung cancer and of prostate cancer.

10. An autonomous molecular computer capable of in vivo treatment.

11. The computer of claim 10, wherein said treatment occurs within a cell or at a cell surface.

12. The computer of claim 1, comprising a plurality of polymeric molecules, optionally including one or more heteropolymers or homopolymers.

13. The computer of claim 12, wherein said polymeric molecules comprise oligomers.

14. The computer of claim 12, wherein said polymeric molecules comprise a plurality of oligonucleotides.

15. The computer of claim 14, wherein said polymeric molecules optionally comprise at least one modified oligonucleotide.

16. The computer of claim 12, wherein said polymeric molecules comprise peptides and/or polypeptides.

17. An autonomous computer for diagnosing a disease comprising an input module including at least one molecule, said input module being capable of generating a response to a presence or absence of at least one marker of the disease and a computation module capable of calculating a probability of the disease based on said response of said input module.

18. The autonomous computer of claim 17, wherein said at least one marker of the disease is a bio-molecule.

19. The autonomous computer of claim 18, wherein said bio-molecule is a DNA molecule, an RNA molecule, a peptide and/or a polypeptide.

20. The autonomous computer of claim 17, wherein said at least one marker is at least two.

21. The autonomous computer of claim 17, wherein said computation module includes at least one transition molecule capable of being activated or being inactivated according to said response of said input module.

22. The autonomous computer of claim 17, further comprises an output module capable of controlling a release of a drug or a drug suppressor molecule based on outcome of said probability of the disease.

23. The autonomous computer of claim 21, wherein said at least one transition molecule is a DNA molecule.

24. The autonomous computer of claim 21, wherein activation or inactivation of said transition molecule is controlled via binding between said at least one marker and said transition molecule.

25. The autonomous computer of claim 21, wherein said at least one molecule of said input module includes an enzymatic moiety which is activated in response to said presence of said at least one marker.

26. The autonomous computer of claim 25, wherein said enzymatic moiety is an endonuclease.

27. The autonomous computer of claim 22, wherein said drug is an antisense oligonucleotide, RNAi (siRNA), Ribozyme, DNAzyme and/or triplex forming oligonucleotide (TFO).
